(19) United States
(12) Patent Application Publication
(10) Pub. No.: US 2024/0429730 A1
(43) Pub. Date: Dec. 26, 2024

(54) Smart Power Tool Battery Charger Based on a Charging State

(71) Applicant: Milwaukee Electric Tool Corporation, Brookfield, WI (US)

(72) Inventors: Jonathan E. Abbott, Milwaukee, WI (US); Samuel Sheeks, Germantown, WI (US); Ryan B. Jipp, Brookfield, WI (US)

(21) Appl. No.: 18/704,032

(22) PCT Filed: Oct. 26, 2022
(86) PCT No.: PCT/US2022/078723

§ 371 Date: Apr. 23, 2024

Related U.S. Application Data
(60) Provisional application No. 63/272,565, filed on Oct. 27, 2021.

(51) Int. Cl. H02J 7/00; H01M 10/46; H01M 50/204; H01M 50/247

(52) U.S. Cl. CPC H02J 7/00712; H01M 10/46; H01M 50/204; H01M 50/247; H01M 2220/30

(57) ABSTRACT

A power tool battery charger includes a housing, at least one charging circuit coupled to the housing, and an electronic controller coupled to the housing. The electronic controller is configured to receive power tool device data from a power tool device, which may be the same or another power tool battery charger, a battery pack, and/or a power tool. The power tool device data indicate various data associated with the power tool device. Charger operation data are generated by the electronic controller based on the power tool device data, and can include a charging rate, charging target, and/or time indication for when to adjust the charging rate and/or charging target of the at least one charging circuit. A machine learning or artificial intelligence controller can also be used when generating the charger operation data. The at least one charging circuit is then operated based on the charger operation data. Alternatively the above functions can be provided by a battery pack for use with a power tool, the battery pack comprising a charging circuit.

### CROSS-REFERENCE TO RELATED APPLICATIONS

This application claims the benefit of U.S. Provisional Patent Application Ser. No. 63/272,565, filed on Oct. 27, 2021, and entitled “SMART POWER TOOL BATTERY CHARGER BASED ON A CHARGING STATE,” which is herein incorporated by reference in its entirety.

### BACKGROUND

Power tools are typically powered by portable battery packs. These battery packs range in battery chemistry and nominal voltage and can be used to power numerous power tools and electrical devices. A power tool battery charger includes one or more battery charger circuits that are connectable to a power source and operable to charge one or more power tool battery packs connected to the power tool battery charger.

### SUMMARY OF THE DISCLOSURE

The present disclosure addresses the aforementioned drawbacks by providing a power tool battery charger that includes a housing, at least one charging circuit coupled to the housing and configured to charge a battery pack coupled thereto, and an electronic controller coupled to the housing and in communication with the at least one charging circuit. The electronic controller includes an electronic processor configured to receive power tool device data from a power tool device, where the power tool device data include data indicative of a use of the power tool device. The electronic controller is also configured to generate, based on the power tool device data, charger operation data indicating at least one of a charging rate of the at least one charging circuit, a charging target of the at least one charging circuit, or a time indication for when to adjust at least one of the charging rate or charging target of the at least one charging circuit. The electronic controller is configured to operate the at least one charging circuit based on the charger operation data.

Some embodiments provide a battery pack for use with a power tool, where the battery pack includes a housing and a plurality of battery cells arranged within the housing. The battery cells are configured to provide electrical power to a power tool when the power tool is coupled to the battery pack. At least one charging circuit is also coupled to the housing and configured to provide electrical power to the plurality of battery cells to charge the plurality of battery cells when coupled to a power tool battery charger, and to discharge the plurality of battery cells to provide the electrical power to a power tool when coupled to the power tool. An electronic controller is also coupled to the housing and in communication with the at least one charging circuit. The electronic controller includes an electronic processor configured to receive power tool device data from a power tool device, where the power tool device data include data indicative of a use of the power tool device. The electronic controller is also configured to generate, based on the power tool device data, charger operation data indicating at least one of a charging rate of the at least one charging circuit, a charging target of the at least one charging circuit, or a time indication for when to adjust at least one of the charging rate or charging target of the at least one charging circuit. The electronic controller is configured to operate the at least one charging circuit based on the charger operation data.

### BRIEF DESCRIPTION OF THE DRAWINGS

The accompanying drawings, which are incorporated in and form a part of this specification, illustrate embodiments of the disclosure and, together with the description, serve to explain principles of the embodiments.

FIG. 1 illustrates a first power tool battery charger system.

FIG. 2 illustrates a second power tool battery charger system.

FIG. 3 illustrates a third power tool battery charger system.

FIGS. 4A and 4B illustrates a fourth power tool battery charger system.

FIG. 5 illustrates a fifth power tool battery charger system.

FIG. 6 illustrates a sixth power tool battery charger system.

FIG. 7A is a block diagram of an example power tool battery charger of the power tool battery charger systems of FIGS. 1-5.

FIG. 7B is a block diagram of a machine learning controller of the power tool battery charger of FIG. 7A.

FIG. 7C is a block diagram of an example battery pack of the power tool battery charger system of FIG. 6.

FIG. 8 is a flowchart illustrating a method of building and implementing a machine learning controller for the power tool battery charger of FIG. 7A and/or the battery pack of FIG. 7C.

FIG. 9 is a flowchart illustrating a method of operating the power tool battery charger of FIG. 7A to the machine learning controller.

FIG. 10 is a flowchart illustrating a method of operating the battery pack of FIG. 7C and the power tool battery charger of FIG. 7A in order to adjust charging of one or more battery packs based on a determined charging state.

FIG. 11 illustrates an example graphical user interface illustrating a charging state that can be selected by a user to control operation of a battery pack and/or power tool battery charger.

FIGS. 12A-12C illustrate examples of charging state indicators implemented by a battery pack and/or power tool battery charger that can indicate the charging state, charging rate, charging target(s), and charge level of the battery pack.

FIGS. 13A-13D illustrate examples of battery pack retake time data mapped to a control parameter (FIG. 13A) and example control logics (FIGS. 13B-13D) for constructing the mapping function and/or estimating the control parameter.

FIGS. 14A-14C illustrate examples of estimating or otherwise determining working hours for a power tool device, such as a battery pack, a power tool battery charger, and/or a power tool.

FIGS. 15A-15D illustrates example control logics for determining a charging target for a battery pack based on power tool device data.

FIG. 16 illustrates an example two-dimensional parameterization for determining a charging state and/or generating charger operation data based on power tool device data.

FIGS. 17A-17C illustrate example power tool battery charger configurations that can be implemented by the power tool battery charger systems of FIGS. 1-5.

FIGS. 18A-18E illustrate example power tool battery packs that can be implemented with the power tool battery charger systems of FIGS. 1-6.

FIG. 19 illustrates a power system that can implement a power tool battery charger system.

### DETAILED DESCRIPTION

Some power tool battery chargers include sensors and a control system that uses hard-corded thresholds to, for example, change or adjust the operation of the battery charger. For example, a sensor may detect that a temperature is above a predetermined, hard-coded threshold. The power tool battery charger may then cease operation of the charging circuit to protect the battery pack and/or power tool battery charger. While these type of thresholds may be simple to implement and provide some benefit to the operation of a power tool battery charger, these type of hard-coded thresholds cannot adapt to changing conditions or applications during which the power tool battery charger is operated, and may not ultimately be helpful in detecting and responding to more complicated conditions such as, for example, when the power tool battery charger is connected to a power source that provides an inconsistent or unreliable source of power, when a user desires a change in charging operation based on working conditions, when usage of power tools and battery packs indicate usage patterns that can drive more optimized charger operation, when environmental or other external conditions (e.g., the power tool battery charger location) indicate that changes to charger operation may be optimal, and so on.

By knowing when a user might need their batteries charged, a power tool battery charger can be optimized for its charging and other power tool battery/power tool battery charger extras (e.g., cell balancing, maintenance/inspection). Additionally, by understanding the use patterns of the user(s), power tool batteries, and/or other factors (e.g., time of day, day of week, cost of electricity, jobsite needs, weather, expected availability of additional energy (e.g., availability of AC plugs, such as when plugged in at night: availability of additional battery supplies: etc.), and the like), a power tool battery charger can include more informed control logic and provide improved charging.

Described here are various systems in which a machine learning controller, or artificial intelligence controller, is utilized to control a feature or function of the power tool battery charger and/or battery. For example, the machine learning controller and/or artificial intelligence controller, instead of implementing hard-coded thresholds determined and programmed by, for example, an engineer, detects conditions based on power tool device data that may include usage data, maintenance data, feedback data, power source data, sensor data, environmental data, operator data, location data, among other data, which may be associated with a power tool device, such as a power tool battery charger, a battery pack, a power tool, and/or a power tool pack adapter.

The power tool device data may be collected while the power tool battery charger, battery pack, and/or power tool are being used, or during previous uses of the power tool battery charger, battery pack, and/or power tool. In some embodiments, the machine learning controller and/or artificial intelligence controller determines adjustable parameters and/or thresholds that are used to operate the power tool battery charger based on, for example, a particular charging target, a particular charging rate, a particular time-of-day to charge, an order in which to charge multiple connected battery packs, timing indications for when to adjust a charging rate and/or charging target (e.g., a charging schedule), or combinations thereof. Accordingly, the parameters, thresholds, conditions, or combinations thereof are based on previous operation of the same type of power tool battery charger and may change based on input received from the user and further operations of the power tool battery charger (e.g., in response to power tool device data acquired while operating the power tool battery charger, battery pack, power tool, and/or power tool pack adapter).

Usage data may include usage data for a power tool battery charger, a power tool battery pack, a power tool, or other devices connected to a power tool device network, such as wireless communication devices, control hubs, access points, and/or peripheral devices (e.g., smartphones, tablet computers, laptop computers, portable music players, and the like).

Usage data for a power tool battery charger may include operation time of the power tool battery charger (e.g., how long the power tool battery charger is used in each session, the amount of time between sessions of power tool battery charger usage, and the like), times of day when battery packs are being put on and/or taken off of the power tool battery charger, unique identifiers of battery packs being put on and/or taken off of the power tool battery charger, specific hours when work is being performed on a jobsite (or being performed more or less frequently on the jobsite), days of the week when work is being performed on a jobsite (or being performed more or less frequently on the jobsite), charging patterns, a retake time (e.g., a time associated with how quickly a battery pack is taken off of a power tool battery charger) working hours associated with the power tool battery charger, and the like. In some embodiments, usage data may include data indicating the order in which batteries are put on a power tool battery charger with multiple charging ports, or on power tool battery chargers in a network of connected (e.g., wired or wirelessly) power tool battery chargers.

Usage data for a battery pack may include operation time of the battery pack (e.g., how long the battery pack is used in each session, the amount of time between sessions of battery pack usage, and the like), the types of power tool(s) on which the battery pack is being used, the frequency with which the battery pack is being used, the frequency with which the battery pack is being used with a particular power tool or power tool type, the frequency with which the battery pack is charged on a particular power tool battery charger or power tool battery charger type, the current charge capacity of the battery pack (e.g., the state of charge of the battery pack), the number of charge cycles the battery pack has gone through, the estimated remaining useful life of the battery pack, a retake time (e.g., a time associated with how quickly a battery pack is taken off of a power tool battery charger) working hours associated with the battery pack, and the like. The state of charge of a battery pack may be, for example, a one-dimensional state of charge (e.g., percent charge, voltage, coulombs, amp-hour (“Ah”), etc.). In some embodiments, usage data may include data indicating the usage of a particular battery.

For example, if a user commonly places a particular battery on a power tool battery charger so that the battery charges before other batteries, then the power tool battery charger may learn to prioritize that given battery. For instance, if a user commonly indicates they want a given battery charged at a faster rate, a power tool battery charger may adjust its charging action to prioritize speed over life for that particular battery, that particular type of battery, similar batteries, and the like.

Usage data for a power tool may include the operation time of the power tool (e.g., how long the power tool is used in each session, the amount of time between sessions of power tool usage, and the like): whether a particular battery pack is used with the power tool and/or the frequency with which the particular battery pack is used with the power tool; whether a particular battery pack type is used with the power tool and/or the frequency with which the particular battery pack is used with the power tool: the type of power tool applications the power tool is frequently used for: information regarding changes in bits, blades, or other accessory devices for the power tool: working hours associated with the power tool; and the like.

Maintenance data may include maintenance data for a power tool battery charger, a power tool battery, and/or a power tool. For example, maintenance data may include a log of prior maintenance, suggestions for future maintenance, and the like.

Feedback data may include data indicating the manner in which a battery pack is put on a power tool battery charger, such as how forcefully the battery pack is put on the charger, whether a prolonged force is applied when placing the battery pack on the charger (e.g., by a user putting a battery pack on a power tool battery charger and holding down the battery pack for a duration of time), whether the battery pack is rapidly and repeatedly put on and taken off of the charger, whether the battery pack is returned to the charger shortly after being taken off the charger, and the like. For example, a bounce detector may detect if a battery pack is placed smoothly or with high speed or high force on a charger. While a debounce logic is usually made to avoid the bouncing characteristic of electrical contacts, the contact/disconnect/reconnect logic can be used as a feedback and/or direct command on how a battery should be charged. In some embodiments, the feedback data may include data associated with a charging port that has a mechanical means of detecting user force or prolonged force. For instance, a load cell, strain sensor, spring, or biased charging port with a sensing for depression may be used as feedback or a direct command to a charger.

Power source data may include data indicating a type of power source (e.g., AC power source, DC power source, battery power source), a type of electricity input of the power source (e.g., 120 V wall outlet, 220 V wall outlet, solar power, gas inverter, wireless charger, another power tool battery pack, another power tool battery charger, an internal battery, a supercapacitor, an internal energy storage device, a vehicle), a cost of the electricity input of the power source, and the like.

In some embodiments, the power source data can include data indicating electrical characteristics or properties of the electrical grid or circuit associated with the power source. For example, the power source data can include data indicating whether the electrical grid is balanced. As another example, the power source data can include data indicating whether circuit breakers on the electrical circuit local to the power source are likely to be tripped. For instance, the power source data may include voltage curves that can be analyzed to predict when a breaker might trip, among other uses. Additionally or alternatively, the power source data can include current and/or phase angle data, which may be analyzed to predict when a breaker might trip, among other uses. As still another example, the power source data can include data indicating other characteristics of the power source, such as when the power source supplies power in a noncontinuous manner, as may be the case for solar power, then the power source data can indicate the noncontinuous manner in which power is supplied by the power source. In these instances, the power source data can be used to optimize the charging action of the power tool battery charger, such as by adjusting the charging rate in response to increases and decreases in the available power being supplied by the power source.

Sensor data may include sensor data collected using one or more sensors (e.g., voltage sensor, a current sensor, a temperature sensor, an inertial sensor) of the power tool battery charger, battery pack, and/or power tool. For example, the sensor data may include voltage sensor data indicating a measured voltage associated with the power tool battery charger, battery pack, and/or power tool. For example, such a measured voltage may include a voltage measured across positive and negative power terminals of a power tool battery charger, battery pack, and/or power tool. Likewise, the sensor data may include current sensor data indicating a measured current associated with the power tool battery charger, battery pack, and/or power tool. For example, such a measured current may include a charging current provided from a power tool battery charger and/or received by a battery pack (e.g., at power terminals of the power tool battery charger or battery pack). Additionally, such a measured current may include a discharge current provided from a battery pack and/or received by a power tool (e.g., at power terminals of the battery pack or power tool). Additionally or alternatively, the sensor data may include temperature sensor data that indicate an internal and/or operating temperature of the power tool battery charger, battery pack, and/or power tool. In some embodiments, the sensor data can include inertial sensor data, such as accelerometer data, gyroscope data, and/or magnetometer data. These inertial sensor data can indicate a motion of the power tool battery charger, battery pack, and/or power tool, and can be processed by an electronic controller to determine a force, angular rate, and/or orientation of the power tool battery charger, battery pack, and/or power tool.

Environmental data may include data indicating a characteristic or aspect of the environment in which the power tool battery charger, battery pack, and/or power tool is located. For example, environmental data can include data associated with the weather, a temperature (e.g., external temperature) of the surrounding environment, the humidity of the surrounding environment, and the like.

Operator data may include data indicating an operator and/or owner of a power tool battery charger, a battery pack, a power tool, and the like. For example, operator data may include an operator identifier (ID), an owner ID, or both.

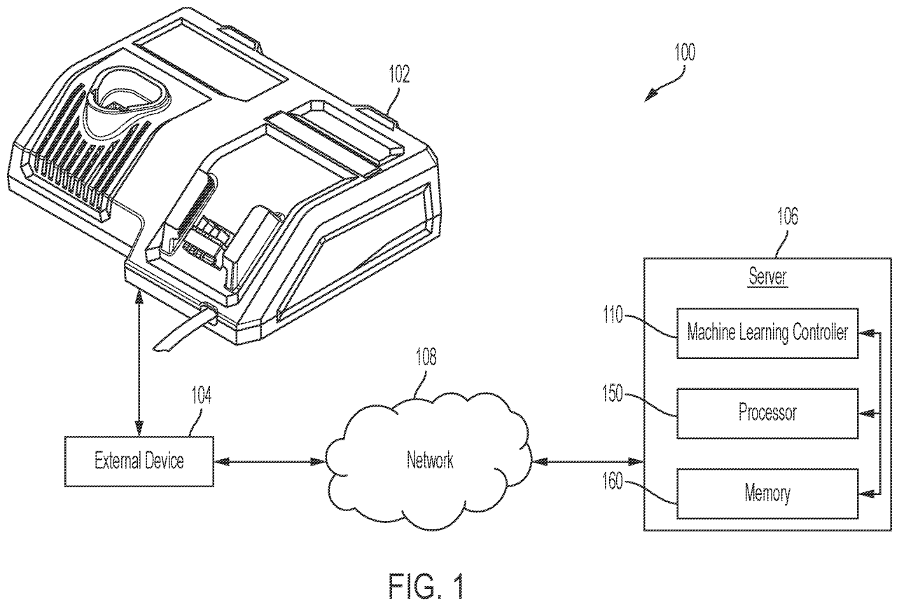

Location data may include data indicating a location of a power tool battery charger, a battery pack, a power tool, and the like. In some embodiments, the location data may indicate a physical location of the power tool battery charger, the battery pack, and/or power tool. For example, the physical location may be represented using geospatial coordinates, such as those determined via GNSS or the like. As another example, the physical location may be represented as a jobsite location (e.g., an address, an identification of a jobsite location) and may include a location within a jobsite (e.g., a particular floor in a skyscraper or other building under construction). In some other embodiments, the location data may indicate a location of the power tool battery charger, the battery pack, and/or power tool for inventory management and tracking. FIG. 1 illustrates a first power tool battery charger system 100. The first power tool battery charger system 100 includes a power tool battery charger 102, an external device 104, a server 106, and a network 108. The power tool battery charger 102 includes various sensors and devices that collect usage information, or data, during the operation of the power tool battery charger 102. The usage information, or data, may alternatively be referred to as operational information, or data, of the power tool battery charger 102, and refers to, for example, data regarding the operation of the power tool battery charger (e.g., current, position, acceleration, temperature, usage time, and the like), the operating mode of the power tool battery charger 102 (e.g., pre-charge mode, constant current regulation mode, constant voltage regulation mode, fast charge mode, operation time in each mode, frequency of operation in each mode, and the like), conditions encountered during operation (e.g., battery and/or charger overheating, whether circuit breakers on a connected circuit are being tripped, and the like), and other aspects (e.g., state of charge of the battery, connected power source type, cost of electricity supplied from the connected power source, and the like). As described above, other power tool device data may also be collected by the power tool battery charger 102, including other usage data, maintenance data, user feedback data, power source data, environmental data, operator data, location data, amongst other data.

In the illustrated embodiment, the power tool battery charger 102 communicates with the external device 104. The external device 104 may include, for example, a smartphone, a tablet computer, a cellular phone, a laptop computer, a smart watch, and the like. The power tool battery charger 102 communicates with the external device 104, for example, to transmit at least a portion of the usage information for the power tool battery charger 102, to receive configuration information for the power tool battery charger 102, or a combination thereof. In some embodiments, the external device 104 may include a short-range transceiver to communicate with the power tool battery charger 102, and a long-range transceiver to communicate with the server 106. In the illustrated embodiment, the power tool battery charger 102 also includes a transceiver to communicate with the external device 104 via, for example, a short-range communication protocol such as Bluetooth® or Wi-Fi®. In some embodiments, the external device 104 bridges the communication between the power tool battery charger 102 and the server 106. For example, the power tool battery charger 102 may transmit operational data to the external device 104, and the external device 104 may forward the operational data from the power tool battery charger 102 to the server 106 over the network 108.

The network 108 may be a long-range wireless network such as the Internet, a local area network (“LAN”), a wide area network (“WAN”), or a combination thereof. In other embodiments, the network 108 may be a short-range wireless communication network, and in yet other embodiments, the network 108 may be a wired network using, for example, USB cables, or may include a combination of long-range, short-range, and/or wired connections. In some embodiments, the network 108 may include both wired and wireless devices and connections. Similarly, the server 106 may transmit information to the external device 104 to be forwarded to the power tool battery charger 102. In some embodiments, the power tool battery charger 102 bypasses the external device 104 to access the network 108 and communicate with the server 106 via the network 108. In some embodiments, the power tool battery charger 102 is equipped with a long-range transceiver instead of or in addition to the short-range transceiver. In such embodiments, the power tool battery charger 102 communicates directly with the server 106 or with the server 106 via the network 108 (in either case, bypassing the external device 104). In some embodiments, the power tool battery charger 102 may communicate directly with both the server 106 and the external device 104. In such embodiments, the external device 104 may, for example, generate a graphical user interface to facilitate control and programming of the power tool battery charger 102, while the server 106 may store and analyze larger amounts of operational data for future programming or operation of the power tool battery charger 102. In other embodiments, however, the power tool battery charger 102 may communicate directly with the server 106 without utilizing a short-range communication protocol with the external device 104.

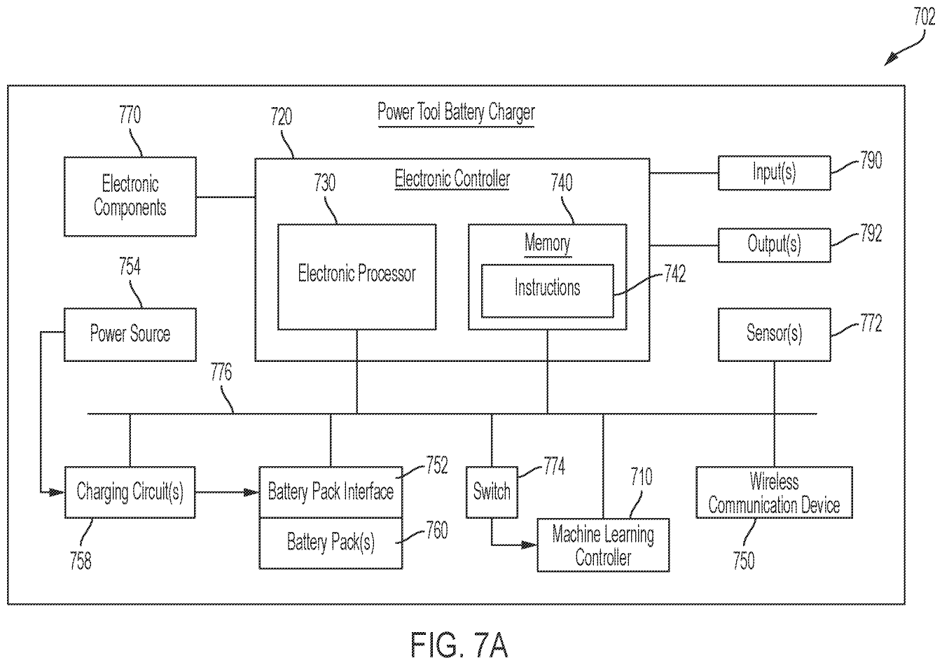

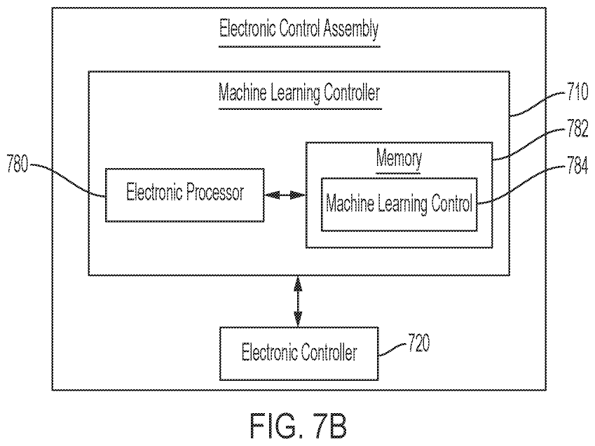

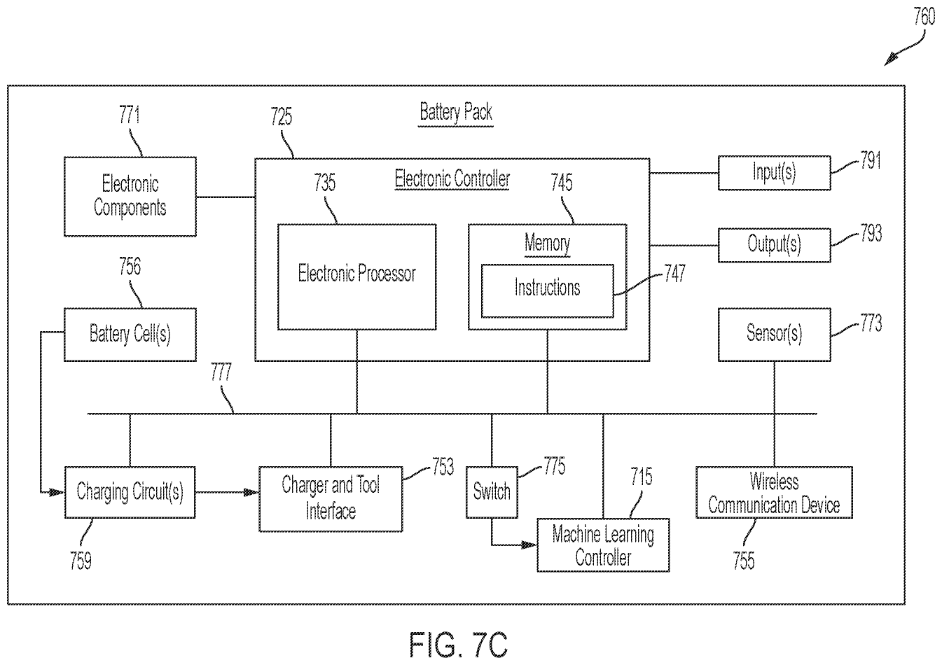

The server 106 includes a server electronic control assembly having a server electronic processor 150, a server memory 160, a transceiver, and a machine learning controller 110. The transceiver allows the server 106 to communicate with the power tool battery charger 102, the external device 104, or both. The server electronic processor 150 receives usage data and/or other power tool device data from the power tool battery charger 102 (e.g., via the external device 104, via one or more sensors), stores the received usage data and/or other power tool device data in the server memory 160, and, in some embodiments, uses the received usage data and/or other power tool device data for constructing, training, adjusting, and/or executing a machine learning controller 110. That is, the machine learning controller 110 may be software or a set of instructions executed by the server processor 150 to implement the functionality of the machine learning controller 110 described herein. In some examples, the machine learning controller 110 includes a separate processor and memory (e.g., as described with respect to FIG. 7B) to execute the software or instructions to implement the functionality of the machine learning controller 110 described herein.

The server 106 may maintain a database (e.g., on the server memory 160) for containing power tool device data, trained machine learning controls (e.g., trained machine learning model and/or algorithms) artificial intelligence controls (e.g., rules and/or other control logic implemented in an artificial intelligence model and/or algorithm), and the like.

Although illustrated as a single device, the server 106 may be a distributed device in which the server electronic processor 150 and server memory 160 are distributed among two or more units that are communicatively coupled (e.g., via the network 108).

The machine learning controller 110 implements a machine learning program, algorithm or model. In some implementations, the machine learning controller 110 is configured to construct a model (e.g., building one or more algorithms) based on example inputs, which may be done using supervised learning, unsupervised learning, reinforcement learning, ensemble learning, active learning, transfer learning, or other suitable learning techniques for machine learning programs, algorithms, or models. Additionally or alternatively, the machine learning controller 110 is configured to modify a machine learning program, algorithm, or model: to active and/or deactivate a machine learning program, algorithm, or model: to switch between different machine learning programs, algorithms, or models; and/or to change output thresholds for a machine learning program, algorithms, or model.

As a non-limiting example, the machine learning controller 110 can construct a machine learning program, algorithm, or model using supervised learning techniques, or alternatively can access a machine learning program, algorithm, or model previously constructed using supervised learning techniques. Supervised learning involves presenting a computer program with example inputs and their actual outputs (e.g., categorizations). In these instances, the machine learning controller 110 is configured to learn a general rule or model that maps the inputs to the outputs based on the provided example input-output pairs.

The machine learning algorithm may be configured to implement various different types of machine learning algorithms or models. For example, the machine learning controller 110 may implement decision tree learning, association rule learning, artificial neural networks, recurrent neural networks, long short-term memory models, inductive logic programming, support vector machines, clustering, Bayesian networks, reinforcement learning, representation learning, similarity and metric learning, sparse dictionary learning, genetic algorithms, k-nearest neighbors (“KNN”) classifiers, among others, such as those listed in Table 1 below.

TABLE 1

| | |
|---|---|
| Recurrent | Recurrent neural networks (“RNNs”), long short-term memory |
| Models | (“LSTM”) models, gated recurrent unit (“GRU”) models, |
| | Markov processes, reinforcement learning |
| Non-Recurrent | Deep neural networks (“DNNs”), convolutional neural networks |
| Models | (“CNNs”), support vector machines (“SVMs”), anomaly |
| | detection (e.g., using principal component analysis (“PCA”), |
| | logistic regression, decision trees/forests, ensemble methods |
| | (e.g., combining models), polynomial/Bayesian/other |
| | regressions, stochastic gradient descent (“SGD”), linear |
| | discriminant analysis (“LDA”), quadratic discriminant analysis |
| | (“QDA”), nearest neighbors classifications/regression, naive |
| | Bayes, etc. |

The machine learning controller 110 can be programmed and trained to perform a particular task. For example, in some embodiments, the machine learning controller 110 is trained to adjust a charging target, a charging rate, a time-of-day when to charge, or combinations thereof, based on data regarding the operation of the power tool battery charger, the operating mode of the power tool battery charger, a condition encountered when operating the power tool battery charger, or other aspects. The task for which the machine learning controller 110 is trained may vary based on, for example, the type of power tool battery charger, a selection from a user, typical applications for which the power tool battery charger is used, the type of power source to which the power tool battery charger is connected, and the like.

Similarly, the way in which the machine learning controller 110 is trained also varies based on the particular task. For instance, the training examples, or data, used to train the machine learning controller 110 may include different information based on the task of the machine learning controller 110. As a non-limiting example in which the machine learning controller 110 is configured to adjust a charging target, charging rate, and/or time-of-day to charge based on the type of power source to which the power tool battery charger is connected, each training example may include a set of inputs such as power source voltage, power source current, cost of electricity supplied by the power source, and the like. Each training example generally also includes a specified output. For example, when the machine learning controller 110 is trained to identify the type of power source to which the power tool battery charger is connected, a training example may have an output that includes a classification of the power source type (e.g., a 120 V power source, a 220 V power source, a solar power source, a gas inverter power source, a wireless power source, whether another battery pack on a multi-bay charger is acting as the power source, whether the power source is an internal power source). Other training examples may include different values for each of the inputs and an output indicating charger operation data (e.g., charging rate(s), charging target(s), time indications of when to adjust charging rate(s) and/or target(s), order in which to charge battery packs on a multi-bay power tool battery charger). The training examples may be previously collected training examples from, for example, a plurality of power tool battery chargers, batteries, power tools, and the like. For example, the training examples may have been previously collected from, for example, several hundred power tool battery chargers of the same type over a span of, for example, one month, six months, one year, or another time period.

A plurality of different training examples is provided to the machine learning controller 110. The machine learning controller 110 uses these training examples to generate a model (e.g., a rule, a set of equations, and the like) that helps categorize or estimate the output based on new input data. The machine learning controller 110 may weigh different training examples differently to, for example, prioritize different conditions or outputs from the machine learning controller 110. For example, a training example corresponding to a first set of charger operation data may be weighted more heavily than a training example corresponding to a second set of charger operation data in order to prioritize the optimization of the first set of charger operation data relative to the second set of charger operation data in certain instances. For instance, the first set of charger operation data may indicate faster charging at the expense of battery wear and the second set of charger operation data may indicate more efficient charging that minimizes battery wear, and the operational needs of the power tool battery charger may indicate that faster charging would be preferable. In some embodiments, the training examples are weighted differently by associating a different cost function or value to specific training examples or types of training examples.

In one example, the machine learning controller 110 implements an artificial neural network. The artificial neural network generally includes an input layer, one or more hidden layers or nodes, and an output layer. Typically, the input layer includes as many nodes as inputs provided to the machine learning controller 110. As described above, the number (and the type) of inputs provided to the machine learning controller 110 may vary based on the particular task for the machine learning controller 110. Accordingly, the input layer of the artificial neural network of the machine learning controller 110 may have a different number of nodes based on the particular task for the machine learning controller 110.

The input layer connects to the one or more hidden layers. The number of hidden layers varies and may depend on the particular task for the machine learning controller 110. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. However, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is associated with an activation function. The activation function defines how the hidden layer is to process the input received from the input layer or from a previous input or hidden layer. These activation functions may vary and be based on not only the type of task associated with the machine learning controller 110, but may also vary based on the specific type of hidden layer implemented.

Each hidden layer may perform a different function. For example, some hidden layers can be convolutional hidden layers which can, in some instances, reduce the dimensionality of the inputs, while other hidden layers can perform more statistical functions such as max pooling, which may reduce a group of inputs to the maximum value, an averaging layer, among others. In some of the hidden layers (also referred to as “dense layers”), each node is connected to each node of the next hidden layer. Some neural networks including more than, for example, three hidden layers may be considered deep neural networks.

The last hidden layer in the artificial neural network is connected to the output layer. Similar to the input layer, the output layer typically has the same number of nodes as the possible outputs. In an example in which the machine learning controller 110 identifies a use application of the battery charger 102, the output layer may include, for example, a number of different nodes, where each different node corresponds to a different set of charger operation data. A first node may indicate that the use application corresponds to an instance where faster charging is desired at the expense of battery wear, and a second node may indicate that the use application corresponds to an instance where more efficient charging is acceptable at the expense of overall charging time, and a third node may indicate that the use application corresponds to an unknown (or unidentifiable) set of charger operation data. In some embodiments, the machine learning controller 110 then selects the output node with the highest value and indicates the corresponding use application to the power tool battery charger 102 or to the user. In some embodiments, the machine learning controller 110 may also select more than one output node.

The machine learning controller 110 or the electronic controller of the power tool battery charger 102 (e.g., electronic controller 720) may then use the one or more outputs to control the power tool battery charger 102 (e.g., by controlling operation of one or more charging circuits of the power tool battery charger 102). For example, the machine learning controller 110 may identify the use application of the power tool battery charger 102 and may determine an optimal set of charger operation data (e.g., charging rate(s), charging target(s), time indications of when to adjust charging rate(s) and/or target(s), an order in which the prioritize charging battery packs) for the power tool battery charger 102. The machine learning controller 110 or the electronic controller of the power tool battery charger 102 may then, for example, control the charging circuit(s) (e.g., charging circuit(s) 758) to adjust the current supplied to the battery pack(s) in order to adjust the charging rate(s) and/or target(s). The machine learning controller 110 and the electronic processor of the power tool battery charger 102 may implement different methods of combining the outputs from the machine learning controller 110.

During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and the like. Different types of training algorithms can be used to adjust the bias values and the weights of the node connections based on the training examples. The training algorithms may include, for example, gradient descent, Newton's method, conjugate gradient, quasi-Newton, Levenberg-Marquardt, among others.

In another example, the machine learning controller 110 implements a support vector machine or other suitable machine learning classifier algorithm or model to perform classification. The machine learning controller 110 may, for example, classify the type of charging state frequently used to control the charging of a particular battery pack using the power tool battery charger 102. In such embodiments, the machine learning controller 110 may receive inputs such as usage data, which may include retake time data and/or working hours data. The machine learning controller 110 then defines a margin using combinations of some of the input variables as support vectors to maximize the margin. In some embodiments, the machine learning controller 110 defines a margin using combinations of more than one of similar input variables. The margin corresponds to the distance between the two closest vectors that are classified differently. For example, the margin corresponds to the distance between a vector representing a first charging state and a vector that represents a second charging state. In some embodiments, the machine learning controller 110 uses more than one support vector machine to perform a single classification. For example, when the machine learning controller 110 classifies the type of charging state for a battery pack, a first support vector machine may determine the charging state based on usage data of the battery pack, while a second support vector machine may determine the charging state based on previous charger operation data (e.g., prior charger operation data indicating charging rate(s), charging target(s), and/or charging schedule(s) used by the power tool battery charger 102 or another power tool battery charger to charge the battery pack). The machine learning controller 110 may then determine whether the power tool battery charger 102 is connected to a battery pack that should be charged according to the charging state when both support vector machines classify the charging state type. In other embodiments, a single support vector machine can use more than two input variables and define a hyperplane that separates one charging state type from other charging state types.

The training examples for a support vector machine include an input vector including values for the input variables (e.g., usage data, voltage, current, and the like), and an output classification indicating whether the charging state type is a particular charging state (e.g., a performance optimized charging state, a battery life optimized charging state). During training, the support vector machine selects the support vectors (e.g., a subset of the input vectors) that maximize the margin. In some embodiments, the support vector machine may be able to define a line or hyperplane that accurately separates one charging state type from other charging state types. In other embodiments (e.g., in a non-separable case), however, the support vector machine may define a line or hyperplane that maximizes the margin and minimizes the slack variables, which measure the error in a classification of a support vector machine. After the support vector machine has been trained, new input data can be compared to the line or hyperplane to determine how to classify the new input data (e.g., what type of charging state the power tool battery charger 102 should use when determining charger operation data for charging the battery pack).

In other embodiments, as mentioned above, the machine learning controller 110 can implement different machine learning algorithms to make an estimation or classification based on a set of input data.

In the example of FIG. 1, the server 106 receives usage information and other power tool device data from the power tool battery charger 102. In some embodiments, the server 106 uses the received power tool device data as additional training examples (e.g., when the actual value or classification is also known). In other embodiments, the server 106 sends the received power tool device data to the trained machine learning controller 110. The machine learning controller 110 then generates an estimated value or classification based on the input power tool device data. The server electronic processor 150 then generates recommendations for future operations of the power tool battery charger 102. For example, the trained machine learning controller 110 may determine that, based on usage data in the power tool device data, the power tool battery charger 102 is currently charging a battery pack that is routinely put on the charger once at the end of a work day and not needed again until the next morning. The server electronic processor 150 may then determine that charger operation data indicating an optimal set of charging rate(s) and charging target(s) and corresponding time indications for charging actions to achieve the optimal charging target at the expected time of day when the battery pack will most likely be needed next, based on past usage data. The server 106 may then transmit the suggested operating parameters to the external device 104. The external device 104 may display the suggested changes to the operating parameters and request confirmation from the user to implement the suggested changes before forwarding the changes on to the power tool battery charger 102. In other embodiments, the external device 104 forwards the suggested changes to the power tool battery charger 102 and displays the suggested changes to inform the user of changes implemented by the power tool battery charger 102.

In particular, in the embodiment illustrated in FIG. 1, the server electronic processor 150 generates a set of parameters and updated thresholds recommended for the operation of the power tool battery charger 102 in particular modes. For example, the machine learning controller 110 may detect that, during various operations of the battery charger 102 for charging battery packs on a particular jobsite, the power tool battery charger 102 could have benefited from a different set of charger operation data that prioritized a first charging rate during the morning hours, a second faster charging rate during afternoon hours, and a third slower charger rate during overnight hours. The machine learning controller 110 may then adjust charger operation data to indicate the optimal charging rates and their associated time indications. The server 106 then transmits the updated charger operation data to the power tool battery charger 102 via the external device 104.

The power tool battery charger 102 receives the updated charger operation data, updates charging circuit controls according to the updated charger operation data, and operates according to the updated charger operation data when battery packs are put on the power tool battery charger 102 during the specified times of day. In some embodiments, the power tool battery charger 102 periodically transmits the usage data and/or other power tool device data to the server 106 based on a predetermined schedule (e.g., every eight hours). In other embodiments, the power tool battery charger 102 transmits the usage data and/or other power tool device data after a predetermined period of inactivity (e.g., when the power tool battery charger 102 has been inactive for two hours), which may indicate that a session of operation has been completed. In some embodiments, the power tool battery charger 102 transmits the usage data and/or other power tool device data in real time to the server 106 and may implement the updated thresholds and parameters in subsequent operations.

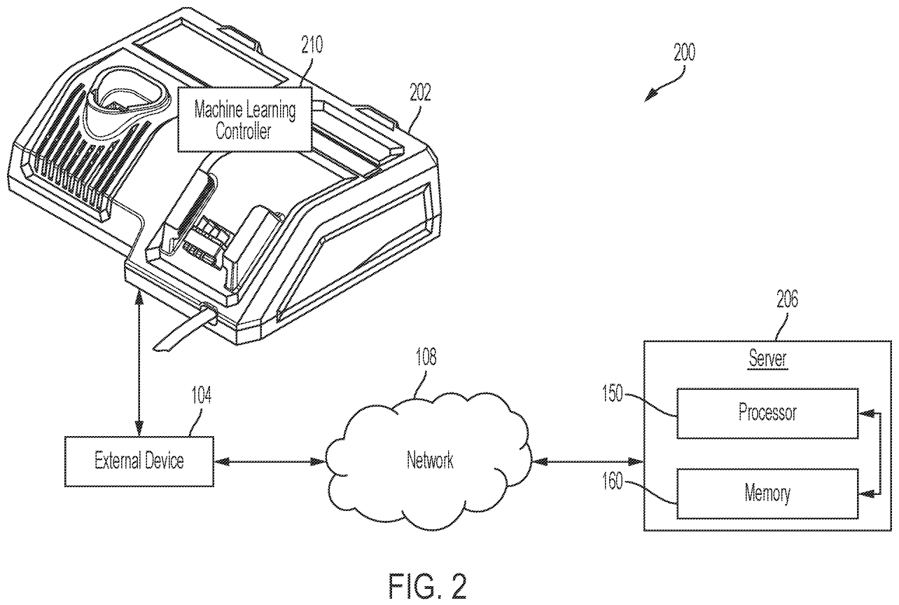

FIG. 2 illustrates a second power tool battery charger system 200. The second power tool battery charger system 200 includes a power tool battery charger 202, the external device 104, a server 206, and a network 108. The power tool battery charger 202 is similar to that of the first power tool battery charger system 100 of FIG. 1 and collects similar usage information as that described with respect to FIG. 1. Unlike the power tool battery charger 102 of the first power tool battery charger system 100, the power tool battery charger 202 of the second power tool battery charger system 200 includes a static machine learning controller 210. The machine learning controller 210 may be software or a set of instructions executed by a processor of the power tool battery charger 202 to implement the functionality of the machine learning controller 210 described herein. In some examples, the machine learning controller 210 includes a separate processor and memory (e.g., as described with respect to FIG. 7B) to execute the software or instructions to implement the functionality of the machine learning controller 210 described herein. In the illustrated embodiment, the power tool battery charger 202 receives the static machine learning controller 210 from the server 206 over the network 108 (e.g., receives the trained machine learning program, algorithm, or model to be executed by a processor of the power tool battery charger 202). In some embodiments, the power tool battery charger 202 receives the static machine learning controller 210 during manufacturing, while in other embodiments, a user of the power tool battery charger 202 may select to receive the static machine learning controller 210 after the power tool battery charger 202 has been manufactured and, in some embodiments, after operation of the power tool battery charger 202. The static machine learning controller 210 is a trained machine learning controller similar to the trained machine learning controller 110 in which the machine learning controller 110 has been trained using various training examples and is configured to receive new input data and generate an estimation or classification for the new input data.

The power tool battery charger 202 communicates with the server 206 via, for example, the external device 104 as described above with respect to FIG. 1. The external device 104 may also provide additional functionality (e.g., generating a graphical user interface) to the power tool battery charger 202. The server 206 of the power tool battery charger system 200 may utilize usage information from power tools, power tool battery chargers, and/or batteries similar to the power tool battery charger 202 and may train a machine learning program, algorithm, or model using training examples from the received usage information from the power tools, power tool battery chargers, and/or batteries. The server 206 then transmits the trained machine learning program, algorithm or model to the machine learning controller 210 of the power tool battery charger 202 for execution during future operations of the power tool battery charger 202.

Accordingly, the static machine learning controller 210 includes a trained machine learning program, algorithm, or model provided, for example, at the time of manufacture. During future operations of the power tool battery charger 202, the static machine learning controller 210 analyzes new usage data and/or other power tool device data from the power tool battery charger 202 and generates recommendations or actions based on the new usage data and/or other power tool device data. As discussed above with respect to the machine learning controller 110, the static machine learning controller 210 has one or more specific tasks such as, for example, determining a current application of the battery charger 102. In other embodiments, the task of the static machine learning controller 210 may be different. In some embodiments, a user of the power tool battery charger 202 may select a task for the static machine learning controller 210 using, for example, a graphical user interface generated by the external device 104. The external device 104 may then transmit the target task for the static machine learning controller 210 to the server 206. The server 206 then transmits a trained machine learning program, algorithm, or model, trained for the target task, to the static machine learning controller 210. Based on the estimations or classifications from the static machine learning controller 210, the power tool battery charger 202 may change its operation (e.g., change the operation of the charging circuit(s)), adjust one of the operating modes of the power tool battery charger 202, and/or adjust a different aspect of the power tool battery charger 202. In some embodiments, the power tool battery charger 202 may include more than one static machine learning controller 210, each having a different target task.

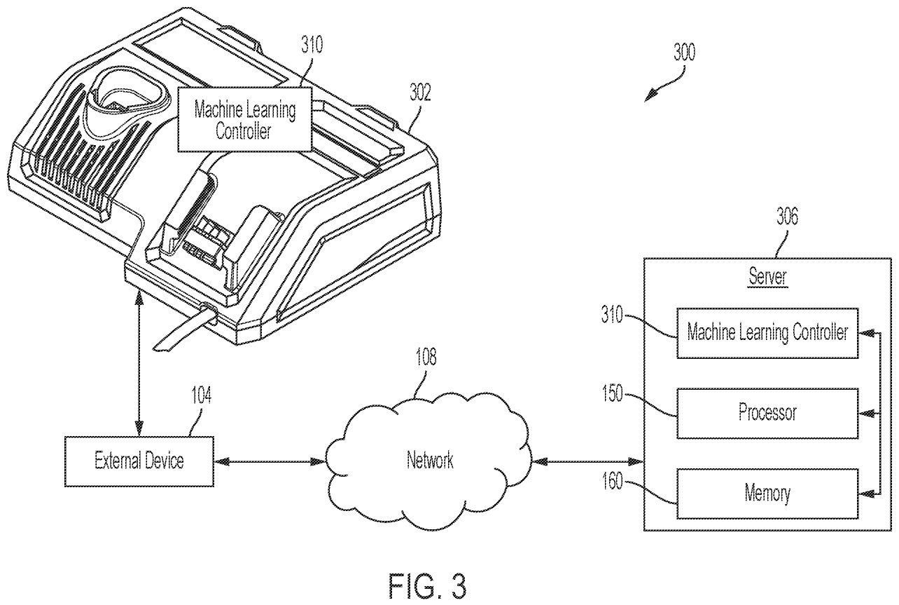

FIG. 3 illustrates a third power tool battery charger system 300. The third power tool battery charger system 300 also includes a power tool battery charger 302, an external device 104, a server 306, and a network 108. The power tool battery charger 302 is similar to the power tool battery chargers 102, 202 described above and includes similar sensors that monitor various types of usage information of the power tool battery charger 302, such as the usage information described above and with respect to FIG. 1. The power tool battery charger 302 of the third power tool battery charger system 300, however, includes an adjustable machine learning controller 310 instead of the static machine learning controller 220 of the second power tool battery charger 202. In the illustrated embodiment, the adjustable machine learning controller 310 of the power tool battery charger 302 receives the machine learning program, algorithm, or model from the server 306 over the network 108. Unlike the static machine learning controller 220 of the second power tool battery charger 202, the server 306 may transmit updated versions of the machine learning program, algorithm, or model to the adjustable machine learning controller 310 to replace previous versions.

The power tool battery charger 302 of the third power tool battery charger system 300 transmits feedback to the server 306 (via, for example, the external device 104) regarding the operation of the adjustable machine learning controller 310. The power tool battery charger 302, for example, may transmit an indication to the server 306 regarding the number of operations that were incorrectly classified by the adjustable machine learning controller 310. The server 306 receives the feedback from the power tool battery charger 302, updates the machine learning program, algorithm, or model, and provides the updated program to the adjustable machine learning controller 310 to reduce the number of operations that are incorrectly classified. Thus, the server 306 updates or re-trains the adjustable machine learning controller 310 in view of the feedback received from the power tool battery charger 302. In some embodiments, the server 306 also uses feedback received from similar power tools and/or batteries to adjust the adjustable machine learning controller 310. In some embodiments, the server 306 updates the adjustable machine learning controller 310 periodically (e.g., every week or month). In other embodiments, the server 306 updates the adjustable machine learning controller 310 when the server 306 receives a predetermined number of feedback indications (e.g., after the server 306 receives two feedback indications). The feedback indications may be positive (e.g., indicating that the adjustable machine learning controller 310 correctly classified a condition, event, operation, or combination thereof), or the feedback may be negative (e.g., indicating that the adjustable machine learning controller 310 incorrectly classified a condition, event, operation, or combination thereof).

In some embodiments, the server 306 also utilizes new usage data and/or other power tool device data received from the power tool battery charger 302 and batteries or power tools to update the adjustable machine learning controller 310. For example, the server 306 may periodically re-train (or adjust the training of) the adjustable machine learning controller 310 based on the newly received usage data and/or other power tool device data. The server 306 then transmits an updated version of the adjustable machine learning controller 310 to the power tool battery charger 302.

When the power tool battery charger 302 receives the updated version of the adjustable machine learning controller 310 (e.g., when an updated machine learning program is provided to and stored on the machine learning controller 310), the power tool battery charger 302 replaces the current version of the adjustable machine learning controller 310 with the updated version. In some embodiments, the power tool battery charger 302 is equipped with a first version of the adjustable machine learning controller 310 during manufacturing. In such embodiments, the user of the power tool battery charger 302 may request newer versions of the adjustable machine learning controller 310. In some embodiments, the user may select a frequency with which the adjustable machine learning controller 310 is transmitted to the power tool battery charger 302.

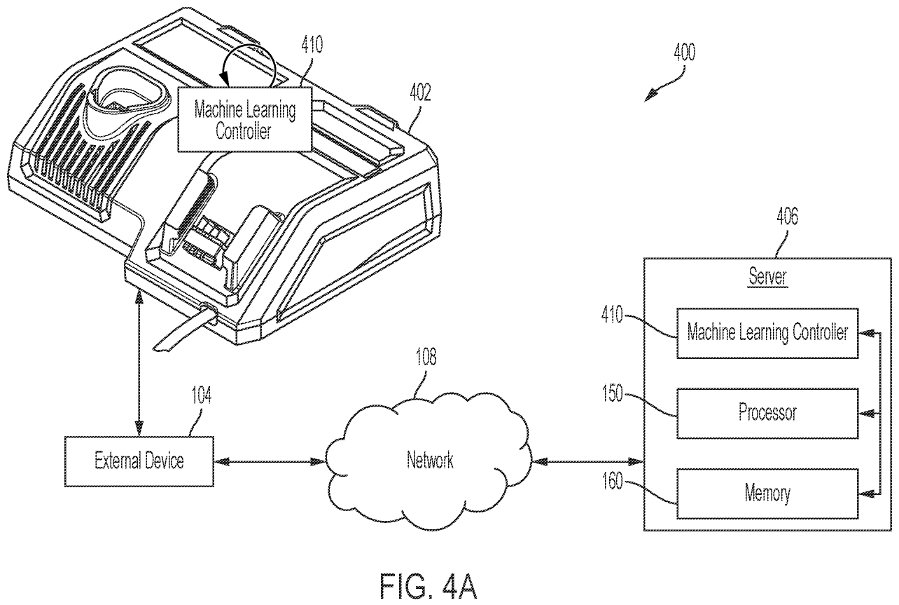

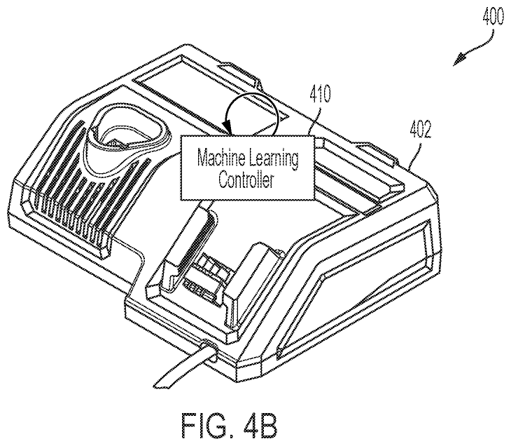

FIG. 4A illustrates a fourth power tool battery charger system 400. The fourth power tool battery charger system 400 includes a power tool battery charger 402, an external device 104, a server 406, and a network 108. The power tool battery charger 402 includes a self-updating machine learning controller 410. The self-updating machine learning controller 410 is first loaded on the power tool battery charger 402 during, for example, manufacturing. In other words, the power tool battery charger 402 receives a trained or partially trained machine learning program, algorithm, or model to be executed by a processor of the power tool battery charger 402. The self-updating machine learning controller 410 updates itself. In other words, the self-updating machine learning controller 410 receives new usage information from the sensors in the power tool battery charger 402, feedback information indicating desired changes to operational parameters (e.g., user wants to increase charging rate), feedback information indicating whether the classification made by the machine learning controller 410 is incorrect, or a combination thereof. The self-updating machine learning controller 410) then uses the received information to re-train the self-updating machine learning controller 410.

In some embodiments, the power tool battery charger 402 re-trains the self-updating machine learning controller 410 when the power tool battery charger 402 is not in operation. For example, the power tool battery charger 402 may detect when a battery is not connected to the power tool battery charger 402, when a battery is connected to the power tool battery charger 402, but fully charged, or when the power tool battery charger 402 has not been operated for a predetermined time period, and start a re-training process of the self-updating machine learning controller 410 while the power tool battery charger 402 remains non-operational.

Training the self-updating machine learning controller 410 while the power tool battery charger 402 is not operating allows more processing power to be used in the re-training process instead of competing for computing resources typically used to operate the power tool battery charger 402. Additionally or alternatively, the power tool battery charger 402 may also re-train the self-updating machine learning controller 410 when the power tool battery charger 402 is in a particular operational mode or another operational condition is met. For instance, the power tool battery charger 402 may detect when a battery pack is put on the power tool battery charger 402, and start a re-training process of the self-updating machine learning controller 410 (e.g., based on power tool device data retrieved from the battery pack recently put on the power tool battery charger 402).

As shown in FIG. 4A, in some embodiments, the power tool battery charger 402 also communicates with the external device 104 and a server 406. For example, the external device 104 communicates with the power tool battery charger 402 as described above with respect to FIGS. 1-3. The external device 104 generates a graphical user interface to facilitate the adjustment of operational parameters of the power tool battery charger 402. The external device 104 may also bridge the communication between the power tool battery charger 402 and the server 406. For example, as described above with respect to FIG. 2, in some embodiments, the external device 104 receives a selection of a target task for the machine learning controller 410. The external device 104 may then request a corresponding machine learning program, algorithm, or model from the server 406 for transmitting to the power tool battery charger 402.

The power tool battery charger 402 also communicates with the server 406 (e.g., via the external device 104). In some embodiments, the server 406 may also re-train the self-updating machine learning controller 410, for example, as described above with respect to FIG. 3. The server 406 may use additional training examples from other similar power tool battery chargers, from one or more batteries, and/or one or more power tools. Using these additional training examples may provide greater variability and ultimately make the machine learning controller 410 more reliable. In some embodiments, the power tool battery charger 402 re-trains the self-updating machine learning controller 410 when the power tool battery charger 402 is not in operation, and the server 406 may re-train the machine learning controller 410 when the power tool battery charger 402 remains in operation (for example, while the power tool battery charger 402 is in operation during a scheduled re-training of the machine learning controller 410). Accordingly, in some embodiments, the self-updating machine learning controller 410 may be re-trained on the power tool battery charger 402, by the server 406, or with a combination thereof. In some embodiments, the server 406 may employ federated learning, in which updates to machine learning models or submodels that are computed on a power tool battery charger 402, external device 104, and/or server 406 may be combined and then redistributed back to the power tool battery charger 402.

In some embodiments, the server 406 does not re-train the self-updating machine learning controller 410, but still exchanges information with the power tool battery charger 402. For example, the server 406 may provide other functionality for the power tool battery charger 402 such as, for example, transmitting information regarding various operating modes for the power tool battery charger 402.

Each of FIGS. 1-4A describes a power tool battery charger system 100, 200, 300, 400 in which a power tool battery charger 102, 202, 302, 402 communicates with a server 106, 206, 306, 406 and with an external device 104. As discussed above with respect to FIG. 1, the external device 104 may bridge communication between the power tool battery charger 102, 202, 302, 402 and the server 106, 206, 306, 406. That is, the power tool battery charger 102, 202, 302, 402 may communicate directly with the external device 104. The external device 104 may then forward the information received from the power tool battery charger 102, 202, 302, 402 to the server 106, 206, 306, 406. Similarly, the server 106, 206, 306, 406 may transmit information to the external device 104 to be forwarded to the power tool battery charger 102. 202, 302, 402. In such embodiments, the power tool battery charger 102, 202, 302, 402 may include a transceiver to communicate with the external device 104 via, for example, a short-range communication protocol such as Bluetooth® or Wi-Fi®. The external device 104 may include a short-range transceiver to communicate with the power tool battery charger 102, 202, 302, 402, and may also include a long-range transceiver to communicate with the server 106, 206, 306, 406. In some embodiments, a wired connection (via, for example, a USB cable) is provided between the external device 104 and the power tool battery charger 102, 202, 302, 402 to enable direct communication between the external device 104 and the power tool battery charger 102, 202, 302, 402. Providing the wired connection may provide a faster and more reliable communication method between the external device 104 and the power tool battery charger 102, 202, 302, 402.

The external device 104 may include, for example, a smartphone, a tablet computer, a cellular phone, a laptop computer, a smart watch, and the like. The server 106, 206, 306, 406 illustrated in FIGS. 1-4A includes at least a server processor 150, a server memory 430, and a transceiver to communicate with the power tool battery charger 102, 202, 302, 402 via the network 108. The server processor 150 receives usage data and/or other power tool device data from the power tool battery charger 102, 202, 302, 402, stores the usage data and/or other power tool device data in the server memory 430, and, in some embodiments, uses the received usage data and/or other power tool device data for constructing, training, and/or adjusting the machine learning controller 110, 210, 310, 410. The term external system device may be used herein to refer to one or more of the external device 104 and the server 106, 206, 306, 406, as each are external to the power tool battery charger 102, 202, 302, 402. Further, in some embodiments, the external system device is a wireless hub, such as a beaconing device put on a jobsite to monitor power tools, batteries, and/or power tool battery chargers: function as a gateway network device (e.g., providing Wi-Fi® network): or both. As described herein, the external system device includes at least an input/output unit (e.g., a wireless or wired transceiver) for communication, a memory storing instructions, and an electronic processor to execute instructions stored on the memory to carry out the functionality attributed to the external system device.

In some embodiments, the power tool battery charger 402 may not communicate with the external device 104 or the server 406. For example, FIG. 4B illustrates the power tool battery charger 402 with no connection to the external device 104 or the server 406. Rather, since the power tool battery charger 402 includes the self-updating machine learning controller 410, the power tool battery charger 402 can implement the machine learning controller 410, receive user feedback, usage data, operational data, and/or other power tool device data, and update the machine learning controller 410 without communicating with the external device 104 or the server 406.

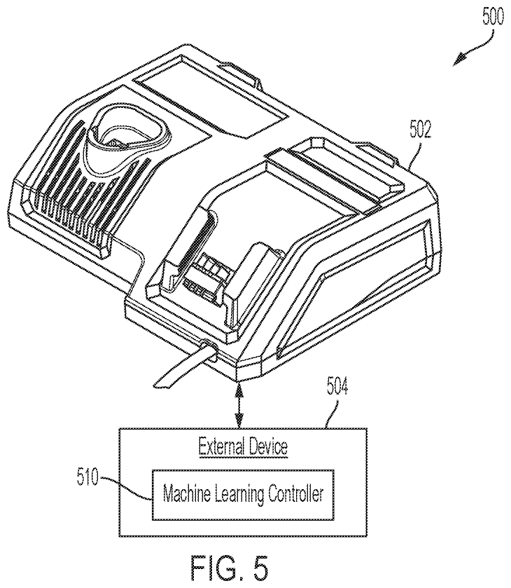

FIG. 5 illustrates a fifth power tool battery charger system 500 including a power tool battery charger 502 and an external device 504. The external device 504 communicates with the power tool battery charger 502 using the various methods described above with respect to FIGS. 1-4A. In particular, the power tool battery charger 502 transmits usage data, other power tool device data, and/or operational data regarding the operation of the power tool battery charger 502 to the external device 504. The external device 504 generates a graphical user interface to facilitate the adjustment of operational parameters of the power tool battery charger 502 and to provide information regarding the operation of the power tool battery charger 502 to the user.

In the illustrated embodiment of FIG. 5, the external device 504 includes a machine learning controller 510. In some embodiments, the machine learning controller 510 is similar to the machine learning controller 110 of FIG. 1. In such embodiments, the machine learning controller 510 receives the usage information from the power tool battery charger 502 and generates recommendations for future operations of the power tool battery charger 502. The machine learning controller 510 may, in such embodiments, generate a set of parameters and/or updated thresholds recommended for the operation of the power tool battery charger 502 in particular modes. The external device 504 then transmits the updated set of parameters and/or updated thresholds to the power tool battery charger 502 for implementation.

In some embodiments, the machine learning controller 510 is similar to the machine learning controller 310 of FIG. 3. In such embodiments, the external device 504 may update the machine learning controller 510 based on, for example, feedback received from the power tool battery charger 502 and/or other operational data from the power tool battery charger 502. In such embodiments, the power tool battery charger 502 also includes a machine learning controller similar to, for example, the adjustable machine learning controller 310 of FIG. 3. The external device 504 can then modify and update the adjustable machine learning controller 510 and communicate the updates to the machine learning controller 510 to the power tool battery charger 502 for implementation. For example, the external device 504 can use the feedback from the user, or other usage or operational data, to retrain the machine learning controller 510, to continue training a machine learning controller 510 implementing a reinforcement learning control, or may, in some embodiments, use the feedback or data to adjust a switching rate on a recurrent neural network, for example.

In some embodiments, as discussed briefly above, the power tool battery charger 502 also includes a machine learning controller. The machine learning controller of the power tool battery charger 502 may be similar to, for example, the static machine learning controller 210 of FIG. 2, the adjustable machine learning controller 310 of FIG. 3 as described above, or the self-updating machine learning controller 410 of FIG. 4A.

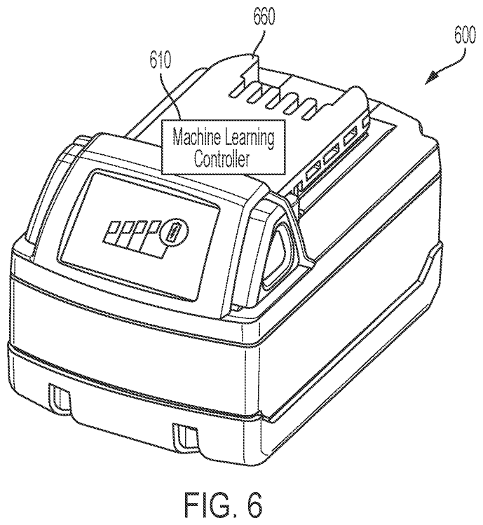

FIG. 6 illustrates a sixth power tool battery charger system 600 including a battery pack 660. The battery pack 660 includes a machine learning controller 610. Although not illustrated, the battery pack 660 may, in some embodiments, communicate with the external device 104, a server, or a combination thereof through, for example, a network. Alternatively, or in addition, the battery pack 660) may communicate with a power tool battery charger, such as a power tool battery charger 102, 202, 302, 402, 502 attached to the battery pack 660. The external device 104 and the server may be similar to the external device 104 and server 106, 206, 306, 406 described above with respect to FIGS. 1-4A. The machine learning controller 610 of the battery pack 660 may be similar to any of the machine learning controllers 210, 310, 410 described above. In one embodiment, the machine learning controller 610 controls operation of the battery pack 660. For example, the machine learning controller 610 may help identify different battery conditions that may be detrimental to the battery pack 660 and may automatically change (e.g., increase or decrease) the amount of current provided by or to the battery pack 660, and/or may change some of the thresholds that regulate the operation of the battery pack 660. For example, the battery pack 660 may, from instructions of the machine learning controller 610, reduce power to inhibit overheating of the battery cells. In some embodiments, the battery pack 660) communicates with a power tool and the machine learning controller 610 controls at least some aspects and/or operations of the power tool. For example, the battery pack 660) may receive usage data and/or other power tool device data (e.g., sensor data) from the power tool and generate outputs to control the operation of the power tool. The battery pack 660 may then transmit the control outputs to the electronic processor of the power tool.

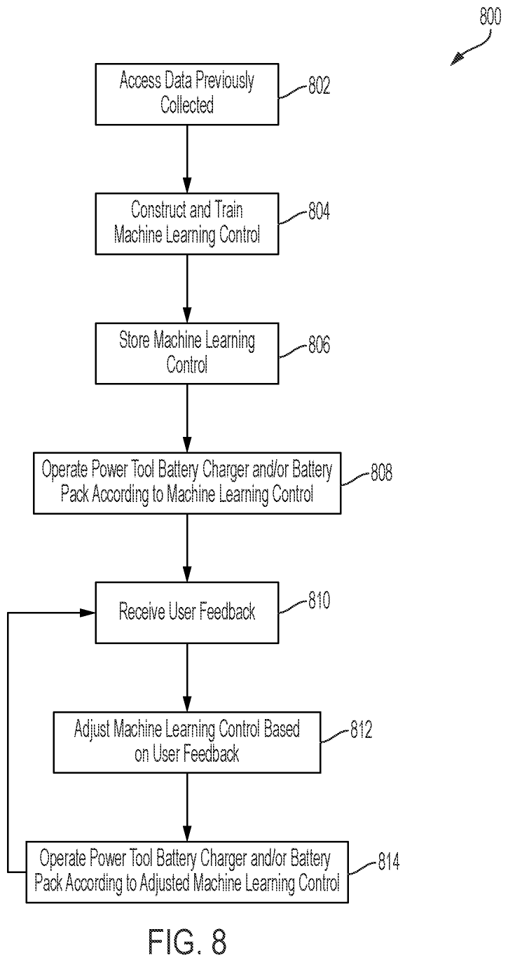

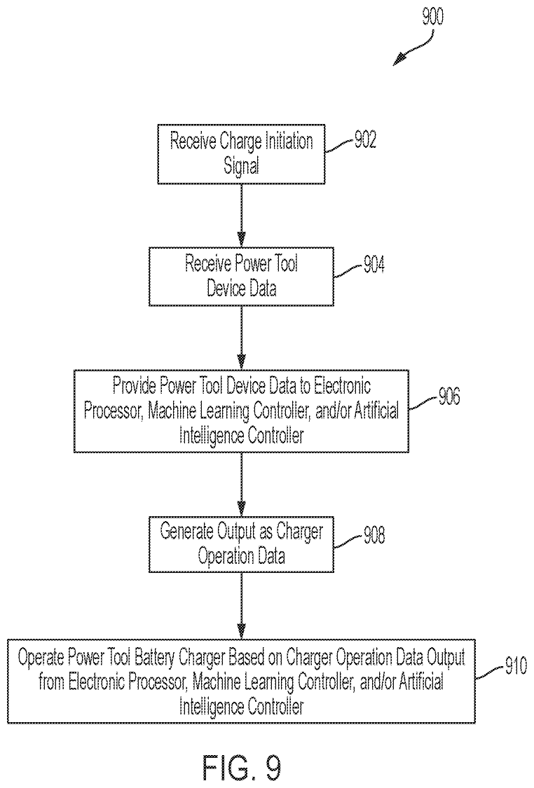

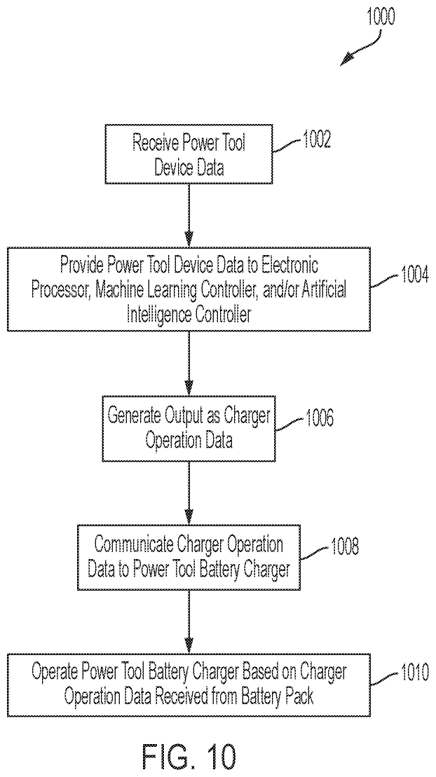

In still other embodiments, a power tool battery charger system can be implemented as a power tool battery pack adapter configured to be positioned between a battery pack and power tool. The power tool adapter can thus include an electronic controller, machine learning controller, and/or artificial intelligence controller that is configured to implement the methods described in the present disclosure (e.g., the process 800 of FIG. 8, the process 900 of FIG. 9, and/or the process 1000 of FIG. 10). In general, a power tool battery pack adapter is a device that is coupled between the power tool and battery pack, such as by having and interface (e.g., a battery pack interface) on its bottom surface for receiving a battery pack and an interface (e.g., a power tool interface) on its top surface for receiving a power tool.

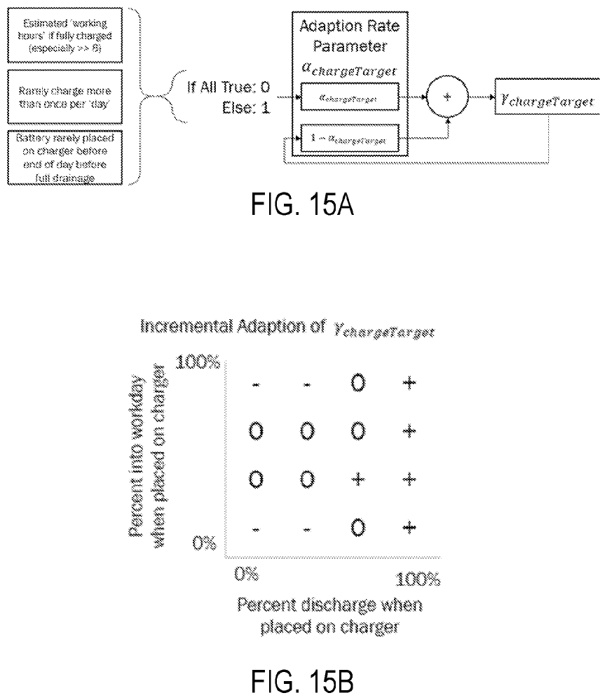

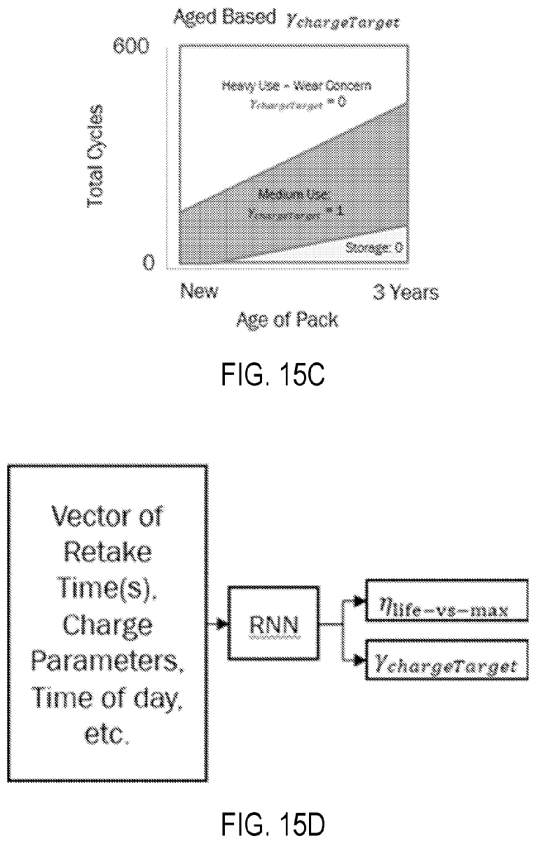

Each of FIGS. 1-6 illustrate various embodiments in which different types of machine learning controllers 110, 210, 310, 410, 510, 610 are used in conjunction with the power tool battery charger 102, 202, 302, 402, 502 and/or battery pack 660. In some embodiments, each power tool battery charger 102, 202, 302, 402, 502 and/or battery pack 660) may include more than one machine learning controller 110, 210, 310, 410, 510, 610 and each machine learning controller 110, 210, 310, 410, 510, 610 may be of a different type. For example, a power tool battery charger 102, 202, 302, 402, 502 and/or battery pack 660 may include a static machine learning controller 210 as described with respect to FIG. 2 and may also include a self-updating machine learning controller 410 as described with respect to FIG. 4A. In another example, the power tool battery charger 102, 202, 302, 402, 502, and/or battery pack 660) may include a static machine learning controller 210. The static machine learning controller 210 may be subsequently removed and replaced by, for example, an adjustable machine learning controller 310. In other words, the same power tool battery charger and/or battery pack may include any of the machine learning controllers 110, 210, 310, 410 described above with respect to FIGS. 1-4B. Additionally, a machine learning controller 710, shown in FIG. 7A and described in further detail below, and a machine learning controller 715, shown in FIG. 7C, and described in further detail below, are example controllers that may be used as one or more of the machine learning controllers 110, 210, 310, 410, 510, and 610 (and 1510 of FIG. 15).

FIG. 7A is a block diagram of a representative power tool battery charger 702 including a machine learning controller 710. The machine learning controller 710 of the power tool battery charger 702 may be a static machine learning controller similar to the static machine learning controller 210 of the second power tool battery charger 202 described above, an adjustable machine learning controller similar to the adjustable machine learning controller 310 of the third power tool battery charger 302 described above, or a self-updating machine learning controller similar to the self-updating machine learning controller 410 of the fourth power tool battery charger 402 described above. In some embodiments, the machine learning controller 710 includes multiple machine learning controllers similar to one or more of the machine learning controllers 210, 310, and/or 410 (e.g., one or more static machine learning controllers, one or more adjustable machine learning controllers, and/or one or more self-updating machine learning controllers). Each such machine learning controller making up the machine learning controller 710 may be or include a different machine learning program, algorithm, or model and, therefore, may be configured to execute a different task or function.

Although the power tool battery charger 702 of FIG. 7A is described as being in communication with the external device 104 or with a server, in some embodiments, the power tool battery charger 702 is self-contained or closed, in terms of machine learning, and does not need to communicate with the external device 104, the server, or any other external system device to perform the functionality of the machine learning controller 710 described in more detail below.

As shown in FIG. 7A, the power tool battery charger 702 includes an electronic controller 720, a wireless communication device 750, a power source 754, a battery pack interface 752, one or more charging circuits 758, electronic components 770, one or more sensors 772, etc.

The electronic controller 720 can include an electronic processor 730) and memory 740. The electronic processor 730, the memory 740, and the wireless communication device 750 can communicate over one or more control buses, data buses, etc., which can include a device communication bus 776. The control and/or data buses are shown generally in FIG. 7A for illustrative purposes. The use of one or more control and/or data buses for the interconnection between and communication among the various modules, circuits, and components would be known to a person skilled in the art.

The electronic processor 730 can be configured to communicate with the memory 740 to store data and retrieve stored data. The electronic processor 730 can be configured to receive instructions and data from the memory 740 and execute, among other things, the instructions. In particular, the electronic processor 730 executes instructions stored in the memory 740. Thus, the electronic controller 720 coupled with the electronic processor 730 and the memory 740 can be configured to perform the methods described herein (e.g., the process 800 of FIG. 8, the process 900 of FIG. 9, and/or the process 1000 of FIG. 10).

The memory 740 can include read-only memory (“ROM”), random access memory (“RAM”), other non-transitory computer-readable media, or a combination thereof. The memory 740) can include instructions 742 for the electronic processor 730 to execute. The instructions 742 can include software executable by the electronic processor 730 to enable the electronic controller 720 to, among other things, determine charger operation data based on power tool device data received from the power tool battery charger 702, a battery pack, a power tool, or other related power tool device. The software can include, for example, firmware, one or more applications, program data, filters, rules, one or more program modules, and other executable instructions. In some embodiments, the machine learning controller 710 may be stored in the memory 740 of the electronic controller 720 and can be executed by the electronic processor 730.

The electronic processor 730 is configured to retrieve from memory 740 and execute, among other things, instructions related to the control processes and methods described herein. The electronic processor 730 is also configured to store data on the memory 740 including usage data (e.g., usage data of the power tool battery charger 702, another power tool battery charger, one or more battery packs, and/or one or more power tools), maintenance data (e.g., maintenance data of the power tool battery charger 702, another power tool battery charger, one or more battery packs, and/or one or more power tools), feedback data, power source data, sensor data (e.g., sensor data of the power tool battery charger 702, another power tool battery charger, one or more battery packs, and/or one or more power tools), environmental data, operator data, location data, and the like. Additionally, the electronic processor 730 can also be configured to store other data on the memory 740 including information identifying the type of power tool battery charger, a unique identifier for the particular power tool battery charger, user characteristics (e.g., identity, trade type, skill level), and other information relevant to operating or maintaining the power tool battery charger 702 (e.g., received from an external source, such as the external device 104 or pre-programed at the time of manufacture).

In some embodiments, the memory 740 may include a machine learning control (e.g., machine learning control 784 described below with respect to FIG. 7B) that, when acted upon by the electronic processor 730, enables the electronic controller 720 to function as a machine learning controller, such as machine learning controller 710. In these instances, the power tool battery charger 702 may not include a separate machine learning controller 710, but may instead have an electronic controller 720 that is configured to function as a machine learning controller. Additionally or alternatively, the memory 740 may include a machine learning control that is accessible by the separate machine learning controller 710.

In some other embodiments, the memory 740 may include an artificial intelligence control that, when acted upon by the electronic processor 730, enables the electronic controller 720 to function as an artificial intelligence controller. The artificial intelligence control may include instructions for implementing one or more artificial intelligence programs, algorithms, or models such as an expert system, a rules engine, a symbolic logic, one or more knowledge graphs, and so on.

The wireless communication device 750 is coupled to the electronic controller 720) (e.g., via the device communication bus 776). The wireless communication device 750 may include, for example, a radio transceiver and antenna, a memory, and an electronic processor. In some examples, the wireless communication device 750 can further include a GNSS receiver configured to receive signals from GNSS satellites, land-based transmitters, etc. The radio transceiver and antenna operate together to send and receive wireless messages to and from the external device 104, one or more battery packs, one or more power tools, one or more additional power tool battery chargers, a server (e.g., server 106, 206, 306, 406), and/or the electronic processor of the wireless communication device 750. The memory of the wireless communication device 750 stores instructions to be implemented by the electronic processor and/or may store data related to communications between the power tool battery charger 702 and the external device 104, one or more battery packs, one or more power tools, one or more additional power tool battery chargers, and/or a server (e.g., server 106, 206, 306, 406).

The electronic processor for the wireless communication device 750 controls wireless communications between the power tool battery charger 702 and the external device 104, one or more battery packs, one or more power tools, one or more additional power tool battery chargers, and/or a server (e.g., server 106, 206, 306, 406). For example, the electronic processor of the wireless communication device 750 buffers incoming and/or outgoing data, communicates with the electronic processor 730 and/or machine learning controller 710, and determines the communication protocol and/or settings to use in wireless communications.

In some embodiments, the wireless communication device 750 is a Bluetooth® controller. The Bluetooth® controller communicates with the external device 104, one or more battery packs, one or more power tools, one or more additional power tool battery chargers, and/or a server (e.g., server 106, 206, 306, 406) employing the Bluetooth® protocol. In such embodiments, therefore, the external device 104, one or more battery packs, one or more power tools, one or more additional power tool battery chargers, and/or a server (e.g., server 106, 206, 306, 406) and the power tool battery charger 702 are within a communication range (i.e., in proximity) of each other while they exchange data. In other embodiments, the wireless communication device 750 communicates using other protocols (e.g., Wi-Fi, cellular protocols, a proprietary protocol, etc.) over a different type of wireless network. For example, the wireless communication device 750 may be configured to communicate via Wi-Fi through a wide area network such as the Internet or a local area network, or to communicate through a piconet (e.g., using infrared or NFC communications). The communication via the wireless communication device 750 may be encrypted to protect the data exchanged between the power tool battery charger 702 and the external device 104, one or more battery packs, one or more power tools, one or more additional power tool battery chargers, and/or a server (e.g., server 106, 206, 306, 406) from third parties.

The wireless communication device 750, in some embodiments, exports usage data (e.g., usage data of the power tool battery charger 702, another power tool battery charger, one or more battery packs, and/or one or more power tools), maintenance data (e.g., maintenance data of the power tool battery charger 702, another power tool battery charger, one or more battery packs, and/or one or more power tools), feedback data, power source data, sensor data (e.g., sensor data of the power tool battery charger 702, another power tool battery charger, one or more battery packs, and/or one or more power tools), environmental data, operator data, location data, and the like from the power tool battery charger 702 (e.g., from the electronic processor 730).

The server 106, 206, 306, 406, receives the exported data, either directly from the wireless communication device 750 or through an external device 104, and logs the data received from the power tool battery charger 702. As discussed in more detail below, the exported data can be used by the power tool battery charger 702, the external device 104, or the server 106, 206, 306, 406, to train or adapt a machine learning controller relevant to similar power tool battery chargers. The wireless communication device 750 may also receive information from the server 106, 206, 306, 406, the external device 104, a power tool, or another power tool battery charger, such as time and date data (e.g., real-time clock data, the current date), configuration data, operation threshold, maintenance threshold, mode configurations, programming for the power tool battery charger 702, updated machine learning controllers for the power tool battery charger 702, and the like. For example, the wireless communication device 750 may exchange information with a second power tool battery charger directly, or via an external device 104.

In some embodiments, the power tool battery charger 702 does not communicate with the external device 104 or with the server 106, 206, 306, 406 (e.g., power tool battery charger system 400 in FIG. 4B). Accordingly, in some embodiments, the power tool battery charger 702 does not include the wireless communication device 750 described above. In some embodiments, the power tool battery charger 702 includes a wired communication interface to communicate with, for example, the external device 104 or a different device (e.g., another power tool battery charger). The wired communication interface may provide a faster communication route than the wireless communication device 750.

In some embodiments, the power tool battery charger 702 includes a data sharing setting. The data sharing setting indicates what data, if any, is exported from the power tool battery charger 702 to the server 106, 206, 306, 406. In one embodiment, the power tool battery charger 702 receives (e.g., via a graphical user interface generated by the external device 104) an indication of the type of data to be exported from the power tool battery charger 702. In one embodiment, the external device 104 may display various options or levels of data sharing for the power tool battery charger 702, and the external device 104 receives the user's selection via its generated graphical user interface. For example, the power tool battery charger 702 may receive an indication that only usage data is to be exported from the power tool battery charger 702, but may not export information regarding, for example, the modes implemented by the power tool battery charger 702, the location of the power tool battery charger 702, and the like. In some embodiments, the data sharing setting may be a binary indication of whether or not data regarding the operation of the power tool battery charger 702 (e.g., usage data) are transmitted to the server 106, 206, 306, 406. The power tool battery charger 702 receives the user's selection for the data sharing setting and stores the data sharing setting in memory to control the communication of the wireless communication device 750 according to the selected data sharing setting.

In some embodiments, the wireless communication device 750 can be within a separate housing along with the electronic controller 720 or another electronic controller, and that separate housing selectively attaches to the power tool battery charger 702. For example, the separate housing may attach to an outside surface of the power tool battery charger 702 or may be inserted into a receptacle of the power tool battery charger 702. Accordingly, the wireless communication capabilities of the power tool battery charger 702 can reside in part on a selectively attachable communication device, rather than integrated into the power tool battery charger 702. Such selectively attachable communication devices can include electrical terminals that engage with reciprocal electrical terminals of the power tool battery charger 702 to enable communication between the respective devices and enable the power tool battery charger 702 to provide power to the selectively attachable communication device. In other embodiments, the wireless communication device 750 can be integrated into the power tool battery charger 702.

In some embodiments, the power source 754 can be an AC power source or a DC power source, which can be in electrical communication with one or more power outlets (e.g., AC or DC outlets). For instance, the power source 754 can be an AC power source, for example, a conventional wall outlet, or the power source 754 can be a DC power source, for example, a photovoltaic cell (e.g., a solar panel). In some embodiments, the power source 754 may use a universal serial bus (“USB”) protocol for supplying power to the power tool battery charger 702. In these instances, the power tool battery charger 702 may include a USB input for power. As an example, the power source 754 may be a solar panel that uses a USB protocol, such as variable power-data object (“PDO”), for supplying power to the power tool battery charger 702.

Additionally or alternatively, the power source 754 can be a battery and the power tool battery charger 702 can be a portable power supply and/or a charging device for one or more power tool battery packs, power tools, or other peripheral devices. In these instances, the power tool battery charger 702 distributes the power from the power source 754 (i.e., battery) to provide power to one or more power tool battery packs, such as battery pack(s) 760, via the battery pack interface 752. Additionally, the power tool battery charger 702 can also distribute the power from the power source 754 (i.e., battery) to one or more peripheral devices (e.g., a smartphone, a tablet computer, a laptop computer, a portable music player, a power tool, and the like).

One or more characteristics of the power source 754 can be monitored by one or more of the sensors 772 of the power tool battery charger 702. For example, a voltage of the power source 754 can be monitored by a sensor 772 implemented as a voltage sensor, which can generate output as power source data that indicate a voltage measured, detected, or otherwise monitored on the power source 754: or a current of the power source 754 can be monitored by a sensor 772 implemented as a current sensor, which can generate output as power source data that indicate a current measured, detected, or otherwise monitored on the power source 754.

The power tool battery charger 702 also includes a power tool battery pack interface 752 that is configured to selectively receive and interface with one or more power tool battery packs 760 (e.g., the battery pack 660 or a similar battery pack without a machine learning controller). The power tool battery pack interface 752 may include one or more charging ports (e.g., for charging one or more battery packs). Each charging port of the battery pack interface 752 can include one or more power terminals and, in some cases, one or more communication terminals that interface with respective power terminals, communication terminals, etc., of the power tool battery pack(s) 760.

In some embodiments, the power tool battery pack interface 752 provides an electrical and mechanical connection for a battery pack 760. Additionally or alternatively, the power tool battery pack interface 752 can provide a wireless coupling to a battery pack 760 in order to provide wireless energy transfer from the power tool battery charger 702 to the battery pack 760. For example, in some configurations the power tool battery pack interface 752 may include one or more transmitter coils for charging a battery pack 760 using a wireless energy transfer (e.g., via electromagnetic induction).

The power tool battery pack(s) 760 can include one or more battery cells of various chemistries, such as lithium-ion (Li-Ion), nickel cadmium (Ni-Cad), etc. The power tool battery pack(s) 760 can further selectively latch and unlatch (e.g., with a spring-biased latching mechanism) to the power tool battery charger 702 to prevent unintentional detachment. The power tool battery pack(s) 760 can further include a pack electronic controller (pack controller) including a processor and a memory. The pack controller can be configured similarly to the electronic controller 720 of the power tool battery charger 702. The pack controller can be configured to regulate charging and discharging of the battery cells, and/or to communicate with the electronic controller 720. In some embodiments, the power tool battery pack(s) 760 can further include an antenna, similar to the wireless communication device 750, coupled to the pack controller via a bus similar to bus 776. Accordingly, the pack controller, and thus the power tool battery pack(s) 760, can be configured to communicate with other devices, such as the power tool battery charger 702 or other power tool battery chargers, a cellular tower, a Wi-Fi router, a mobile device, access points, etc. In some embodiments, the memory of the pack controller can include the instructions 742. The power tool battery pack(s) 760 can further include, for example, a charge level fuel gauge, analog front ends, sensors, etc.

The electronic controller 720 controls the charging circuit(s) 758 to charge the battery pack(s) 760. For example, charging circuit(s) 758 can each include controllable power switching elements (e.g., field effect transistors, IGBTs, and the like) that the electronic processor 730 of the electronic controller 720 selectively enables to provide power from the power source 754 to the respective battery pack(s) 760. Thus, the electronic controller 720) coupled with the electronic processor 730 and the memory 740 can be configured to control the charging circuit(s) 758 to perform the methods described herein (e.g., the process 800 of FIG. 8, the process 900 of FIG. 9, and/or the process 1000 of FIG. 10).

For instance, the instructions 742 can include software executable by the electronic processor 730 to enable the electronic controller 720 to, among other things, control the charging circuit(s) 758 to adjust a charging target for a battery pack 760, adjust a charging rate for a battery pack 760, adjust a time of day when to charge a battery pack 760, adjust an order in which to charge battery packs 760 connected to the battery pack interface 752, combinations thereof, and the like. Such charging actions can be characterized as charger operation data, which indicate controls for the charging circuit(s) 758 to adjust the charging rate(s) and/or charging target(s), and can include timing indications for when the charging rate(s) and/or target(s) should be changed. The charger operation data may also indicate an order in which to charge different battery packs 760 connected to a power tool battery charger 702 (e.g., connected to different charging bays of a multi-bay charger) and/or different sets of charging rate(s) and/or target(s) to be applied to different charging circuits 758 in order to prioritize different charging actions for different charging bays.

In some embodiments, the power tool battery charger 702 also optionally includes additional electronic components 770. The electronic components 770 can include, for example, one or more of a lighting element (e.g., a light-emitting diode (“LED”)), an audio element (e.g., a speaker), a bounce detector, etc. In further examples, the electronic components 770 may include a radio frequency identification (“RFID”) reader to read a battery identification number stored on an RFID tag in the battery pack 760. As another example, the electronic components 770) may include a near field communication (“NFC”) reader to read a battery identification number stored on an NFC tag in the battery pack 760, a power tool identification number stored on an NFC tag in the power tool, and the like.

In some embodiments, the electronic controller 720 is also connected to one or more sensors 772, which may include voltage sensors or voltage sensing circuits, current sensors or current sensing circuits, temperature sensors or temperature sensing circuits, inertial sensors or inertial sensing circuits (e.g., accelerometers, gyroscopes, magnetometers), or the like. The temperature sensor(s) may include, for example, a thermistor. Each temperature sensor sends a signal to the electronic controller 720 indicating a temperature of the battery pack (e.g., indicative of a temperature of battery cells within the pack), a temperature of the battery charger 702 (e.g., indicative of a temperature within a housing of the charger, of power switching elements, and/or other electronics of the battery charger 702), and/or an ambient temperature of the environment around the battery charger 702.

The one or more sensors 772 are coupled to the machine learning controller 710 and/or electronic processor 730) (e.g., via the device communication bus 776) and communicate to the machine learning controller 710 and/or electronic processor 730 various output signals indicative of different parameters of the power tool battery charger 702, the power source 754, the battery pack(s) 760, and/or the environment.

In some embodiments, the machine learning controller 710 uses the sensor data from the sensor(s) 772 to control the charging circuit(s) 758, such as by applying the sensor data to one or more machine learning programs, algorithms, or models in order to generate output as control signals that control an action of the charging circuit(s) 758. For example, sensor data including voltage data can be used to indicate the type of power source to which the power tool battery charger 702 is connected and charger operation data can be generated in response to control the charging action of the charging circuit(s) 758 according to the type of connected power source. As another example, current data can be used to monitor the charging rate and/or current draw of the power tool battery charger 702 and charger operation data can be generated in response to control the charging action of the charging circuit(s) 758 to limit the maximum current draw. As still another example, inertial sensor data (e.g., accelerometer data, gyroscope data, magnetometer data) can be used to determine a position of the power tool battery charger 702, from which charger operation data can be generated in response to control the charging action of the charging circuit(s) 758 to adjust the charging rate(s) and/or target(s) based on an estimated use application of the power tool battery charger 702 based on its location.

In some other embodiments, the electronic processor 730 uses power tool device data from the battery pack(s) 760 to control the charging circuit(s) 758. For example, usage data can be used to indicate various aspects of the power tool battery charger 702 use, or likely future uses of the power tool battery charger 702. These data can be used to generate charger operation data to control the charging action of the charging circuit(s) 758 in an optimized manner for the current usage of the power tool battery charger 702 and/or for future likely usage of the power tool battery charger 702.

The machine learning controller 710 is coupled to the electronic controller 720 (e.g., via the device communication bus), and in some embodiments may be selectively coupled such that an activation switch 774 (e.g., mechanical switch, electronic switch) can selectively switch between an activated state and a deactivated state. When the activation switch 774 is in the activated state, the electronic controller 720 is in communication with the machine learning controller 710 and receives decision outputs from the machine learning controller 710. When the activation switch 774 is in the deactivated state, the electronic controller 720 is not in communication with the machine learning controller 710. In other words, the activation switch 774 selectively enables and disables the machine learning controller 710.

As described above with respect to FIGS. 1-6, the machine learning controller 710 includes a trained machine learning controller that utilizes previously collected data to analyze and classify new data from the power tool battery charger 702, one or more battery packs, and/or one or more power tools. As explained in more detail below, the machine learning controller 710 can identify conditions, applications, and states of the power tool battery charger 702.

In one embodiment, the activation switch 774 switches between an activated state and a deactivated state. In such embodiments, while the activation switch 774 is in the activated state, the electronic controller 720 controls the operation of the power tool battery charger 702 (e.g., changes the operation of the charging circuit(s) 758) based on the determinations from the machine learning controller 710. Otherwise, when the activation switch 774 is in the deactivated state, the machine learning controller 710 is disabled and the machine learning controller 710 does not affect the operation of the power tool battery charger 702. In some embodiments, however, the activation switch 774 switches between an activated state and a background state. In such embodiments, when the activation switch 774 is in the activated state, the electronic controller 720 controls the operation of the power tool battery charger 702 based on the determinations or outputs from the machine learning controller 710. However, when the activation switch 774 is in the background state, the machine learning controller 710 continues to generate output based on the usage data of the power tool battery charger or other collected data and may calculate (e.g., determine) thresholds or other operational levels, but the electronic controller 720 does not change the operation of the power tool battery charger 702 based on the determinations and/or outputs from the machine learning controller 710. In other words, in such embodiments, the machine learning controller 710 operates in the background without affecting the operation of the power tool battery charger 702.

In some embodiments, the activation switch 774 is not included on the power tool battery charger 702 and the machine learning controller 710 is maintained in the enabled state or is controlled to be enabled and disabled via, for example, wireless signals from the server (e.g., servers 106, 206, 306, 406) or from the external device 104.

In some embodiments, the power tool battery charger 702 may implement an artificial intelligence controller instead of, or in addition to, the machine learning controller 710. The artificial intelligence controller implements one or more AI programs, algorithms, or models. In some embodiments, the AI controller is configured to implement the one or more AI programs, algorithms, or models such as an expert system, a rules engine, a symbolic logic, one or more knowledge graphs, and so on. In some embodiments, the AI controller is integrated into and implemented by the electronic controller 720 (e.g., the electronic controller 720 may be referred to as an AI controller). In some embodiments, the AI controller is a separate controller from the electronic controller 720 and includes an electronic processor and memory, similar to the machine learning controller 710 as illustrated in FIG. 7B.

In some embodiments, the power tool battery charger 702 can include one or more inputs 790 (e.g., one or more buttons, switches, and the like) that allow a user to select a mode of the power tool battery charger 702 and indicates to the user the currently selected mode of the power tool battery charger 702. In some embodiments, the input 790 includes a single actuator. In such embodiments, a user may select an operating mode for the power tool battery charger 702 based on, for example, a number of actuations of the input 790. For example, when the user activates the actuator three times, the power tool battery charger 702 may operate in a third operating mode. In other embodiments, the input 790 includes a plurality of actuators, each actuator corresponding to a different operating mode. For example, the input 790 may include four actuators, when the user activates one of the four actuators, the power tool battery charger 702 may operate in a first operating mode. The electronic controller 720 receives a user selection of an operating mode via the input 790, and controls the electronic controller 720 such that the one or more charging circuits 758 are operated according to the selected operating mode.

In some embodiments, the power tool battery charger 702 does not include an input 790. In such embodiments, the power tool battery charger 702 may operate in a single mode, or may include a different selection mechanism for selecting an operation mode for the power tool battery charger 702. In some embodiments, as described in more detail below, the power tool battery charger 702 (e.g., the electronic controller 720) automatically selects an operating mode for the power tool battery charger 702 using, for example, the machine learning controller 710 and/or artificial intelligence controller. In some embodiments, the power tool battery charger 702 communicates with the external device 104, and the external device 104 generates a graphical user interface that enables a user to convey information to the power tool battery charger 702 without the need for input(s) 790 on the power tool battery charger 702 itself.

In some embodiments, the power tool battery charger 702 may include one or more outputs 792 that are also coupled to the electronic controller 720. The output(s) 792 can receive control signals from the electronic controller 720 to generate a visual signal to convey information regarding the operation or state of the power tool battery charger 702 to the user. The output(s) 792 may include, for example, LEDs or a display screen and may generate various signals indicative of, for example, an operational state or mode of the power tool battery charger 702, an abnormal condition or event detected during the operation of the power tool battery charger 702, and the like. For example, the output(s) 792 may indicate measured electrical characteristics of the power tool battery charger 702, the state or status of the power tool battery charger 702, an operating mode of the power tool battery charger 702, and the like.

In some embodiments, the power tool battery charger 702 does not include the output(s) 792. In some embodiments, the power tool battery charger 702 communicates with the external device 104, and the external device 104 generates a graphical user interface that conveys information to the user without the need for output(s) 792 on the power tool battery charger 702 itself.

As shown in FIG. 7B, the machine learning controller 710 includes an electronic processor 780 and a memory 782. The memory 782 stores a machine learning control 784, which may also be referred to as machine learning control instructions. The machine learning control 784 may include a trained machine learning program, algorithm, or model, as described above with respect to FIGS. 1-6. For example, reference to storing, transmitting, receiving, executing, and/or updating of a machine learning controller herein (e.g., machine learning controllers 110, 210, 310, etc.) refers, at least in some examples, to a processor of the machine learning controller or the device having the machine learning controller storing, transmitting, receiving, executing, and/or updating machine learning control instructions, such as machine learning control 784. In the illustrated embodiment, the electronic processor 780 includes a graphics processing unit.

In the embodiment of FIG. 7B, the machine learning controller 710 is positioned on a separate printed circuit board (“PCB”) as the electronic controller 720 of the power tool battery charger 702. The PCB of the electronic controller 720 and the machine learning controller 710 are coupled with, for example, wires or cables to enable the electronic controller 720 of the power tool battery charger 702 to control the charging circuit(s) 758 based on the outputs and determinations from the machine learning controller 710.

In other embodiments, however, the machine learning control 784 may be stored in memory 740 of the electronic controller 720 and may be implemented by the electronic processor 730. In yet other embodiments, the machine learning controller 710 is implemented in the separate electronic processor 780, but is positioned on the same PCB as the electronic controller 720 of the power tool battery charger 702. Embodiments with the machine learning controller 710 implemented as a separate processing unit from the electronic controller 720, whether on the same or different PCBs, allows selecting a processing unit to implement each of the machine learning controller 710 and the electronic controller 720 that has its capabilities (e.g., processing power and memory capacity) tailored to the particular demands of each unit. Such tailoring can reduce costs and improve efficiencies of the power tools. In some embodiments, as illustrated in FIG. 5, for example, the external device 104 includes the machine learning controller 710 and the power tool battery charger 702 communicates with the external device 104 to receive the estimations or classifications from the machine learning controller 710.

In some embodiments, the machine learning controller 710 is implemented in a plug-in chip or controller that is easily added to the power tool battery charger 702. For example, the machine learning controller 710 may include a plug-in chip that is received within a cavity of the power tool battery charger 702 and connects to the electronic controller 720. For example, in some embodiments, the power tool battery charger 702 includes a lockable compartment including electrical contacts that is configured to receive and electrically connect to the plug-in machine learning controller 710. The electrical contacts enable bidirectional communication between the plug-in machine learning controller 710 and the electronic controller 720, and enable the plug-in machine learning controller 710 to receive power from the power tool battery charger 702.

As discussed above with respect to FIG. 1, the machine learning control 784 may be constructed, trained, and/or operated by the server 106. In other embodiments, the machine learning control 784 may be constructed and/or trained by the server 106, but implemented by the power tool battery charger 702 (similar to FIGS. 2 and 3), and in yet other embodiments, the power tool battery charger 702 (e.g., the electronic controller 720, electronic processor 780, or a combination thereof) constructs, trains, and/or implements the machine learning control 784 (similar to FIG. 4B).

FIG. 7C is a block diagram of a representative battery pack 760, which in some embodiments may include a machine learning controller 715. In such embodiments, the battery pack 760 may be similar to the battery pack 660 described above, or other such battery packs described in the present disclosure. The machine learning controller 715 of the battery pack 760 may be a static machine learning controller similar to the static machine learning controller 210 of the second power tool battery charger 202 described above, an adjustable machine learning controller similar to the adjustable machine learning controller 310 of the third power tool battery charger 302 described above, or a self-updating machine learning controller similar to the self-updating machine learning controller 410 of the fourth power tool battery charger 402 described above. In some embodiments, the machine learning controller 715 includes multiple machine learning controllers similar to one or more of the machine learning controllers 210, 310, and/or 410 (e.g., one or more static machine learning controllers, one or more adjustable machine learning controllers, and/or one or more self-updating machine learning controllers). Each such machine learning controller making up the machine learning controller 715 may be or include a different machine learning program, algorithm, or model and, therefore, may be configured to execute a different task or function.

Although the battery pack 760 of FIG. 7C is described as being in communication with the external device 104 or with a server, in some embodiments, the battery pack 760 is self-contained or closed, in terms of machine learning, and does not need to communicate with the external device 104, the server, or any other external system device to perform the functionality of the machine learning controller 715 described in more detail below:

In some embodiments, the battery pack 760 does not include a machine learning controller 715. In these embodiments, the battery pack 760 can either be in communication with a remote machine learning controller (e.g., a machine learning controller on a server such as server 106, 206, 306, 406; a machine learning controller on another power tool device, such as another battery pack, a power tool battery charger, or a power tool: or a machine learning controller on an external device, such as external device 104) that is operable to control one or more aspects of the battery pack 760, or the battery pack 760 can be operable without machine learning functionality.

As shown in FIG. 7C, the battery pack 760 includes an electronic controller 725, a wireless communication device 755, a charger and tool interface 753, one or more battery cells 756, one or more charging circuits 759, electronic components 771, one or more sensors 773, etc.

The battery pack 760 is, for example, configured to provide power to a power tool. The battery pack 760 is further configured to receive charging current and to be charged by the power tool battery charger 702 or another power tool battery charger. To be received by the power tool battery charger 702 or power tool, the battery pack 760 may electrically and mechanically interface with the battery charger 702 and (at a different time) with a power tool.

In some aspects of this disclosure, the battery pack 760 may collect data about the battery pack 760) (e.g., power tool device data or other operational data of the battery pack), may collect data about a power tool used with the battery pack 760 (e.g., power tool device data or other operation data of the power tool), may collect data about the power tool battery charger 702 or other power tool battery charger used to charge the battery pack 760 (e.g., power tool device data or other operational data of the power tool battery charger 702 or other power tool battery charger), and/or store the collected data in a memory 745 of the battery pack 760.

In further aspects, the battery pack 760) may communicate with the power tool battery charger 702 while the battery pack 760 is electrically and mechanically connected in a charging dock of the power tool battery charger 702. Additionally or alternatively, the battery pack 760 may communicate with one or more other power tool battery chargers, battery packs, and/or power tools while the battery pack 760 is electrically and mechanically connected in a charging dock of the power tool battery charger 702.

In even further aspects, the battery pack 760 may wirelessly communicate with the power tool battery charger 702 (while being electrically and mechanically connected to the power tool battery charger 702, or otherwise), other power tool battery chargers, other battery packs, power tools, an external device 104, and/or a server using the wireless communication device 755 (e.g., communicating via the network 108, or directly with the respective device(s)).

The electrical power provided by the battery pack 760 is controlled, monitored, and regulated using control electronics within the battery pack 760, the power tool battery charger 702, and/or a power tool. For example, the battery pack 760 can include an electronic controller 725 that can be configured similarly to the electronic controller 720 of the power tool battery charger 702. The electronic controller 725 can be configured to regulate charging and discharging of the battery cells 756, and/or to communicate with the electronic controller 720 of the power tool battery charger 702. The electronic controller 725 can include an electronic processor 735 and memory 745. The electronic processor 735, the memory 745, and the wireless communication device 755 can communicate over one or more control buses, data buses, etc., which can include a device communication bus 777. The control and/or data buses are shown generally in FIG. 7C for illustrative purposes. The use of one or more control and/or data buses for the interconnection between and communication among the various modules, circuits, and components would be known to a person skilled in the art.

The electronic processor 735 can be configured to communicate with the memory 745 to store data and retrieve stored data. The electronic processor 735 can be configured to receive instructions and data from the memory 745 and execute, among other things, the instructions. In particular, the electronic processor 735 executes instructions stored in the memory 745. Thus, the electronic controller 725 coupled with the electronic processor 735 and the memory 745 can be configured to perform the methods described herein (e.g., the process 800 of FIG. 8, the process 900 of FIG. 9, and/or the process 1000 of FIG. 10).

The memory 745 can include ROM, RAM, other non-transitory computer-readable media, or a combination thereof. The memory 745 can include instructions 747 for the electronic processor 735 to execute. The instructions 747 can include software executable by the electronic processor 735 to enable the electronic controller 725 to, among other things, determine charger operation data based on power tool device data received from the battery pack 760, another battery pack, a power tool battery charger, a power tool, or other related power tool device. The software can include, for example, firmware, one or more applications, program data, filters, rules, one or more program modules, and other executable instructions. In some embodiments, the machine learning controller 715 may be stored in the memory 745 of the electronic controller 725 and can be executed by the electronic processor 735.

The electronic processor 735 is configured to retrieve from memory 745 and execute, among other things, instructions related to the control processes and methods described herein. The electronic processor 735 is also configured to store data on the memory 745 including usage data (e.g., usage data of the battery pack 760), another battery pack, a power tool battery charger, and/or one or more power tools), maintenance data (e.g., maintenance data of the battery pack 760, another battery pack, a power tool battery charger, and/or one or more power tools), feedback data, power source data, sensor data (e.g., sensor data of the battery pack 760, another battery pack, a power tool battery charger, and/or one or more power tools), environmental data, operator data, location data, and the like. Additionally, the electronic processor 735 can also be configured to store other data on the memory 745 including information identifying the type of battery pack, indicating a battery chemistry type for the battery pack 760, the total capacity of the battery pack 760 (e.g., the ampere hour rating of the battery pack 760), the present capacity of the battery pack 760, the remaining charge level of the battery pack 760, a unique identifier for the particular battery pack, user characteristics (e.g., identity, trade type, skill level), and other information relevant to operating or maintaining the battery pack 760 (e.g., received from an external source, such as the external device 104 or pre-programed at the time of manufacture).

In some embodiments, the memory 745 may include a machine learning control (e.g., machine learning control 784 described above with respect to FIG. 7B) that, when acted upon by the electronic processor 735, enables the electronic controller 725 to function as a machine learning controller, such as machine learning controller 715. In these instances, the battery pack 760 may not include a separate machine learning controller 715, but may instead have an electronic controller 725 that is configured to function as a machine learning controller. Additionally or alternatively, the memory 745 may include a machine learning control that is accessible by the separate machine learning controller 715.

In some other embodiments, the memory 745 may include an artificial intelligence control that, when acted upon by the electronic processor 735, enables the electronic controller 725 to function as an artificial intelligence controller. The artificial intelligence control may include instructions for implementing one or more artificial intelligence programs, algorithms, or models such as an expert system, a rules engine, a symbolic logic, one or more knowledge graphs, and so on.

The wireless communication device 755 is coupled to the electronic controller 725 (e.g., via the device communication bus 777). The wireless communication device 755 may include, for example, a radio transceiver and antenna, a memory, and an electronic processor. In some examples, the wireless communication device 755 can further include a GNSS receiver configured to receive signals from GNSS satellites, land-based transmitters, etc. The radio transceiver and antenna operate together to send and receive wireless messages to and from the external device 104, one or more power tool battery chargers, one or more power tools, one or more additional battery packs, a server (e.g., server 106, 206, 306, 406), and/or the electronic processor of the wireless communication device 755. The memory of the wireless communication device 755 stores instructions to be implemented by the electronic processor and/or may store data related to communications between the battery pack 760 and the external device 104, one or more power tool battery chargers, one or more power tools, one or more additional battery packs, and/or a server (e.g., server 106, 206, 306, 406).

The electronic processor for the wireless communication device 755 controls wireless communications between the battery pack 760 and the external device 104, one or more power tool battery chargers, one or more power tools, one or more additional battery packs, and/or a server (e.g., server 106, 206, 306, 406). For example, the electronic processor of the wireless communication device 755 buffers incoming and/or outgoing data, communicates with the electronic processor 735 and/or machine learning controller 715, and determines the communication protocol and/or settings to use in wireless communications.

In some embodiments, the wireless communication device 755 is a Bluetooth® controller. The Bluetooth® controller communicates with the external device 104, one or more power tool battery chargers, one or more power tools, one or more additional battery packs, and/or a server (e.g., server 106, 206, 306, 406) employing the Bluetooth® protocol. In such embodiments, therefore, the external device 104, one or more power tool battery chargers, one or more power tools, one or more additional battery packs, and/or a server (e.g., server 106, 206, 306, 406) and the battery pack 760 are within a communication range (i.e., in proximity) of each other while they exchange data. In other embodiments, the wireless communication device 755 communicates using other protocols (e.g., Wi-Fi, cellular protocols, a proprietary protocol, etc.) over a different type of wireless network. For example, the wireless communication device 755 may be configured to communicate via Wi-Fi through a wide area network such as the Internet or a local area network, or to communicate through a piconet (e.g., using infrared or NFC communications). The communication via the wireless communication device 755 may be encrypted to protect the data exchanged between the battery pack 760 and the external device 104, one or more power tool battery chargers, one or more power tools, one or more additional battery packs, and/or a server (e.g., server 106, 206, 306, 406) from third parties.

The wireless communication device 755, in some embodiments, exports usage data (e.g., usage data of the battery pack 760), another battery pack, one or more power tool battery chargers, and/or one or more power tools), maintenance data (e.g., maintenance data of the battery pack 760, another battery pack, one or more power tool battery chargers, and/or one or more power tools), feedback data, power source data, sensor data (e.g., sensor data of the battery pack 760, another battery pack, one or more power tool battery chargers, and/or one or more power tools), environmental data, operator data, location data, and the like from the battery pack 760 (e.g., from the electronic processor 735).

The server 106, 206, 306, 406, receives the exported data, either directly from the wireless communication device 755 or through an external device 104, and logs the data received from the battery pack 760. As discussed in more detail below, the exported data can be used by the battery pack 760, the external device 104, or the server 106, 206, 306, 406, to train or adapt a machine learning controller relevant to similar battery packs. The wireless communication device 755 may also receive information from the server 106, 206, 306, 406, the external device 104, a power tool, a power tool battery charger, or another battery packs, such as time and date data (e.g., real-time clock data, the current date), configuration data, operation threshold, maintenance threshold, mode configurations, programming for the battery pack 760, updated machine learning controllers for the battery pack 760, and the like. For example, the wireless communication device 755 may exchange information with a second battery pack, a power tool, and/or a power tool battery charger directly, or via an external device 104.

In some embodiments, the battery pack 760 does not communicate with the external device 104 or with the server 106, 206, 306, 406 (e.g., power tool battery charger system 600 in FIG. 6). Accordingly, in some embodiments, the battery pack 760 does not include the wireless communication device 755 described above. In some embodiments, the battery pack 760) includes a wired communication interface to communicate with, for example, the external device 104 or a different device (e.g., a power tool battery charger, another battery pack). The wired communication interface may provide a faster communication route than the wireless communication device 755.

In some embodiments, the battery pack 760 includes a data sharing setting. The data sharing setting indicates what data, if any, is exported from the battery pack 760 to the server 106, 206, 306, 406. In one embodiment, the battery pack 760) receives (e.g., via a graphical user interface generated by the external device 104) an indication of the type of data to be exported from the battery pack 760. In one embodiment, the external device 104 may display various options or levels of data sharing for the battery pack 760, and the external device 104 receives the user's selection via its generated graphical user interface. For example, the battery pack 760 may receive an indication that only usage data is to be exported from the battery pack 760, but may not export information regarding, for example, the modes implemented by the battery pack 760, the location of the battery pack 760, and the like. In some embodiments, the data sharing setting may be a binary indication of whether or not data regarding the operation of the battery pack 760 (e.g., usage data) are transmitted to the server 106, 206, 306, 406. The battery pack 760 receives the user's selection for the data sharing setting and stores the data sharing setting in memory to control the communication of the wireless communication device 755 according to the selected data sharing setting.

In some embodiments, the wireless communication device 755 can be within a separate housing along with the electronic controller 725 or another electronic controller, and that separate housing selectively attaches to the battery pack 760. For example, the separate housing may attach to an outside surface of the battery pack 760, may be inserted into a receptacle of the battery pack 760, and/or may be coupled to the charger and tool interface 753. Accordingly, the wireless communication capabilities of the battery pack 760 can reside in part on a selectively attachable communication device, rather than integrated into the battery pack 760. Such selectively attachable communication devices can include electrical terminals that engage with reciprocal electrical terminals of the battery pack 760 to enable communication between the respective devices and enable the battery pack 760 to provide power to the selectively attachable communication device. In other embodiments, the wireless communication device 755 can be integrated into the battery pack 760.

The battery pack 760 also includes a charger and tool interface 753 that is configured to selectively receive and interface with a power tool battery charger (e.g., the power tool battery charger 702, a similar power tool battery charger without a machine learning controller), one or more power tools, and/or an adapter that couples a battery pack 760 to a power tool and provides communication (wired or wireless) to an external device 104, power tool battery charger 702, or other device in a power tool device network. The charger and tool interface 753 may include one or more charging ports (e.g., for charging one or more battery packs). Each charging port of the charger and tool interface 753 can include one or more power terminals and, in some cases, one or more communication terminals that interface with respective power terminals, communication terminals, etc., of the power tool battery charger 702, other power tool battery chargers, and/or power tools.

For example, the charger and tool interface 753 can include a combination of mechanical components (e.g., rails, grooves, latches, etc.) and electrical components (e.g., one or more terminals) configured to and operable for interfacing (e.g., mechanically, electrically, and communicatively connecting) the battery pack 760 with another device (e.g., a power tool, a power tool battery charger, an adapter coupling the battery pack 760 to a power tool and providing communication to an external device 104, etc.). The charger and tool interface 753 is configured, for example, to receive power via a power line between the one or more battery cells 756 and the charger and tool interface 753. The charger and tool interface 753 can also be configured to communicatively connect to the electronic controller 725 via a communications line (e.g., via device communication bus 777). For example, the charger and tool interface 753 communicates with the electronic controller 725 and receives electrical power from the charging circuit(s) 759, as described below.

In some examples, the charger and tool interface 753 may include a physical lock (e.g., using a solenoid locking mechanism) for the electronic controller 725 to lock and prevent the battery pack 760 from being removed from the power tool battery charger 702. For example, the electronic controller 725 may provide a lock signal to the solenoid locking mechanism, which may actuate a solenoid to extend or move a lock element (e.g., a pin, bar, bolt, shackle, etc.) into or through a lock receptacle on the power tool battery charger 702 (preventing removal of the battery pack), and may provide an unlock signal to de-actuate the solenoid to retract or move the lock element out or away from the lock receptacle on the power tool battery charger 702 (permitting removal of the battery pack).

The charger and tool interface 753 can further selectively latch and unlatch (e.g., with a spring-biased latching mechanism) to the power tool battery charger 702 (or power tool) to prevent unintentional detachment of the battery pack 760 therefrom.

The battery pack 760 can include one or more battery cells 756 of various chemistries, such as lithium-ion (Li-Ion), nickel cadmium (Ni-Cad), etc. The battery cells 756 within the battery pack 760 provide operational power (e.g., voltage and current) to a power tool. In some examples, the battery pack 760 may have a nominal voltage of approximately 12 volts (between 8 volts and 16 volts), approximately 18 volts (between 16 volts and 22 volts), approximately 72 volts (between 60 volts and 90 volts), or another suitable amount.

In some examples, the battery pack 760 may have a larger capacity so as to provide a longer run time when operating under similar circumstances as a battery pack 760 with a smaller capacity. To achieve additional capacity, the battery pack 760 may include an additional set of battery cells 756. For example, in one configuration the battery pack 760 may include a set of series-connected battery cells 756, while in another configuration the battery pack 760 may include two or more sets of series-connected battery cells 756, with each set being connected in parallel to the other set(s) of battery cells 756. A series-parallel combination of battery cells 756 allows for an increased voltage and an increased capacity of the battery pack 760.

The electronic controller 725 controls the charging circuit(s) 759 to charge and/or discharge the battery cells 756. For example, charging circuit(s) 759 can each include controllable power switching elements (e.g., field effect transistors, IGBTs, and the like) that the electronic processor 735 of the electronic controller 725 selectively enables to control the charging current to and discharge current from the battery cells 756. Thus, the electronic controller 725 coupled with the electronic processor 735 and the memory 745 can be configured to control the charging circuit(s) 759 to perform the methods described herein (e.g., the process 800 of FIG. 8, the process 900 of FIG. 9, and/or the process 1000 of FIG. 10).

For instance, the instructions 747 can include software executable by the electronic processor 735 to enable the electronic controller 725 to, among other things, control the charging circuit(s) 759 to adjust a charging target for a battery pack 760, adjust a charging rate for a battery pack 760, adjust a time of day when to charge a battery pack 760, adjust an order in which to charge battery packs 760 connected to a power tool battery charger 702, combinations thereof, and the like. Such charging actions can be characterized as charger operation data, which indicate controls for the charging circuit(s) 759 to adjust the charging rate(s) and/or charging target(s), and can include timing indications for when the charging rate(s) and/or target(s) should be changed. The charger operation data may also indicate an order in which to charge different battery packs 760 connected to a power tool battery charger 702 (e.g., connected to different charging bays of a multi-bay charger) and/or different sets of charging rate(s) and/or target(s) to be applied to different charging circuits 759 in order to prioritize different charging actions for different battery cells 756.

In some embodiments, the electronic processor 735 uses power tool device data from the battery pack(s) 760 to control the charging circuit(s) 759. For example, usage data can be used to indicate various aspects of the battery pack 760 use (e.g., retake time, working hours), or likely future uses of the battery pack 760. These data can be used to generate charger operation data to control the charging action of the charging circuit(s) 759 in an optimized manner for the current usage of the battery pack 760 and/or for future likely usage of the battery pack 760. That is, in some embodiments, various types of power tool device data can be used to determine or otherwise select a charging state for the battery pack 760, which may be a one-dimensional charging state or a multidimensional charging state. From the determined charging state, charger control operation data may be generated and used by the electronic processor 730 to control the charging circuit(s) 759 to charge, or discharge, the battery pack 760 in accordance with the determined charging state.

In some embodiments, the battery pack 760 also optionally includes additional electronic components 771. The electronic components 771 can include, for example, one or more of a lighting element (e.g., an LED), a charge level fuel gauge, an audio element (e.g., a speaker), analog front ends, etc. In some embodiments, the electronic components 771 can include an RFID tag and/or an NFC tag, which may store a battery identification number for the battery pack 760

In some embodiments, the electronic controller 725 is also connected to one or more sensors 773, which may include voltage sensors or voltage sensing circuits, current sensors or current sensing circuits, temperature sensors or temperature sensing circuits, inertial sensors or inertial sensing circuits (e.g., accelerometers, gyroscopes, magnetometers), or the like. The temperature sensor(s) may include, for example, a thermistor. Each temperature sensor sends a signal to the electronic controller 725 indicating a temperature of the battery pack 760 (e.g., indicative of a temperature of battery cells 756 within the battery pack 760) and/or an ambient temperature of the environment around the battery pack 760.

The one or more sensors 773 are coupled to the machine learning controller 715 and/or electronic processor 735 (e.g., via the device communication bus 777) and communicate to the machine learning controller 715 and/or electronic processor 735 various output signals indicative of different parameters of the battery pack 760, the battery cells 756, and/or the environment.

In some embodiments, the machine learning controller 715 uses the sensor data from the sensor(s) 773 to control the charging circuit(s) 759, such as by applying the sensor data to one or more machine learning programs, algorithms, or models in order to generate output as control signals that control an action of the charging circuit(s) 759. For example, sensor data including current data can be used to monitor the charging rate and/or current draw of the battery pack 760 and charger operation data can be generated in response to control the charging action of the charging circuit(s) 759 to limit the maximum current draw. As still another example, inertial sensor data (e.g., accelerometer data, gyroscope data, magnetometer data) can be used to determine a position of the battery pack 760, from which charger operation data can be generated in response to control the charging action of the charging circuit(s) 759 to adjust the charging rate(s) and/or target(s) based on an estimated use application of the battery pack 760 based on its location.

The machine learning controller 715 is coupled to the electronic controller 725 (e.g., via the device communication bus), and in some embodiments may be selectively coupled such that an activation switch 775 (e.g., mechanical switch, electronic switch) can selectively switch between an activated state and a deactivated state. When the activation switch 775 is in the activated state, the electronic controller 725 is in communication with the machine learning controller 715 and receives decision outputs from the machine learning controller 715. When the activation switch 775 is in the deactivated state, the electronic controller 725 is not in communication with the machine learning controller 715. In other words, the activation switch 775 selectively enables and disables the machine learning controller 715.

As described above with respect to FIGS. 1-6, the machine learning controller 715 includes a trained machine learning controller that utilizes previously collected data to analyze and classify new data from the battery pack 760, other battery packs, one or more power tool battery chargers, and/or one or more power tools. As explained in more detail below, the machine learning controller 715 can identify conditions, applications, and states of the battery pack 760, and can generate charger operation data based on those conditions, applications, and/or states (e.g., one-dimensional or multidimensional charging states).

In one embodiment, the activation switch 775 switches between an activated state and a deactivated state. In such embodiments, while the activation switch 775 is in the activated state, the electronic controller 725 controls the operation of the battery pack 760 (e.g., changes the operation of the charging circuit(s) 759) based on the determinations from the machine learning controller 715. Otherwise, when the activation switch 775 is in the deactivated state, the machine learning controller 715 is disabled and the machine learning controller 715 does not affect the operation of the battery pack 760. In some embodiments, however, the activation switch 775 switches between an activated state and a background state. In such embodiments, when the activation switch 775 is in the activated state, the electronic controller 725 controls the operation of the battery pack 760 based on the determinations or outputs from the machine learning controller 715. However, when the activation switch 775 is in the background state, the machine learning controller 715 continues to generate output based on the usage data of the power tool battery charger or other collected data and may calculate (e.g., determine) thresholds or other operational levels, but the electronic controller 725 does not change the operation of the battery pack 760 based on the determinations and/or outputs from the machine learning controller 715. In other words, in such embodiments, the machine learning controller 715 operates in the background without affecting the operation of the battery pack 760.

In some embodiments, the activation switch 775 is not included on the battery pack 760 and the machine learning controller 715 is maintained in the enabled state or is controlled to be enabled and disabled via, for example, wireless signals from the server (e.g., servers 106, 206, 306, 406) or from the external device 104.

In some embodiments, the battery pack 760 may implement an artificial intelligence controller instead of, or in addition to, the machine learning controller 715. The artificial intelligence controller implements one or more AI programs, algorithms, or models. In some embodiments, the AI controller is configured to implement the one or more AI programs, algorithms, or models such as an expert system, a rules engine, a symbolic logic, one or more knowledge graphs, and so on. In some embodiments, the AI controller is integrated into and implemented by the electronic controller 725 (e.g., the electronic controller 725 may be referred to as an AI controller). In some embodiments, the AI controller is a separate controller from the electronic controller 725 and includes an electronic processor and memory, similar to the machine learning controller 715 as illustrated in FIG. 7C.

In some embodiments, the battery pack 760) can include one or more inputs 791 (e.g., one or more buttons, switches, and the like) that allow a user to select a mode (e.g., a charging state, one or more charging rates for the battery pack 760, one or more charging targets for the battery pack 760, a charging schedule for the battery pack 760, etc.) of the battery pack 760 and that can indicate to the user the currently selected mode of the battery pack 760. In some embodiments, the input 791 includes a single actuator. In such embodiments, a user may select a charging state mode for the battery pack 760 based on, for example, a number of actuations of the input 791. For example, when the user activates the actuator three times, the battery pack 760 may be charged according to a third charging state mode. In other embodiments, the input 791 includes a plurality of actuators, each actuator corresponding to a different charging state mode. For example, the input 791 may include four actuators, when the user activates one of the four actuators, the battery pack 760 may operate in a first charging state mode. The electronic controller 725 receives a user selection of a charging state mode via the input 791, and controls the electronic controller 725 such that the one or more charging circuits 759 are operated according to the selected charging state mode.

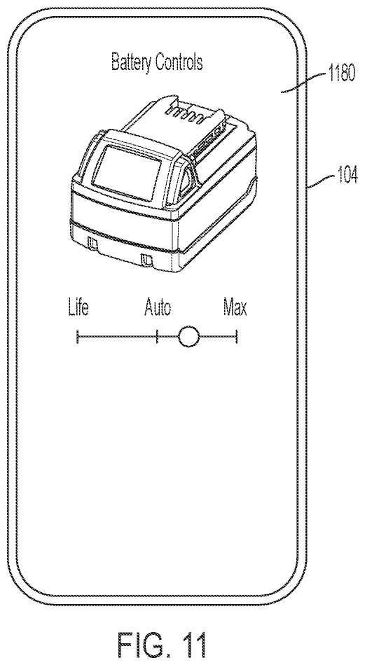

In some embodiments, the battery pack 760 does not include an input 791. In such embodiments, the battery pack 760 may operate in a single mode, or may include a different selection mechanism for selecting a charging state mode for the battery pack 760. In some embodiments, as described in more detail below; the battery pack 760 (e.g., the electronic controller 725) automatically selects a charging state mode and corresponding charger operation data for the battery pack 760 using, for example, the machine learning controller 715 and/or artificial intelligence controller. In some embodiments, the battery pack 760 communicates with the external device 104, and the external device 104 generates a graphical user interface that enables a user to convey information to the battery pack 760 without the need for input(s) 791 on the battery pack 760 itself. In these instances, the external device 104 can enable the user to select or adjust the charging state mode for the battery pack 760 (see FIG. 11).

In some embodiments, the battery pack 760) may include one or more outputs 793 that are also coupled to the electronic controller 725. The output(s) 793 can receive control signals from the electronic controller 725 to generate a visual signal to convey information regarding the operation or state of the battery pack 760 to the user (e.g., the selected charging state of the battery pack 760, the charge level of the battery pack 760, the charging rate at which the battery pack 760 is presently being charged, one or more charging targets set for the battery pack 760, etc.). The output(s) 793 may include, for example, LEDs or a display screen and may generate various signals indicative of, for example, a charging state or mode of the battery pack 760, an abnormal condition or event detected during the operation and/or charging of the battery pack 760, and the like. For example, the output(s) 793 may indicate a fuel gauge for the battery pack 760, a charging state for the battery pack 760, measured electrical characteristics of the battery pack 760, the state or status of the battery pack 760, an operating mode of the battery pack 760, and the like.

In some embodiments, the battery pack 760 does not include the output(s) 793. In some embodiments, the battery pack 760 communicates with the external device 104, and the external device 104 generates a graphical user interface that conveys information to the user without the need for output(s) 793 on the battery pack 760 itself.

FIG. 8 illustrates a process 800 of constructing and implementing a machine learning program, algorithm, and/or model, which may be implemented as machine learning control 784. The process 800 is described with respect to the server electronic processor 150 and the power tool battery charger 702 and/or battery pack 760. However, as previously described with respect to FIGS. 7A-7C, the power tool battery charger 702 is representative of the power tool battery chargers 102, 202, 302, 402, 502 described in the respective systems of FIGS. 1-5, and the battery pack 760 is representative of the battery pack 660. Additionally, the server electronic processor 150 may be incorporated into one or more of the servers 106, 206, 306, 406, described in the respective systems of FIGS. 1-4A. Accordingly, the process 800 may be implemented by one or more of the systems described above in FIGS. 1-7C, including by one or more of the server electronic processors 150 in combination with one or more of the power tool battery chargers 102, 202, 302, 402, 502, 702 and/or battery packs 660, 760. Additionally, as described in further detail below; the process 800 can be implemented by one or more of the power tool battery chargers 102, 202, 302, 402, 502, 702 and/or battery packs 660, 760 (i.e., without a server processor). Further, at least in some embodiments, the process 800 may be implemented by other server processors and/or other power tool battery chargers and/or battery packs.

In step 802, the server processor 150 accesses power tool device data, such as usage data and/or other power tool device data, previously collected from similar power tool battery chargers and/or battery packs. Additionally, the server processor 150 can access user characteristic information, such as characteristic information of a user using a respective power tool battery charger and/or battery pack at a time the power tool battery charger and/or battery pack is collecting power tool device data. For example, to build the machine learning control 784 for the power tool battery chargers of FIGS. 1-5 and 7A, the server electronic processor 150 accesses power tool device data previously collected from other power tool battery chargers, battery packs, and/or power tools (e.g., via the network 108). Additionally or alternatively, to build the machine learning control for the battery packs of FIGS. 6 and 7C, the server electronic processor 150 accesses power tool device data previously collected from other power tool battery chargers, battery packs, and/or power tools (e.g., via the network 108). The power tool device data includes, for example, some or all of usage data, maintenance data, feedback data, power source data, sensor data, environmental data, operator data, location data, and the like. Additionally, the server electronic processor 150 accesses user characteristic information previously collected (e.g., via the network 108).

In some embodiments, the server processor 150 accesses power tool device data from a network of connected power tool battery chargers, battery packs, power tools, external devices, and any connected wireless communication devices, control hubs, access points, gateway devices, or the like (e.g., a power tool device network). For example, many jobsites have specific hours during which work is regularly performed. In these instances, a network of power tool battery chargers may be used to collect power tool device data associated with the jobsite, such as usage data indicating the hours and/or days during which the power tool battery chargers are most commonly used at the jobsite. For example, the network of power tool battery chargers can collect usage data indicating when battery packs are being put on and/or taken off of power tool battery chargers, when battery packs are being put on and/or taken off of power tools, charging patterns, and the like. The power tool device network can be linked based on the location of the devices. For instance, the power tool battery chargers, battery packs, power tools, external devices, and any connected wireless communication devices, control hubs, access points, gateway devices, or the like, being used at the same jobsite location may be connected as a power tool device network. In some embodiments, the jobsite may be a single floor on a building construction project (e.g., a skyscraper) where different trades may be grouped by floor.

In still other embodiments, the power tool device network may include power tool battery chargers, battery packs, power tools, external devices, and any connected wireless communication devices, control hubs, access points, gateway devices, or the like, that are owned in the same inventory (e.g., a digital inventory maintained by the server electronic processor 150 on the server memory 160 linking such devices to an operator or other entity), and/or that are commonly used by the same group of users. In these instances, the operator data may be shared amongst the devices in the power tool device network and used to indicate which devices should be included in the power tool device network for data collection and storage.

The power tool device network may also include power tool battery chargers and power tools that are sharing a common group of battery packs. In these instances, the power tool device network can also include the battery packs being shared amongst the power tool battery chargers and power tools, as well as any connected devices, such as external devices, wireless communication devices, control hubs, access points, gateway devices, or the like. For example, if a particular battery pack is commonly put on a first and second power tool battery charger, then the battery pack and the first and second power tool battery chargers can be considered a power tool device network, and may aggregate their settings or other power tool device data amongst themselves.

The server electronic processor 150 then proceeds to build and/or train the machine learning control 784 based on the power tool device data, the user characteristic information, or both, as indicated at step 804. In some instances, a previously trained machine learning control may be retrained on new power tool device data. Building and training the machine learning control 784 may include, for example, determining the machine learning architecture (e.g., using a support vector machine, a decision tree, a neural network, or a different architecture). In the case of building and training a neural network, for example, building the neural network may also include determining the number of input nodes, the number of hidden layers, the activation function for each node, the number of nodes of each hidden layer, the number of output nodes, and the like. Training the machine learning control 784 includes providing training examples to the machine learning control 784 and using one or more algorithms to set the various weights, biases, or other parameters of the machine learning control 784 to make reliable estimations or classifications.

As will be described in more detail below, in some embodiments the machine learning control 784 constructed by the server electronic processor 150 can be deployed to power tool devices (e.g., a power tool battery charger 702) where the machine learning controller 710 can be updated or otherwise refined, and/or can have its output logic adjusted based on the initial machine learning controller 784. That is, the machine learning control 784 constructed by the server electronic processor 150 can be tuned (e.g., hand tuned) by an end user of the power tool device.

In some embodiments, building and training the machine learning control 784 includes building and training a recurrent neural network. Recurrent neural networks allow analysis of sequences of inputs instead of treating every input individually. That is, recurrent neural networks can base their determination or output for a given input not only on the information for that particular input, but also on the previous inputs. For example, when the machine learning control 784 is configured to determine a charging state for a battery pack and/or generate charger operation data for charging the battery pack, the machine learning control 784 may determine that since the last three operations charged a battery pack to a specified charging target using a particular charging rate (or variable charging rate over a duration of time), the fourth operation is also likely to use the same charging operation parameters. Using recurrent neural networks helps compensate for some of the misclassifications the machine learning control 784 would make by providing and taking into account the context around a particular operation. Accordingly, when implementing a recurrent neural network, the learning rate affects not only how each training example affects the overall recurrent neural network (e.g., adjusting weights, biases, and the like), but also affects how each input affects the output of the next input.

The server electronic processor 150 builds and trains the machine learning control 784 to perform a particular task. For example, in some embodiments, the machine learning control 784 is trained to adjust the charging of one or more battery packs 760 based on usage data and/or other power tool device data (e.g., by determining a use application for the power tool battery charger 702 and adjusting the charger operation data accordingly, by determining a charging state for a battery pack 760 and adjusting the charger operation data accordingly, and the like). In other embodiments, the machine learning control 784 is trained to determine a retake time for a battery pack 760 and/or to adjust the charger operation based on the retake time that was determined for the battery pack 760. In still other embodiments, the machine learning control 784 is trained to determine working hours for a battery pack 760) and/or one or more power tools (e.g., one or more power tools frequently used with a particular battery pack) and/or to adjust the charger operation based on the working hours for the battery pack 760 and/or the one or more power tools. In other embodiments, the machine learning control 784 is trained to determine a charging state for a battery pack 760 and/or to adjust the charger operation based on the charging state that was determined for the battery pack 760.

The task for which the machine learning control 784 is trained may vary based on, for example, the type of power tool battery charger 702 and/or battery pack 760, a selection from a user, typical applications for which the power tool battery charger and/or battery pack 760 is used, user characteristic information, other characteristics or operational parameters indicated in power tool device data, and the like. Various examples of particular tasks for which the machine learning control 784 is built and trained are described below in more detail. The server electronic processor 150 uses different power tool device data to train the machine learning control 784 based on the particular task.

In some embodiments, the particular task for the machine learning controller 710, 715 (e.g., for the machine learning control 784) also defines the particular architecture for the machine learning control 784. For example, for a first set of tasks, the server electronic processor 150 may build a support vector machine, while, for a second set of tasks, the server electronic processor 150 may build a neural network. In some embodiments, each task or type of task is associated with a particular architecture. In such embodiments, the server electronic processor 150 determines the architecture for the machine learning control 784 based on the task and the machine learning architecture associated with the particular task.

After the server electronic processor 150 builds and trains the machine learning control 784, the server electronic processor 150 stores the machine learning control 784 in, for example, the memory 160 of the server, as indicated at step 806. The server electronic processor 150, additionally or alternatively, transmits the trained machine learning control 784 to the power tool battery charger 702 and/or the battery pack 760. In such embodiments, the power tool battery charger 702 stores the machine learning control 784 in the memory 782 of the machine learning controller 710 and/or the battery pack 760 stores the machine learning control 784 in the memory of the machine learning controller 715. In some embodiments, for example, when the machine learning control 784 is implemented by the electronic controller 720 of the power tool battery charger 702, the power tool battery charger 702 stores the machine learning control 784 in the memory 740 of the electronic controller 720. In other embodiments, for example, when the machine learning control 784 is implemented by the electronic controller 725 of the battery pack 760, the battery pack 760 stores the machine learning control 784 in the memory 745 of the electronic controller 725.

Once the machine learning control 784 is stored, the power tool battery charger 702 operates the charging circuit(s) 758 according to (or based on) the outputs and determinations from the machine learning controller 710 of the power tool battery charger 702 and/or the machine learning controller 715 of the battery pack 760, as indicated at step 808. Additionally or alternatively, the battery pack 760 operates its charging circuit(s) 759 according to (or based on) the outputs and determinations from the machine learning controller 715 of the battery pack 760 and/or the machine learning controller 710 of the power tool battery charger. For example, the machine learning controller 715 of the battery pack may determine usage data, such as retake time and/or working hours, for the battery pack 760 and communicate these usage data to the machine learning controller 710 of the power tool battery charger 702, which may then generate charger operation data for controlling the charging circuit(s) 758 based on the battery pack 760 usage data. In embodiments in which the machine learning controller 710, 715 (including the machine learning control 784) is implemented in the server 106, 206, the server 106, 206 may determine operational thresholds from the outputs and determinations from the machine learning controller 710, 715. The server 106, 206 then transmits the determined operational thresholds to the power tool battery charger 702 to control the charging circuit(s) 758.

The performance of the machine learning controller 710, 715 depends on the amount and quality of the data used to train the machine learning controller 710, 715. Accordingly, if insufficient data is used (e.g., by the server 106, 206, 306, 406) to train the machine learning controller 710, 715, the performance of the machine learning controller 710, 715 may be reduced. Alternatively, different users may have different preferences and may operate the power tool battery charger 702 for different applications and in a slightly different manner (e.g., some users may place battery packs onto the power tool battery charger 702 at different times of the day, some may prefer a faster charging speed, and the like) and/or may have different preferences on the charging state of a battery pack 760 (e.g., whether to charge the battery pack 760 with priority to extending battery life, whether to charge the battery pack 760 with priority to charging performance, or the like). These differences in usage of the power tool battery charger 702 and/or battery pack 760 may also compromise some of the performance of the machine learning controller 710, 715 from the perspective of a user.

Optionally, to improve the performance of the machine learning controller 710, 715, in some embodiments, the server electronic processor 150 receives feedback from the power tool battery charger 702, the battery pack 760, and/or the external device 104 regarding the performance of the machine learning controller 710, 715, as indicated at step 810. In other words, at least in some embodiments, the feedback is with regard to the control of the charging circuit(s) 758, 759 from the earlier step 806. In other embodiments, however, the power tool battery charger 702 and/or battery pack 760 does not receive user feedback regarding the performance of the machine learning controller 710, 715 and instead continues to operate the power tool battery charger 702 and/or battery pack 760 by executing the machine learning control 784 (e.g., the process may not proceed to steps 810, 812, and 814). As explained in further detail below; in some embodiments, the power tool battery charger 702 and/or battery pack 760 includes specific feedback mechanisms for providing feedback on the performance of the machine learning controller 710, 715. In some embodiments, the external device 104 may also provide a graphical user interface that receives feedback from a user regarding the operation of the machine learning controller 710, 715. The external device 104 then transmits the feedback indications to the server electronic processor 150.

In some embodiments, the power tool battery charger 702 and/or battery pack 760 may only provide negative feedback to the server 106, 206, 306, 406 (e.g., when the machine learning controller 710, 715 performs poorly). In some embodiments, the server 106, 206, 306, 406 may consider the lack of feedback from the power tool battery charger 702, battery pack 760, and/or external device 104 to be positive feedback indicating an adequate performance of the machine learning controller 710, 715. In some embodiments, the power tool battery charger 702 and/or battery pack 760 receives, and provides to the server electronic processor 150, both positive and negative feedback.

In some embodiments, in addition to, or instead of, user feedback (e.g., directly input to the power tool battery charger 702), the power tool battery charger 702 senses one or more power tool battery charger characteristics via one or more sensors 772, and the feedback is based on the sensor data. For example, the power tool battery charger 702 can include a temperature sensor to sense a temperature of the power tool battery charger 702 during a charging operation, and the sensed output temperature is provided as feedback. The sensed output temperature may be evaluated locally on the power tool battery charger 702, or externally on the external device 104 or the server electronic processor 150, to determine whether the feedback is positive or negative (e.g., the feedback may be positive when the sensed output temperature is within an acceptable temperature range, and negative when outside of the acceptable temperature range). Similarly, the battery pack 760 may sense one or more battery pack characteristics via one or more sensors 773, and the feedback may be based on the sensor data. As discussed above, in some embodiments, the power tool battery charger 702 and/or battery pack 760 may send the feedback or other information directly to the server 106, 206, 306, 406 while in other embodiments, an external device 104 may serve as a bridge for communications between the power tool battery charger 702 and/or battery pack 760 and the server 106, 206, 306, 406 and may send the feedback to the server 106, 206, 306, 406.

The server electronic processor 150 then adjusts the machine learning control 784 based on the received user feedback, as indicated at step 812. In some embodiments, the server electronic processor 150 adjusts the machine learning control 784 after receiving a predetermined number of feedback indications (e.g., after receiving 100 feedback indications). In other embodiments, the server electronic processor 150 adjusts the machine learning control 784 after a predetermined period of time has elapsed (e.g., every two weeks or every two months). In yet other embodiments, the server electronic processor 150 adjusts the machine learning control 784 continuously (e.g., after receiving each feedback indication). Adjusting the machine learning control 784 may include, for example, re-training the machine learning controller 710, 715 using the additional feedback as a new set of training data or adjusting some of the parameters (e.g., weights, support vectors, and the like) of the machine learning controller 710, 715. Because the machine learning controller 710, 715 has already been trained for the particular task, re-training the machine learning controller 710, 715 with the smaller set of newer data requires fewer computing resources (e.g., time, memory, computing power, etc.) than the original training of the machine learning controller 710, 715.

In some instances, transfer learning can be used to re-train or otherwise adjust the machine learning control 784, in which case the re-training and/or adjusting of the machine learning control 784 may occur locally on the power tool battery charger 702 and/or battery pack 760 rather than on the server 106, 206, 306, 406. For example, the electronic processor 780 of the machine learning controller 710, electronic processor of the machine learning controller 715, or the electronic processor 730 of the electronic controller 720 can implement transfer learning to re-train the machine learning control 784 based on the new set of training data.

In some embodiments, the machine learning control 784 includes a reinforcement learning control that allows the machine learning control 784 to continually integrate the feedback received by the user to optimize the performance of the machine learning control 784. In some embodiment, the reinforcement learning control periodically evaluates a reward function based on the performance of the machine learning control 784. In such embodiments, training the machine learning control 784 includes increasing the operation time of the power tool battery charger 702 and/or battery pack 760 such that the machine learning control 784 (e.g., reinforcement learning control) receives sufficient feedback to optimize the execution of the machine learning control 784. In some embodiments, when reinforcement learning is implemented by the machine learning control 784, a first stage of operation (e.g., training) is performed during manufacturing or before, such that when a user operates the power tool battery charger 702 and/or uses the battery pack 760, the machine learning control 784 can achieve a predetermined minimum performance (e.g., accuracy). The machine learning control 784, once the user operates the power tool battery charger 702 and/or uses the battery pack 760, may continue learning and evaluating the reward function to further improve its performance. Accordingly, the power tool battery charger 702 and/or battery pack 760 may be initially provided with a stable and predictable algorithm, which may be adapted over time. In some embodiments, reinforcement learning is limited to portions of the machine learning control 784. For example, in some embodiments, instead of potentially updating weights/biases of the entire or a substantial portion of the machine learning control 784, which can take significant processing power and memory, the actual model remains frozen or mostly frozen (e.g., all but last layer(s) or outputs), and only one or a few output parameters or output characteristics of the machine learning control 784 are updated based on feedback.

In some embodiments, the machine learning controller 710 interprets the operation of the power tool battery charger 702 by the user as feedback regarding the performance of the machine learning controller 710. For example, if a user commonly places a particular battery pack 760 on the power tool battery charger 702 so that the battery pack charges before other battery packs, then the machine learning controller 710 may learn to prioritize that given battery pack 760. As another example, if a user commonly indicates they want a given battery pack 760 charged at a faster rate (e.g., via a button press such as using input 790, via a graphical user interface using the external device 104, by slamming the battery pack 760 on the power tool battery charger 702, by rapidly putting the battery pack 760 on and taking the battery pack 760 off the power tool battery charger 702), the machine learning controller 710 may learn to adjust its charging action to prioritize speed over life for that particular battery pack, that particular type of battery pack, similar battery packs, and the like. For example, a bounce detector may detect if a battery pack 760 is placed smoothly or with high speed or high force on a charger. While a debounce logic is usually made to avoid the bouncing characteristic of electrical contacts, the contact/disconnect/reconnect logic can be used as a feedback and/or direct command on how a battery should be charged. In some embodiments, the feedback data may include data associated with a charging port that has a mechanical means of detecting user force or prolonged force. For instance, a load cell, strain sensor, spring, or biased charging port with a sensing for depression may be used as feedback or a direct command to a charger.

Additionally or alternatively, the machine learning controller 715 can interpret the operation of the battery pack 760 by the user as feedback regarding the performance of the machine learning controller 715. For example, if a user frequently uses the battery pack 760) with a particular power tool or type of power tool, then the machine learning controller 715 may learn to determine a charging state for the battery pack 760 that prioritizes charging the battery pack 760 based on charging rates and/or charging targets that meet the needs of the power tool application.

In some embodiments, the server 106, 206, 306, 406 receives power tool device data from a variety of different power tool battery chargers, battery packs, and/or power tools. Accordingly, when the server electronic processor 150 adjusts the machine learning control 784 based on the user feedback, the server electronic processor 150 may be adjusting the machine learning control 784 based on feedback from various users. In embodiments in which the machine learning controller 710 is fully implemented on the power tool battery charger 702 (e.g., such as discussed above with respect to FIGS. 4A and 4B), the electronic controller 720 may use the feedback indications from only the power tool battery charger 402 (FIG. 4B) to adjust the machine learning controller 410 of the same power tool battery charger 402. In other words, some power tool battery chargers 702 may use only the feedback information from particular users to adjust the machine learning control 784. Using the feedback information from particular users may help customize the operation of the power tool battery charger 702 for the user of that particular power tool battery charger. Additionally or alternatively, in embodiments in which the machine learning controller 715 is fully implemented on the battery pack 760, the electronic controller 725 may use the feedback indications from only the battery pack 760 to adjust the machine learning controller 715 of the same battery pack 760 power. In other words, some battery packs 760) may use only the feedback information from particular users to adjust the machine learning control 784. Using the feedback information from particular users may help customize the operation of the battery pack 760 and/or power tool battery charger 702 for the user of that particular battery pack and/or power tool battery charger.

After the server electronic processor 150 adjusts the machine learning controller 710, 715 based on the user feedback, the power tool battery charger 702 operates according to the outputs and determinations from the adjusted machine learning controller 710, 715, as indicated at step 814. In some embodiments, such as the power tool battery charger system 300 of FIG. 3, the server 306 transmits the adjusted machine learning control 784 to the power tool battery charger 702. The power tool battery charger 702 then stores the adjusted machine learning control 784 in the memory 782 of the machine learning controller 710 (or in the memory 740 of the power tool battery charger 702), and operates the charging circuit(s) 758 according to the adjusted machine learning controller 710. Similarly, in some embodiments, the battery pack 760 can store the adjusted machine learning control 784 in the memory of the machine learning controller 715 (or in the memory 745 of the battery pack 760), and operates the charging circuit(s) 759 according to the adjusted machine learning controller 715. The adjusted machine learning controller 710, 715 improves its performance by using a larger and more varied dataset (e.g., by receiving feedback indications from various users) for the training of the machine learning controller 715.

In some embodiments, the user may also select a learning rate for the machine learning controller 710, 715. Adjusting the learning rate for the machine learning controller 710, 715 impacts the speed of adjustment of the machine learning controller 710, 715 based on the received user feedback. For example, when the learning rate is high, even a small number of feedback indications from the user (or users) will impact the performance of the machine learning controller 710, 715. On the other hand, when the learning rate is lower, more feedback indications from the user are used to create the same change in performance of the machine learning controller 710, 715. Using a learning rate that is too high may cause the machine learning controller 710, 715 to change unnecessarily due to an anomaly in the operation of the power tool battery charger 702 and/or battery pack 760. On the other hand, using a learning rate that is too low may cause the machine learning controller 710, 715 to remain unchanged until a large number of feedback indications are received requesting a similar change. It will be appreciated also that multiple learning rates may also be implemented. For instance, different learning rates may be associated with different subregions of a machine learning control. A user may, for example, modify the learning rate (or switching rate) for the later stages of the machine learning control that map classifications and regressions to desired outputs.

In some embodiments, the power tool battery charger 702 (and/or battery pack 760) includes a dedicated actuator to adjust the learning rate of the machine learning controller 710 (and/or machine learning controller 715). In another embodiment, the activation switch 774, 775 used to enable or disable the machine learning controller 710, 715 may also be used to adjust the learning rate of the machine learning controller 710, 715. For example, the activation switch 774, 775 may include a rotary dial. When the rotary dial is positioned at a first end, the machine learning controller 710, 715 may be disabled, as the rotary dial moves toward a second end opposite the first end, the machine learning controller 710, 715 is enabled and the learning rate increases. When the rotary dial reaches the second end, the learning rate may be at a maximum learning rate. In other embodiments, an external device 104 (e.g., smartphone, tablet, laptop computer, an ASIC, and the like), may communicatively couple with the power tool battery charger 702 and/or battery pack 760 and provide a user interface to, for example, select the learning rate. In some embodiments, the selection of a learning rate may include a selection of a low, medium, or high learning rate. In other embodiments, more or less options are available to set the learning rate, and may include the ability to turn off learning (i.e., setting the learning rate to zero).

As discussed above, when the machine learning controller 710, 715 implements a recurrent neural network, the learning rate (or sometimes referred to as a “switching rate”) affect how previous inputs or training examples affect the output of the current input or training example. For example, when the switching rate is high the previous inputs have minimal effect on the output associated with the current input. That is, when the switching rate is high, each input is treated more as an independent input. On the other hand, when the switching rate is low; previous inputs have a high correlation with the output of the current input. That is, the output of the current input is highly dependent on the outputs determined for previous inputs. In some embodiments, the user may select the switching rate in correlation (e.g., with the same actuator) with the learning rate. In other embodiments, however, a separate actuator (or graphical user interface element) is generated to alter the switching rate independently from the learning rate. The methods or components to set the switching rate are similar to those described above with respect to setting the learning rate.

The description of FIG. 8 focuses on the server electronic processor 150 training, storing, and adjusting the machine learning control 784. In some embodiments, however, the electronic controller 720 of the power tool battery charger 702 and/or the electronic controller 725 of the battery pack 760 may perform some or all of the steps described above with respect to FIG. 8. For example, FIG. 4 illustrates an example power tool battery charger system 400 in which the power tool battery charger 402 stores and adjusts the machine learning controller 710. Accordingly, in this system 400, the electronic controller 720 performs some or all of the steps described above with respect to FIG. 8. Analogously, in some embodiments, the electronic processor 780 of the machine learning controller 710, the electronic controller 725 of the battery pack 760, or the external device 104 performs some or all of the steps described above with respect to FIG. 8.

FIG. 9 is a flowchart illustrating a process 900 of operating the power tool battery charger 702 according to the electronic controller 720, the machine learning controller 710, or alternatively according to an artificial intelligence controller as described above.

In step 902, the power tool battery charger 702 receives a signal indicating that the power tool battery charger 702 is to begin an operation. For example, the battery pack interface 752 may have mechanical or other means of detecting that a battery pack 760 has been put on the battery pack interface 752 and that charging of that battery pack 760 should be initiated. In response to detecting a battery pack 760, the battery pack interface 752 may provide an indication of the detection that is received by the electronic controller 720. In some embodiments, this indication is the signal received by the power tool battery charger 702 indicating that the power tool battery charger 702 is to begin the operation.

During operation of the power tool battery charger 702, the electronic controller 720 receives power tool device data, as indicated at step 904, from the sensors 772 and/or a connected power tool device (e.g., an external device 104, a server 106, 206, 306, 406, a power tool, a battery pack, another power tool battery charger, a control hub). The power tool device data may be received from various sources, as described herein. For example, the power tool device data may be received by the electronic controller 720 of the power tool battery charger 702 from the power tool battery pack 760 (e.g., from a memory of the battery pack 760) populated by the battery pack 760 during use of the battery pack 760), from a memory for the power tool battery charger 702 (e.g., the memory 740), from the external device 104, from the server 106, 206, 306, 406, or a combination thereof. The source of the particular data making up the set of power tool device data may be provided by the device that collects or generates such data. For example, usage data for the power tool battery charger 702 may be retrieved from a memory of the power tool battery charger 702, while usage data for the power tool battery pack 760 may be provided to the power tool battery charger 702 from the power tool battery pack 760. Data of the set of power tool device data that are provided, in step 904, to the power tool battery charger 702 from another device may be communicated via one or more of the wired or wireless connections and communication capabilities of the power tool battery charger 702, as described herein (e.g., with respect to FIG. 7A).

As discussed above, the power tool device data provide varying information regarding the operation of the power tool battery charger 702, the battery pack(s) 760, and/or one or more associated power tools, including, for example, usage data (e.g., usage data of the power tool battery charger 702, another power tool battery charger, one or more battery packs, and/or one or more power tools), maintenance data (e.g., maintenance data of the power tool battery charger 702, another power tool battery charger, one or more battery packs, and/or one or more power tools), feedback data, power source data, sensor data (e.g., sensor data of the power tool battery charger 702, another power tool battery charger, one or more battery packs, and/or one or more power tools), environmental data, operator data, location data, and the like. The power tool device data may also include other operational parameter data, such as date, time, time since last use, mode, errors, history of past applications and charging rates, user input, external inputs, and the like.

In some embodiments, the electronic controller 720 can receive the power tool device data from one or more power tool devices in a connected power tool device network (e.g., a network of connected power tool battery chargers, battery packs, power tools, external devices, wireless communication devices, control hubs, access points, gateway devices, or the like). For example, the power tool device network can be linked based on the location of the devices. In some embodiments, the power tool device network can include devices being used at the same jobsite location. The jobsite may be a single floor on a building construction project (e.g., a skyscraper) where different trades may be grouped by floor, or other suitable geographical location where power tool devices are regularly used to perform work. In still other embodiments, the power tool device network may include devices that are owned in the same inventory, and/or that are commonly used by the same group of users. The power tool device network may also include power tool battery chargers and power tools that are sharing a common group of battery packs. In these instances, the power tool device network can also include the battery packs being shared amongst the power tool battery chargers and power tools, as well as any connected devices, such as external devices, wireless communication devices, control hubs, access points, gateway devices, or the like.

The electronic controller 720 then provides at least some of the power tool device data to the electronic processor 730, the machine learning controller 710, or additionally or alternatively an artificial intelligence controller, as indicated at step 906. In embodiments in which the electronic controller 720 implements the machine learning control 784 (or artificial intelligence control), the electronic controller 720 bypasses step 906. When the power tool battery charger 702 does not store a local copy of the machine learning controller 710 (or artificial intelligence controller), such as in the power tool battery charger system 100 of FIG. 1, the electronic controller 720 transmits some or all of the power tool device data to the server 106 where the machine learning controller 710 (or artificial intelligence controller) analyzes the received data in real-time, approximately real-time, at a later time, or not at all.

The power tool device data transmitted to the electronic processor 730 and/or the machine learning controller 710 (or artificial intelligence controller) varies based on, for example, the particular task for the electronic controller 720, machine learning controller 710, or artificial intelligence controller. As discussed above, the task for the electronic controller 720, machine learning controller 710, (or artificial intelligence controller) may vary based on, for example, the type of power tool battery charger 702, the type of battery pack(s) 760 attached to the power tool battery charger 702, or so on.

For example, the machine learning controller 710 (or artificial intelligence controller) for the power tool battery charger 702 may be configured to identify a type of application of the power tool battery charger 702 and may use specific operational thresholds for each type of application. In such embodiments, the electronic controller 720 may transmit, for example, a first set of charger operation data indicating that a battery pack 760 should be charged according to a faster charging mode, but may not send a second set of charger operation data indicating that the battery pack 760 could be charged according to a slower charging mode that optimizes battery life.

The electronic processor 730, machine learning controller 710, or artificial intelligence controller then generates an output based on the received power tool device data and the particular task associated with the electronic controller 720, machine learning controller 710, or artificial intelligence controller, as indicated at step 908.

For example, the machine learning program, algorithm, or model executing on the machine learning controller 710 (or artificial intelligence program, algorithm, or model executing on an artificial intelligence controller, or other program, algorithm or model executing on the electronic controller 720) processes (e.g., classifies according to one of the aforementioned machine learning and/or artificial intelligence algorithms) the received power tool device data and generates an output.

In the example above, the output of the machine learning controller 710 may indicate a type of application for which the power tool battery charger 702 is being used, charger operation data for controlling the operation of charging circuit(s) 758 of the power tool battery charger 702, and the like.

The electronic controller 720 then operates the charging circuits(s) 758 based on the output from the electronic processor 730, machine learning controller 710, or artificial intelligence controller, as indicated at step 910.

For example, the electronic controller 720 may use the output from the electronic processor 730 or machine learning controller 710 to determine whether any operational thresholds (e.g., charging target(s), charging rate(s), time indications for changing charging rate(s), time-of-day to charge, and the like) are to be changed to increase the efficacy of the operation of the power tool battery charger 702. The electronic controller 720 then utilizes the updated operational thresholds or ranges to operate the charging circuit(s) 758.

In another example, the output may indicate a condition of a battery pack 760 connected to the power tool battery charger 702 and the electronic controller 720 controls the charging circuit(s) 758 dependent on the condition. For example, and as described in further detail below, the condition may indicate a temperature of the battery pack 760, a state of charge of the battery pack 760, an abnormal condition that is detected, or an operation that is finished (e.g., charging to a particular charging target, charging for a particular duration of time). The charging circuit(s) 758, in turn, may be controlled to stop, to increase charging rate, or decrease charging rate based on the condition, or may be controlled in other ways based on the condition. Although the particular task of the machine learning controller 710 may change as described in more detail below, the electronic controller 720 uses the output of the machine learning controller 710 to, for example, better operate the power tool battery charger 702 and achieve a greater operating efficiency.

In some embodiments, the electronic processor 730 or machine learning controller 710 receives user characteristics of the current user of the power tool battery charger 702 in step 906, in addition to or instead of sensor data, and then generates an output in step 908 based on the user characteristics or based on the user characteristics and the sensor data received in step 906. In some embodiments, in addition to or instead of controlling the charging circuit(s) 758 in step 910, another electronically controllable element is controlled. For example, in some embodiments, an LED of the power tool battery charger 702 is enabled, disabled, has its color changed, or has its brightness changed.

In some embodiments, the server 106, 206, 306, 406 may store a selection of various machine learning controls 784 in which each machine learning control 784 is specifically trained to perform a different task. In such embodiments, the user may select which of the machine learning controls 784 to implement with the power tool battery charger 702. For example, an external device 104 may provide a graphical interface that allows the user to select a type of machine learning control 784. A user may select the machine learning control 784 based on, for example, usage data, jobsite data (e.g., data indicating likely use applications for the power tool battery charger 702), energy costs for the power source supplying power to the power tool battery charger 702, the type of power source supplying power to the power tool battery charger 702, the position and/or location of the power tool battery charger 702 (e.g., determined via inertial sensors, GNSS signal data, and the like), amongst others. In such embodiments, the graphical user interface receives a selection of a type of machine learning control 784. The external device 104 may then send the user's selection to the server 106, 206, 306, 406. The server 106, 206, 306, 406 would then transmit a corresponding machine learning control 784 to the power tool battery charger 702, or may transmit updated operational thresholds based on the outputs from the machine learning control 784 selected by the user. Accordingly, the user can select which functions to be implemented with the machine learning control 784 and can change which type of machine learning control 784 is implemented by the server 106, 206, 306, 406 or the power tool battery charger 702 during the operation of the power tool battery charger 702.

As discussed above, a user may provide feedback indications regarding the operation of the electronic processor 730 or machine learning controller 710. In one example, a user may commonly place a particular battery pack 760 on the power tool battery charger 702 so that the battery pack charges before other battery packs, which may indicate to the machine learning controller 710 to implement a particular controller action for that battery pack 760. As another example, a user may indicate that they want a given battery pack 760 charged at a faster rate (e.g., via a button press such as using input 790, via a graphical user interface using the external device 104, by slamming the battery pack 760 on the power tool battery charger 702, by rapidly placing the battery pack 760 on and taking the battery pack 760 off the power tool battery charger 702), such that the machine learning controller 710 may implement a particular controller action associated with the user feedback indicating a faster charging rate is desired. That is, in some instances, the user may override a default machine learning control 784 of the machine learning controller 710. This overriding may include deactivating the machine learning controller 710 in favor of a manual control or adjustment of the power tool battery charger 702: switching the machine learning controller 710 to perform a different machine learning program, algorithm, or model; and/or adjusting the outputs of the machine learning controller 710.

In another example, the input(s) 790 of the power tool battery charger 702 may include one or more actuators that can receive user feedback regarding the operation of the power tool battery charger 702 and regarding the operation of the electronic processor 730 or machine learning controller 710, in particular. In some embodiments, the power tool battery charger 702 includes a first actuator and a second actuator. In some embodiments, each actuator may be associated with a different type of feedback. For example, the activation of the first actuator may indicate that the operation of the machine learning controller 710 is adequate (e.g., positive feedback), while the activation of the second actuator may indicate that the operation of the machine learning controller 710 is inadequate (e.g., negative feedback). For example, a user may indicate that changes made to the charging operation (e.g., charging target(s), charging rate(s), time indications for charging, time-of-day for charging, order of charging battery packs) are undesirable when the electronic controller 720 implemented a different charging operation due to a determination by the machine learning controller 710 that the power tool battery charger 702 is being utilized for a particular application.

In other embodiments, the first actuator and the second actuator (or an additional pair of buttons) are associated with increasing and decreasing the learning rate of the machine learning controller 710, respectively. For example, when the user wants to increase the learning rate (or switching rate) of the machine learning controller 710, the user may activate the first actuator. The first and second actuators may be positioned on any suitable portion of the housing of the power tool battery charger.

In another embodiment, the user may provide feedback to the electronic controller 720 by moving the power tool battery charger 702 itself. For example, the power tool battery charger 702 may include an accelerometer and/or a magnetometer (e.g., as a sensor 772) that provides an output signal to the electronic controller 720 indicative of a position, orientation, or combination thereof of the power tool battery charger 702. In such embodiments, sensor data from the sensors 772 may indicate aspects of the positional or location context for the power tool battery charger 702. Such contextual information may indicate prioritizing how and when to charge battery packs 760. A power tool battery charger 702 may also have sensors 772 such as a pressure sensor (to help measure altitude, such as height in a building) and/or a GPS or other GNSS receiver. These positional and/or locational sensor data can help understand the power tool battery charger 702 context. For example, a power tool battery charger 702 may be hung on a wall, secured in a vehicle, carried, placed on the ground, put on an attachment system (e.g., a modular toolbox or storage system), etc.

By detecting, based on the sensor data, that a power tool battery charger 702 is secured in a vehicle that is moved, charger operation data can be generated to prioritize fast charging of the battery pack(s) 760, to prioritize charging battery packs 760 so they are sufficiently charged when the vehicle arrives at an estimated or otherwise identified location (e.g., based on user input via the external device 104 or estimated based on usage data and past location data), and the like. For instance, a moving power tool battery charger 702 may also indicate that the power tool battery charger 702 is moving in a toolbox or modular storage system and may have battery packs that are soon to be used. Additionally or alternatively, a moving power tool battery charger 702 may also indicate that the power tool battery charger 702 changing altitudes (e.g., between floors in a skyscraper) may soon be used, especially if the sensor data indicate that the power tool battery charger 702 is increasing in altitude.

The power tool battery charger 702 may have additional capabilities beyond just charging battery packs 760, including charging other peripheral devices (e.g., a smartphone, whether wirelessly or via wired connection), powering a light (possibly a light that is integrated in the power tool battery charger 702), and/or powering other peripheral devices (e.g., via a USB plug, such as USB-powered fans, USB-powered chargers). These additional capabilities, especially when employed, may imply that a user may be near or soon to revisit the power tool battery charger 702. In these instances, it may be desirable to make sure a battery pack 760 is sufficiently charged for a user to take. Usage data indicating these other charging uses can be received by the electronic controller 720 and used to determine whether users are nearby and may require a charged battery pack sooner. The power tool battery charger 702 may also prioritize these additional capabilities over charging of battery packs (especially if limited by a max current draw from an outlet or other power source).

As discussed above, the machine learning controller 710 is associated with one or more particular tasks. The machine learning controller 710 receives various types of data from the one or more power tool battery chargers, one or more battery packs, one or more power tools, a server, an external device, and/or the electronic controller 720 based on the particular task for which the machine learning controller 710 is configured. For example, the machine learning controller 710 can receive data from one or more batteries (e.g., battery pack(s) 760), one or more power tools, one or more external devices (e.g., external device 104, 504), one or more servers (e.g., server 106, 206, 306, 406), other power tool battery chargers, and the like.

As described above, various types of data or other information may be utilized by the machine learning controller 710 to generate outputs, make determinations and predictions, and the like. The machine learning controller may receive, for example, usage data (e.g., usage data of the power tool battery charger 702, another power tool battery charger, one or more battery packs, and/or one or more power tools), maintenance data (e.g., maintenance data of the power tool battery charger 702, another power tool battery charger, one or more battery packs, and/or one or more power tools), feedback data, power source data, sensor data (e.g., sensor data of the power tool battery charger 702, another power tool battery charger, one or more battery packs, and/or one or more power tools), environmental data, operator data, location data, and the like.

The machine learning controller 710 may also receive information regarding the type of battery pack 760 used with the power tool battery charger 702 (e.g., a 12 V battery pack, an 18 V battery pack).

As discussed above, the input 790 may select an operating mode for the power tool battery charger 702. The operating mode may specify operation parameters and thresholds for the power tool battery charger 702 during operation in that mode. For example, each operation mode may define charger operation data such as charging rate(s), charging target(s), time indications of when to change charging rate(s) and/or charging target(s) (including durations of time at which different charging rates should be maintained), an order in which battery packs 760 should be charged, a time-of-day when battery pack(s) 760 should be charged, and a combination thereof. The combination of two or more operation parameters or thresholds define a battery charger use profile or mode. When the mode is selected by the user, the electronic controller 720 controls the charging circuit(s) 758 according to the operation parameters or thresholds specified by the selected mode, which may be stored in the memory 740.

The machine learning controller 710 also receives information regarding the operating mode of the power tool battery charger 702 such as, for example, the charging target(s) associated with the mode, the charging rate(s) associated with the mode, timing information for when to adjust charging rates and/or charging targets, and the like. The machine learning controller 710 also receives sensor data indicative of an operational parameter of the power tool battery charger 702 such as, for example, charging current, battery pack voltage, feedback from the input(s) 790, motion of the power tool battery charger, temperature of the power tool battery charger, and the like.

As discussed above, the machine learning controller 710 may also receive feedback from the user as well as an indication of a target learning rate. The machine learning controller 710 uses various types and combinations of the information described above to generate various outputs based on the particular task associated with the machine learning controller 710. For example, in some embodiments, the machine learning controller 710 generates suggested parameters for a particular mode. The machine learning controller 710 may generate a suggested starting or finishing charging rate, a suggested max charging target, a suggested time of day to charge the battery pack or at which to adjust the charging rate, and the like.

As discussed above, the architecture for the machine learning controller 710 may vary based on, for example, the particular task associated with the machine learning controller 710. In some embodiments, the machine learning controller 710 may include a neural network, a support vector machine, decision trees, logistic regression, and other machine learning architectures. The machine learning controller 710 may further utilize kernel methods or ensemble methods to extend the base structure of the machine learning controller 710. In some embodiments, the machine learning controller 710 implements reinforcement learning to update the machine learning controller 710 based on received feedback indications from the user.

FIG. 10 is a flowchart illustrating a process 1000 of operating the battery pack 760 according to the electronic controller 725, the machine learning controller 715, or alternatively according to an artificial intelligence controller as described above. In particular, the battery pack 760 is capable of receiving power tool device data and, in response, determining a charging state for the battery pack 760 and generating charger operation data that is used by a power tool battery charger to charge the battery pack 760 according to the determined charging state.

The electronic controller 725 receives power tool device data, as indicated at step 1002, from the sensors 773 and/or a connected power tool device (e.g., an external device 104, a server 106, 206, 306, 406, a power tool, another battery pack, a power tool battery charger, a control hub). The power tool device data may be received from various sources, as described herein. For example, the power tool device data may be received by the electronic controller 725 of the battery pack 760 from the power tool battery charger 702 (e.g., from a memory of the power tool battery charger 702 populated by the power tool battery charger 702 during use of the power tool battery charger 702), from a memory for the battery pack 760) (e.g., the memory 745), from the external device 104, from the server 106, 206, 306, 406, or a combination thereof. The source of the particular data making up the set of power tool device data may be provided by the device that collects or generates such data. For example, usage data for the battery pack 760 may be retrieved from a memory of the battery pack 760, while usage data for the power tool battery charger 702 may be provided to the battery pack 760 from the power tool battery charger 702. Data of the set of power tool device data that are provided, in step 1002, to the battery pack 760 from another device may be communicated via one or more of the wired or wireless connections and communication capabilities of the battery pack 760, as described herein (e.g., with respect to FIG. 7C).

As discussed above, the power tool device data provide varying information regarding the operation of the power tool battery charger 702, the battery pack(s) 760, and/or one or more associated power tools, including, for example, usage data (e.g., usage data of the battery pack 760, another battery pack, one or more power tool battery chargers, and/or one or more power tools), maintenance data (e.g., maintenance data of the battery pack 760, another battery pack, one or more power tool battery chargers, and/or one or more power tools), feedback data, power source data, sensor data (e.g., sensor data of the battery pack 760), another battery pack, one or more power tool battery chargers, and/or one or more power tools), environmental data, operator data, location data, and the like. The power tool device data may also include other operational parameter data, such as date, time, time since last use, mode, errors, history of past applications and charging rates, user input, external inputs, and the like.

In some embodiments, the electronic controller 725 can receive the power tool device data from one or more power tool devices in a connected power tool device network (e.g., a network of connected power tool battery chargers, battery packs, power tools, external devices, wireless communication devices, control hubs, access points, gateway devices, or the like). For example, the power tool device network can be linked based on the location of the devices. In some embodiments, the power tool device network can include devices being used at the same jobsite location. The jobsite may be a single floor on a building construction project (e.g., a skyscraper) where different trades may be grouped by floor, or other suitable geographical location where power tool devices are regularly used to perform work. In still other embodiments, the power tool device network may include devices that are owned in the same inventory, and/or that are commonly used by the same group of users. The power tool device network may also include power tool battery chargers and power tools that are sharing a common group of battery packs. In these instances, the power tool device network can also include the battery packs being shared amongst the power tool battery chargers and power tools, as well as any connected devices, such as external devices, wireless communication devices, control hubs, access points, gateway devices, or the like.

The electronic controller 725 then provides at least some of the power tool device data to the electronic processor 735, the machine learning controller 715, or additionally or alternatively an artificial intelligence controller, as indicated at step 1004. In embodiments in which the electronic controller 725 implements the machine learning control 784 (or artificial intelligence control), the electronic controller 725 bypasses step 1004. When the battery pack 760 does not store a local copy of the machine learning controller 715 (or artificial intelligence controller), the electronic controller 725 transmits some or all of the power tool device data to a server (e.g., the server 106) where the machine learning controller 715 (or artificial intelligence controller) analyzes the received data in real-time, approximately real-time, at a later time, or not at all.

The power tool device data transmitted to the electronic processor 735 and/or the machine learning controller 715 (or artificial intelligence controller) varies based on, for example, the particular task for the electronic controller 725, machine learning controller 715, or artificial intelligence controller. As discussed above, the task for the electronic controller 725, machine learning controller 715, (or artificial intelligence controller) may vary based on, for example, the type of battery pack 760, the type of power tool battery chargers on which the battery pack 760 is frequently put, the type of power tools with which the battery pack 760 is frequently used, or so on.

The electronic processor 735, machine learning controller 715, or artificial intelligence controller then generates an output based on the received power tool device data and the particular task associated with the electronic controller 725, machine learning controller 715, or artificial intelligence controller, as indicated at step 1006. For example, the machine learning program, algorithm, or model executing on the machine learning controller 715 (or artificial intelligence program, algorithm, or model executing on an artificial intelligence controller, or other program, algorithm or model executing on the electronic controller 725) processes (e.g., classifies according to one of the aforementioned machine learning and/or artificial intelligence algorithms) the received power tool device data and generates an output.

In the example above, the output of the machine learning controller 715 may indicate a type of charging state according to which the battery pack 760 should be charged; charger operation data for controlling the charging circuit(s) 758 of a power tool battery charger 702, the charging circuit(s) 759 of the battery pack 760, or both; and the like. For example, the machine learning controller 715 (or artificial intelligence controller) for the battery pack 760 may be configured to identify and/or determine a charging state for the battery pack 760 and may use specific operational thresholds for each type of charging state.

The charger operation data output by the electronic processor 735, machine learning controller 715, and/or artificial intelligence controller are then communicated to a power tool battery charger. In these embodiments, the battery pack 760 communicates the charger operation data to the power tool battery charger, as indicated at step 1008. For example, the battery pack 760 may communicate the charger operation data wirelessly (e.g., using wireless communication device 755), using a wired connection, or using the charger and tool interface 753 when the battery pack 760 is mechanically and electrically connected to the power tool battery charger. In some embodiments, the electronic controller 725 may transmit, for example, a first set of charger operation data indicating that a battery pack 760 should be charged according to the determined charging state, but may not send a second set of charger operation data indicating that the battery pack 760 could be charged according to a different charging state.

The electronic controller 720 of the power tool battery charger 702 (or another power tool battery charger not having a machine learning controller 710) then operates the charging circuits(s) 758 based on the charger operation data received from the battery pack 760, as indicated at step 1010. For example, the electronic controller 720 may use the charger operation data to determine whether any operational thresholds (e.g., charging target(s), charging rate(s), time indications for changing charging rate(s), time-of-day to charge, and the like) are to be changed according to the determined charging state for the battery pack 760. The electronic controller 720 then utilizes the updated operational thresholds or ranges to operate the charging circuit(s) 758.

In some embodiments, the electronic processor 730 or machine learning controller 710 receives user characteristics of the current user of the power tool battery charger 702 and/or the battery pack 760 in step 1008, in addition to the charger operation data, and then generates an output in step 1010 based on the user characteristics or based on the user characteristics and the charger operation data received in step 1008. In some embodiments, in addition to or instead of controlling the charging circuit(s) 758 in step 1010, another electronically controllable element is controlled. For example, in some embodiments, an LED of the power tool battery charger 702 and/or battery pack 760 is enabled, disabled, has its color changed, or has its brightness changed.

In some embodiments, the server 106, 206, 306, 406 may store a selection of various machine learning controls 784 in which each machine learning control 784 is specifically trained to perform a different task. In such embodiments, the user may select which of the machine learning controls 784 to implement with the battery pack 760. For example, an external device 104 may provide a graphical interface that allows the user to select a type of machine learning control 784. A user may select the machine learning control 784 based on, for example, usage data, jobsite data (e.g., data indicating likely use applications for the battery pack 760), the position and/or location of the battery pack 760 (e.g., determined via inertial sensors, GNSS signal data, and the like), amongst others. In such embodiments, the graphical user interface receives a selection of a type of machine learning control 784. The external device 104 may then send the user's selection to the server 106, 206, 306, 406. The server 106, 206, 306, 406 would then transmit a corresponding machine learning control 784 to the battery pack 760, or may transmit updated operational thresholds based on the outputs from the machine learning control 784 selected by the user. Accordingly, the user can select which functions to be implemented with the machine learning control 784 and can change which type of machine learning control 784 is implemented by the server 106, 206, 306, 406 or the battery pack 760.

As discussed above, a user may provide feedback indications regarding the operation of the electronic processor 735 or machine learning controller 715. In one example, a user may commonly place a particular battery pack 760 on the power tool battery charger 702 so that the battery pack charges before other battery packs, which may indicate to the machine learning controller 715 to implement a particular controller action for that battery pack 760. As another example, a user may indicate that they want a given battery pack 760 charged at a faster rate (e.g., via a button press such as using input 791, via a graphical user interface using the external device 104, by slamming the battery pack 760 on the power tool battery charger 702, by rapidly placing the battery pack 760 on and taking the battery pack 760 off the power tool battery charger 702), such that the machine learning controller 715 may determine a particular charging state for the battery pack 760 and implement a particular controller action associated with the user feedback indicative of the charging state.

In another example, the input(s) 791 of the battery pack 760 may include one or more actuators that can receive user feedback regarding the operation of the battery pack 760 and/or a preferred charging state for the battery pack 760, and regarding the operation of the electronic processor 735 or machine learning controller 715, in particular. In some embodiments, the battery pack 760 includes a first actuator and a second actuator. In some embodiments, each actuator may be associated with a different type of feedback. For example, the activation of the first actuator may indicate that the operation of the machine learning controller 715 is adequate (e.g., positive feedback), while the activation of the second actuator may indicate that the operation of the machine learning controller 715 is inadequate (e.g., negative feedback). For example, a user may indicate that changes made to the charging operation (e.g., charging target(s), charging rate(s), time indications for charging, time-of-day for charging, order of charging battery packs) are undesirable when the electronic controller 725 implemented a different charging operation due to a determination by the machine learning controller 715 that the power tool battery charger 702 is being utilized for a particular application.

In other embodiments, the first actuator and the second actuator (or an additional pair of buttons) are associated with increasing and decreasing the learning rate of the machine learning controller 715, respectively. For example, when the user wants to increase the learning rate of the machine learning controller 715, the user may activate the first actuator. The first and second actuators may be positioned on any suitable portion of the housing of the power tool battery charger.

In another embodiment, the user may provide feedback to the electronic controller 725 by moving the battery pack 760 itself. For example, the battery pack 760 may include an accelerometer and/or a magnetometer (e.g., as a sensor 773) that provides an output signal to the electronic controller 725 indicative of a position, orientation, or combination thereof of the battery pack 760. In such embodiments, sensor data from the sensors 773 may indicate aspects of the positional or location context for the battery pack 760. Such contextual information may indicate prioritizing how and when to charge the battery pack 760. A battery pack 760 may also have sensors 773 such as a pressure sensor (to help measure altitude, such as height in a building) and/or a GPS or other GNSS receiver. These positional and/or locational sensor data can help understand the battery pack 760 context. For example, a battery pack 760 may be hung on a wall, secured in a vehicle, carried, placed on the ground, put on an attachment system (e.g., a modular toolbox or storage system), etc.

By detecting, based on the sensor data, that a battery pack 760 is secured in a vehicle that is moved, charger operation data can be generated to prioritize fast charging of the battery pack(s) 760, to prioritize charging battery packs 760 so they are sufficiently charged when the vehicle arrives at an estimated or otherwise identified location (e.g., based on user input via the external device 104 or estimated based on usage data and past location data), and the like. For instance, a moving battery pack 760 may also indicate that the battery pack 760 is moving in a toolbox or modular storage system and may soon to be used. Additionally or alternatively, a moving battery pack 760 may also indicate that the battery pack 760 is changing altitudes (e.g., between floors in a skyscraper) and therefore may soon be used, especially if the sensor data indicate that the battery pack 760 is increasing in altitude.

As discussed above, the machine learning controller 715 is associated with one or more particular tasks. The machine learning controller 715 receives various types of data from the one or more power tool battery chargers, one or more battery packs, one or more power tools, a server, an external device, and/or the electronic controller 725 based on the particular task for which the machine learning controller 715 is configured. For example, the machine learning controller 715 can receive data from one or more batteries (e.g., battery pack(s) 760), one or more power tools, one or more external devices (e.g., external device 104, 504), one or more servers (e.g., server 106, 206, 306, 406), other power tool battery chargers and/or battery packs, and the like.

As described above, various types of data or other information may be utilized by the machine learning controller 715 to generate outputs, make determinations and predictions, and the like. The machine learning controller may receive, for example, usage data (e.g., usage data of the battery pack 760, another battery pack, one or more power tool battery chargers, and/or one or more power tools), maintenance data (e.g., maintenance data of the battery pack 760, another battery pack, one or more power tool battery chargers, and/or one or more power tools), feedback data, power source data, sensor data (e.g., sensor data of the battery pack 760, another battery pack, one or more power tool battery chargers, and/or one or more power tools), environmental data, operator data, location data, and the like.

The machine learning controller 715 may also receive information regarding the type of battery pack 760, including battery chemistry (e.g., Li-ion), present charge level, nominal voltage (e.g., a 12 V battery pack, an 18 V battery pack), total charge capacity, and the like.

As discussed above, the input 791 may select an operating mode and/or charging state for the battery pack 760. The charging state may specify operation parameters and thresholds for the battery pack 760 and/or a power tool battery charger to achieve that charging state. For example, each charging state mode may be associated with charger operation data such as charging rate(s), charging target(s), time indications of when to change charging rate(s) and/or charging target(s) (including durations of time at which different charging rates should be maintained), an order in which battery packs 760 should be charged, a time-of-day when battery pack(s) 760 should be charged, and a combination thereof. The combination of two or more operation parameters or thresholds define a charging state for the battery pack 760 and/or a battery charger use profile or mode for a power tool battery charger. When the charging state is selected by the user, the electronic controller 725 controls the charging circuit(s) 759 according to the operation parameters or thresholds specified by the charging state, which may be stored in the memory 745, or alternatively the electronic controller 720 of the power tool battery charger 702 may control the charging circuit(s) 758 according to the operation parameters or thresholds specified by the charging state, which may be stored in the memory 740.

The machine learning controller 715 also receives information regarding the operating mode of the battery pack 760 and/or connected power tool battery charger 702 such as, for example, the charging target(s) associated with the mode, the charging rate(s) associated with the mode, timing information for when to adjust charging rates and/or charging targets, and the like. The machine learning controller 715 also receives sensor data indicative of an operational parameter of the battery pack 760 and/or connected power tool battery charger 702 such as, for example, charging current, battery pack voltage, feedback from the input(s) 791, motion of the power tool battery charger, temperature of the battery pack, and the like.

As discussed above, the machine learning controller 715 may also receive feedback from the user as well as an indication of a target learning rate. The machine learning controller 715 uses various types and combinations of the information described above to generate various outputs based on the particular task associated with the machine learning controller 715. For example, in some embodiments, the machine learning controller 715 generates suggested parameters for a particular charging state. The machine learning controller 715 may generate a suggested starting or finishing charging rate, a suggested maximum charging target, a suggested time of day to charge the battery pack or at which to adjust the charging rate, and the like.

As discussed above, the architecture for the machine learning controller 715 may vary based on, for example, the particular task associated with the machine learning controller 715. In some embodiments, the machine learning controller 715 may include a neural network, a support vector machine, decision trees, logistic regression, and other machine learning architectures. The machine learning controller 715 may further utilize kernel methods or ensemble methods to extend the base structure of the machine learning controller 715. In some embodiments, the machine learning controller 715 implements reinforcement learning to update the machine learning controller 715 based on received feedback indications from the user.

As described above, the power tool battery charger 702 and/or battery pack 760 can generate charger operation data (e.g., charging rate(s), charging target(s), charging schedule(s)) to achieve a preferred or otherwise determined charging state for a particular battery pack, a type of battery pack, or one or more battery packs associated with an operator and/or jobsite (e.g., battery packs belonging to the same inventory). These charger operation data can be generated using a machine learning controller (e.g., machine learning controller 710 and/or machine learning controller 715), an electronic processor (e.g., electronic processor 730 or electronic processor 735), and/or an artificial intelligence controller implemented on the power tool battery charger 702 or battery pack 760.

In some embodiments, the charging state may be a one-dimensional charging state. For example, a power tool battery charger and/or battery pack may have two or more charging goal states for desired or optimum charging, such as the following two-state system:

| | Max Charging Target | Max Charging rate |
|---|---|---|
| Performance Charging State | 100% | Full |
| Life-Boost Charging State | 70% to 80% | Reduced |

While the one-dimensional state system is simplified with limited charging options, it permits easy communication to a user. For instance, the power tool battery charger may show the charging state, charging goal, and/or charging rate(s) to a user based on a charging state indicator, which may include illuminated icons on the power tool battery charger 702 (e.g., using output(s) 792) and/or battery pack 760 (e.g., using output(s) 793), illuminated LEDs on the power tool battery charger 702 (e.g., using output(s) 792) and/or battery pack 760 (e.g., using output(s) 793), and/or via a graphical user interface (e.g., a graphical user interface displayed by the external device 104).

As these two states are one-dimensional states at the two ends of a spectrum, the battery pack 760 and/or power tool battery charger 702 can operate at the end points. Additionally or alternatively, a stepped, continuous, piecewise, or other intermediate set of states generally between the two end points can also be determined. For example, whereas a life-boost charging state may prioritize extended battery pack life over charging performance, and whereas a performance charging state may prioritize charging performance over extending the life of the battery pack, an intermediate set of states may include charging rate(s), charging target(s), and/or a charging schedule that balance charging performance (e.g., faster charging) and extended battery life. In these embodiments, a one-dimensional user interface conducive to a slider, level, dial, knob, etc., can be used to select the charging state for which charger operation data will be generated. As an example, a one-dimensional user interface can be used to select an intermediate charging state corresponding to charger operation data that are a weighted combination of charger operation data for a life-boost charging state and charger operation data for a performance charging state (e.g., 60% life-boost and 40% performance, meaning that the intermediate charging state is skewed slightly towards extending the life of the battery pack, but without fully compromising on charging performance).

As described above, a machine learning control, an artificial intelligence control, or another suitable control logic can be implemented (e.g., by the electronic controller 720 or electronic controller 725) to generate the charger operation data for controlling the charging action of a battery pack by a power tool battery charger.

As described above, in some embodiments, the charging state can be selected by a user via the external device 104. FIG. 11 illustrates an example graphical user interface 1180 that displays the suggested change to the battery charger use profile (e.g., the charging state and/or one or more parameters of the charger operation data). The graphical user interface 1180 is generated by the external device 104, which may be in communication with the power tool battery charger 702, the battery pack 760, the server 106, 206, 306, 406, and the network 108. The external device 104 includes an electronic processor, input/output interface (e.g., touch screen display), wireless communication circuit for the aforementioned power tool battery charger (and/or battery pack(s) or power tool(s)), server, and network communications, and a memory storing instructions that are retrieved and executed by the electronic processor to implement the functionality of the external device 104 described herein.

As shown in FIG. 11, charger operation data for charging the battery pack 760) can be based on the charging state (e.g., a life-boosting charging state, a maximum performance charging state, an auto mode). In the “auto” mode, the parameter η_{life-vs-max} may be determined using the methods described below. In some embodiments, the parameter η_{life-vs-max} can be adapted to a particular user and/or change over time (e.g., based on usage patterns in the usage data for the battery pack being charged). The charging state may also indicate other parameters such as minimum and/or maximum allowable charging rates, minimum and/or maximum preferred charging targets, preferred times of day for charging, and the like.

The electronic controller 720 then controls the charging circuit(s) 758 (e.g., in step 1010) according to the suggested change by the machine learning controller 710. For example, the electronic controller 720 controls the charging circuit(s) 758 (and, in some cases, other controllable elements) in accordance with a battery charger use profile stored in the memory 740 as modified with the suggested change in step 1010.

In some embodiments, the electronic controller 720 waits for confirmation from a user before updating a battery charger use profile in the memory 740 with the suggested changes in step 1010. For example, the external device 104 may receive input via the graphical user interface 1180 that indicates the user confirms the suggested change (e.g., via a touch input on a graphical “save” button on the graphical user interface 1180), and, in response, the external device 104 transmits a confirmation signal to the electronic controller 720 via the wireless communication device 750. Upon receipt of the confirmation signal, the electronic controller 720 stores the suggested change in a battery charger use profile in the memory 740. In some embodiments, the electronic controller 720 implements the change suggested by the machine learning controller 710 without waiting for user confirmation. In such embodiments, the external device 104 may receive and display the implemented change to inform the user that the operational parameter for the battery charger use mode has been changed.

In some embodiments, a method is provided similar to the process 1000 to generate a suggested change to a battery charger use profile, but the suggested change is based on user feedback, rather than power tool device data (e.g., sensor data) alone or in combination with user feedback. For example, the machine learning controller 710, implementing a genetic algorithm, receives a current battery charger use profile of the power tool battery charger 702 from the electronic processor 730 (e.g., including values for particular battery charger parameters) and receives user feedback after a battery charger operation. Then, the machine learning controller 710 processes the user feedback and generates an output that indicates a suggested change to the current battery charger use profile. Thereafter, the current battery charger use profile is adjusted based on the suggested change, and the one or more charging circuits 758 are operated according to the adjusted battery charger use profile.

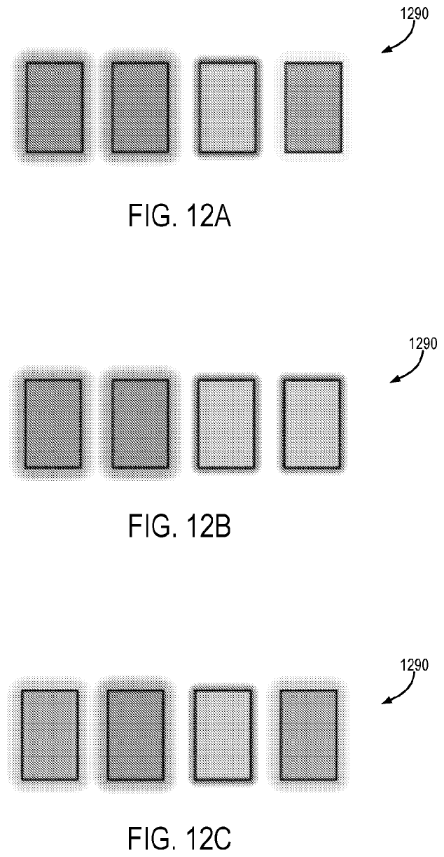

In some embodiments, the output(s) 792 of the power tool battery charger 702 and/or the output(s) 793 of the battery pack may include a charging state indicator. FIGS. 12A-12C illustrate examples of charging indicators 1290 according to different examples. The charging state can be displayed to a user using charging indicators 1290, which can be provided as icons on a graphical user interface (e.g., graphical user interface 1180), as illuminated icons and/or LEDs on the power tool battery charger 702 and/or battery pack 760, or combinations thereof.

In the battery life boost example, illustrated in FIG. 12A, the charging indicators 1290 can be filled up in a sequential fashion (e.g., from left to right) in order to communicate the rate of charging and/or the charging target. For example, a fill-up animation can be provided from left to right, with the rate at which the charging indicators 1290 are animated corresponding to, or otherwise indicating, the charging rate. Alternatively, the charging indicators 1290 may use other fill-up animations, such as pulsing, alternating, waving brighter, and the like. Again, the change in animation of the charging indicators 1290 may correspond to, or otherwise indicate, the charging rate. The last charging indicator 1290 may be set to indicate the maximum charging target. For example, the last (furthest right) charging indicator 1290 may be set to green to indicate the maximum charging target. The unreached charging indicators 1290 may be illuminated at a lesser level, and not just be turned off, in order to communicate the maximum charging target. The last charging indicator 1290 may be fully illuminated when the maximum charging target is reached.

An example of a display for a charging state that prioritizes, optimizes, or otherwise is based on performance is shown in FIG. 12B. As in the example shown in FIG. 12A, the charging state can be displayed to a user using charging indicators 1290. In this example, the charging indicators 1290 can again be animated to sequentially fill-up (e.g., from left to right), and the fill-up animation of the charging indicators 1290 can be modulated to indicate the charging rate. The unreached charging indicators 1290 may be illuminated at a lesser level, and not just be turned off, in order to communicate the maximum charging target. The last charging indicator 1290 may be fully illuminated when the maximum charging target is reached.

An example of a display for a charging state that is focused on charging a battery pack while limiting over draining the battery pack to help the life of the battery pack (e.g., an “ultra-life boost mode”) is shown in FIG. 12C. As in the examples shown in FIGS. 12A and 12B, the charging state can be displayed to a user using charging indicators 1290. In this example, the charging indicators 1290 can again be animated to sequentially fill-up (e.g., from left to right), and the fill-up animation of the charging indicators 1290 can be modulated to indicate the charging rate. The unreached charging indicators 1290 may be illuminated at a lesser level, and not just be turned off, in order to communicate the minimum and/or maximum charging targets. The last charging indicator 1290 may be fully illuminated when the maximum charging target is reached. The “lowest” charging indicator 1290 (e.g., the first charging indicator 1290) and the “highest” charging indicator 1290 (e.g., the last charging indicator 1290) can both be modulated to have a different appearance to indicate the minimal allowed charge level and the maximal allowed charge level, respectively, for the battery pack 760 when charged according to the ultra-life boost mode. For example, the first and last charging indicators 1290 may be set to green to indicate the minimum and maximum charging targets.

When the charging state of a battery pack 760 is set to this example ultra-life boost mode, the battery pack 760 can be constrained to the minimum level of charge, such that the electronic controller 725 controls the operation of the charging circuit(s) 759 to prevent discharging the battery cells 756 beyond the minimum level of charge set by the charging state (and/or charger operation data based on the charging state). Additionally or alternatively, the user can override the charging state to discharge the battery pack 760 beyond the minimum level of charge allowed by the charging state. For example, the user can allow depleting the last fraction of charge in the battery pack 760 by pushing a button on the battery pack (e.g., an input 791), commanding the power tool to continue operation (e.g., by releasing and depressing a trigger of the power tool), and/or by cycling the battery pack 760 on the power tool. The charger operation data for a determined charging state can be generated based on power tool device data, as described above. In some embodiments, the charger operation data can be based on retake time data for the battery pack to be charged. These methods are especially advantageous for battery packs and power tool battery chargers whose clock may be imprecise and/or where an internet-of-things clock (even if hardware is put in) may not be available to update to a specific time of day due to lack of regular connection.

The retake time can be defined as a time between when a battery pack reaches a charging target (e.g., a full charge, a percentage charge) and when the battery pack is taken off the power tool battery charger, a time between when a battery pack is put on a power tool battery charger and when the battery pack is taken off from the power tool battery charger, a time between when a battery pack reaches a charging target (e.g., a full charge, a percentage charge) and when the battery pack is used next on a power tool, a time between subsequent times when a battery pack is taken off a power tool battery charger (whether the same power tool battery charger or different power tool battery chargers), a time between subsequent times when a battery pack is put on a power tool battery charger (whether the same power tool battery charger or different power tool battery chargers), and the like.

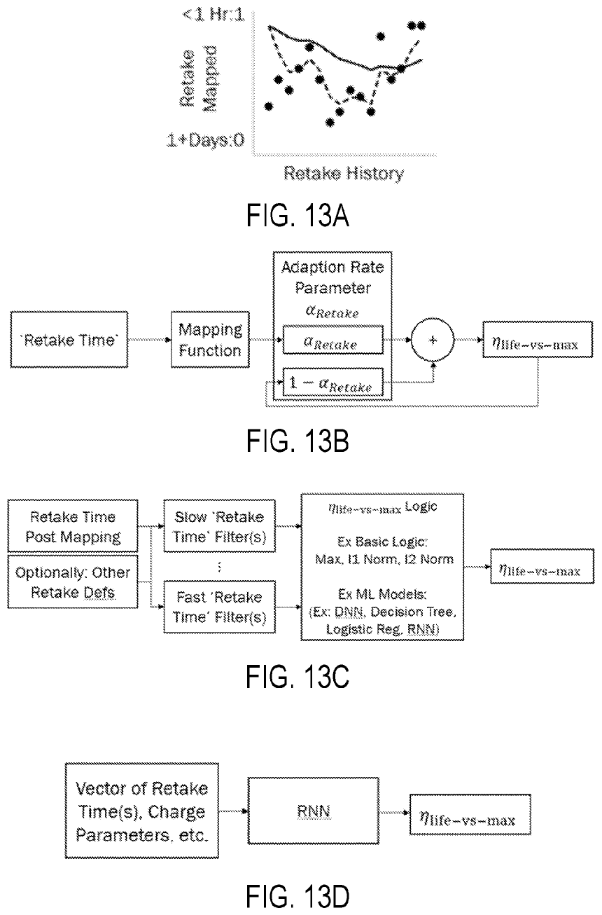

In some embodiments, a mapping function can be defined or otherwise constructed to map the retake time to a parameterized value (e.g., values in the range of [0, 1], values in the range of [−1,1]). An example of retake time data mapped to values of η_{life-vs-max} is illustrated in FIG. 13A. The mapping function may use a piecewise mapping, a stepped mapping, or the like. Alternatively, the mapping function may be constructed to distinguish short durations (e.g., less than a few hours) to longer durations (e.g., multiple days). As noted above, in some embodiments the retake time can be potentially mapped to negative values, such as when a battery pack is taken off a power tool battery charger before the battery pack has been fully charged, or otherwise charged to a set charging target. The mapping function may vary depending on battery chemistries and configurations.

In some embodiments, the charger operation data may include, for example, at least two charging rates, which may be two discrete charging rates such as a maximum charging rate and a lower charging rate. Alternatively, the charger operation data can include any number of different charging rates.

The mapping function can be constructed based on the charger operation data, which may be a continuous mapping function or a piecewise mapping function, stepped mapping function, parametric mapping function, and the like. For example, the machine learning controller 710, 715 (or electronic processor 730, 735) can construct the mapping function based on power tool device data (e.g., usage data including retake time data) received from the battery pack 760, other battery pack(s), power tool battery charger 702, other power tool battery charger(s), one or more power tools, and/or other power tool devices.

As one example, in the following equation, the parameter η_{life-vs-max} that varies from 0 to 1 allows for moving between two charging rates. The parameters Γₘᵢₙ and Γₘₐₓ can be minimum and maximum charging rates included in the charging operation data (e.g., charging operation data provided by the battery pack or generated by the power tool battery charger, such as based on power tool device data received from the battery pack).

$${Γ}_{chargingTarget} = {Γ}_{min} + ( {Γ}_{max} - {Γ}_{min} ) \cdot {η}_{life - vs - max} ; \qquad ( 1 )$$

In other embodiments the electronic processor 730 of the power tool battery charger 702 receives a determined charging rate from the battery pack 760 by providing a to the electronic processor 735 of the battery pack 760, which estimates parameter η_{life-vs-max} or otherwise computes a charging rate based on the parameter, or retrieves an already estimated charging rate from the memory 745 based on the parameter, and then the battery pack 760 responds to the power tool battery charger 702 with the determined charging rate, Γ. In some cases, the maximum charging target may always be a set value (e.g., 100% or some other percent charge capacity) and only the charging rate is varied. In other cases, the maximum charging target can also be varied, as described in the present disclosure.

The minimum and maximum charging rates, Γₘᵢₙ and Γₘₐₓ, may also be a function of other parameters, such as the current state of charge and any other factors (e.g., time of day, temperature, allowable battery charging parameters, etc.). Thus, as described, in some instances the charger operation data can be generated by the battery pack 760 (e.g., using electronic processor 735 and/or machine learning controller 715) or the power tool battery charger 702 (e.g., using electronic processor 730 and/or machine learning controller 710) based on power tool device data received from the battery pack 760, the power tool battery charger 702, or another power tool device (e.g., another battery pack, another power tool battery charger, one or more power tools).

As described above charger operation data can be generated by the electronic processor 730 of the power tool battery charger 702 (or other power tool battery charger, such as a power tool battery charger without a machine learning controller 710), the electronic processor 735 of the battery pack 760 (or other battery pack, such as a battery pack without a machine learning controller 715), the machine learning controller 710, the machine learning controller 715, and/or an artificial intelligence controller implemented by a power tool battery charger and/or battery pack. The charger operation data may be generated based on a determined charging state, which in some instances may be a user-selected charging state, or an automatically determined charging data (e.g., determined by the electronic processor 730, electronic processor 735, machine learning controller 710, machine learning controller 715, and/or artificial intelligence controller based on power tool device data). The charger operation data may be generated based on power tool device data collected from a battery pack (e.g., the battery pack to be charged), a power tool battery charger (e.g., the power tool battery charger being used to charge the battery pack), one or more power tools (e.g., one or more power tools on which the battery pack has been or will be used), and other power tool devices, including other battery packs and power tool battery chargers.

In some embodiments, the charger operation data can be generated based on retake time data for the battery pack to be charged.

As one example, the charger operation data can be generated using an adaptive model, such as an adaptive regression model, as illustrated in FIG. 13B. In this example logic, an adaptation rate parameter, αᵣₑₜₐₖₑ, is implemented to iteratively adapt a mapping function, which in some examples may be based on a regression model. The mapping function can account for the current state of η_{life-vs-max}, allowing for various regression techniques. The adaptation rate can be a small value (e.g., 0.05) for a gradual learning rate. Other adaption schemes can alternatively be implemented.

As an example, a ramp function could be used as the mapping function. The adaptation rate may be selected to fall slower than rise, so there may be two values of αᵣₑₜₐₖₑ which may, for example, be biased towards increasing charging performance.

In the illustrated embodiments, a mapping function can be constructed or otherwise estimated based on the retake time data. An adaptation rate parameter can then be determined and used to iteratively adapt the mapping function (e.g., based on a trial-by-trial adaptation, or the like). The determined value for η_{life-vs-max} can then be used to estimate the charging rate, such as by using Eqn. (1) in addition to power tool device data, which may indicate values for the minimum and maximum charging rates.

As another example, the charger operation data can be generated based on filtering, segmenting, or otherwise grouping the retake time data into two or more sets of retake time data, as illustrated in FIG. 13C. For example, the retake time data can be filtered or otherwise grouped into a first retake time data set corresponding to “slow” retake times and a second retake time data set corresponding to “fast” retake times. In other examples, the retake time data can be filtered or otherwise grouped into more than two different retake time data sets corresponding to retake times satisfying different criteria or definitions. Additionally or alternatively, the retake time data may already include two or more different retake time data sets (e.g., the electronic processor 730 of the power tool battery charger 702, the electronic processor 735 of the battery pack 760, the machine learning controller 710, the machine learning controller 715, and/or artificial intelligence controller can generate or otherwise determine retake time data as including the two or more different retake time data sets).

In this example logic, an efficient memory methodology with more time history can be used. In the illustrated embodiments, only two filters are shown as being used, but in alternative embodiments any number of filters can be employed. For example, multiple different retake times based on different definitions can be measured and used as an input.

The value for η_{life-vs-max} can be determined based on the two or more retake time data sets using various techniques. As one example, a metaheuristic algorithm and/or model can be used. For example, an optimization technique based on optimizing an objective function over the two or more retake time data sets can be implemented. The objective function may include a maximum norm, an L1-norm, and L2-norm, or other suitable vector norms. In other examples, a machine learning program, model, and/or algorithm can be used to estimate or otherwise determine the value for η_{life-vs-max} by inputting the two or more retake time data sets, generating output as an estimated value for η_{life-vs-max}. In some embodiments, the machine learning program, model, and/or algorithm can implement any one of a various types of machine learning, such as a deep neural network, a decision tree, a logistic regression, and/or a recurrent neural network. The determined value for η_{life-vs-max} can then be used to estimate the charging rate, such as by using Eqn. (1) in addition to the minimum and maximum charging rates, which may be determined from or otherwise based on power tool device data.

As yet another example, the charger operation data can be generated using a machine learning control logic, as illustrated in FIG. 13D. For example, a recurrent neural network can be implemented. A recurrent neural network keeps a state history of when charging performance is valued over battery life. The retake time data and other power tool device data (e.g., other usage data, charging parameters, charging parameters such as minimum and maximum allowable charging rates) are input to the recurrent neural network, generating output as an estimated value for η_{life-vs-max}. The determined value for η_{life-vs-max} can then be used to estimate the charging rate, such as by using Eqn. (1) in addition to power tool device data, which may indicate values for the minimum and maximum charging rates.

The foregoing control logic examples can be implemented as machine learning programs, algorithms, and/or models: artificial intelligence programs, algorithms, and/or models: or other suitable programs or controls executed upon by an electronic processor (e.g., electronic processor 730 of the power tool battery charger 702 or other suitable power tool battery charger, electronic processor 735 of the battery pack 760 or other suitable battery pack), a machine learning controller (e.g., machine learning controller 710 of the power tool battery charger 702, machine learning controller 715 of the battery pack 760), an artificial intelligence controller (e.g., an artificial intelligence controller implemented by a power tool battery charger, an artificial intelligence controller implemented by a battery pack), and the like. For example, the foregoing control logic examples can be implemented in step 1006 of process 1000 to generate charger operation data including charging rates (e.g., using the electronic controller 735, machine learning controller 715, and/or artificial intelligence controller of the battery pack 760 or another suitable battery pack). Additionally or alternatively, the foregoing control logic examples can be implemented in step 908 of process 900 to generate charger operation data including charging rates (e.g., using the electronic controller 730, machine learning controller 710, and/or artificial intelligence controller of the power tool battery charger 702 or another suitable power tool battery charger). In some other embodiments, the control logic examples can be executed on a server (e.g., server 106, 206, 306, 406) and/or external device 104, and the generated charger operation data can be communicated to the power tool battery charger and/or battery pack via the network 108 or other wireless or wired communication.

As described above, the charger operation data can include charging rate(s) and charging target(s) in addition to one or more charging schedules that include time indications that define when to adjust between different charging rates and/or charging targets. Furthermore, to convert charging parameters into the actual rate at which to charge a battery pack, it can be advantageous to determine or otherwise estimate the working hours for the battery pack, the type of battery pack, multiple battery packs, a user, a jobsite, one or more power tools, one or more power tool battery chargers, and the like. Thus, in some embodiments, usage data can also include a measure or estimate of working hours for a power tool device, such as a power tool battery charger, a battery pack, and/or a power tool. For example, because the life of a battery pack 760 can be improved by charging slower when the battery pack is less likely to be used (e.g., at night), it can be advantageous to measure, estimate, or otherwise determine the working hours for a battery pack. In some instances, the working hours for a battery pack can be a user selected parameter (e.g., via an app or other user interface). In some other instances, the working hours for a battery pack can be determined automatically, which can balance convenience for the user with practicality.

The working hours can indicate one or more ranges or sets of hours that a power tool device (e.g., a battery pack) are frequently or most likely to be used. The working hours may be a discrete set of hours, or a continuous (or near continuous) range of hours. The binning of work hours may be replaced with other increments other than hours (e.g., minutes), or may be raw data with near continuous time increments. In some embodiments, a buffer can be added before and after a set of working hour ranges. For example, a kernel can be run over a histogram of working hours so as to smooth and spread the distribution of working hours. Working hours may be stored as a range or a parameter based on time. In some embodiments, the stored working hours for a power tool device can be forgotten and/or deprioritized (e.g., weighted differently) with age. Old working hours data can be forgotten or deprioritized in various ways, such as based on a first in, first out (“FIFO”) methodology, a random decrement, and the like.

A different set of working hours can be defined for each day of the week, for weekdays versus weekend days, or other combinations of days of the week. Alternatively, the same working hours can be defined for each day of the week. Additionally or alternatively, different sets of working hours can be defined based on other time scales (e.g., weeks in a month or year, months in a year, seasons). For example, if the usage data for a battery pack indicate that the battery pack is routinely used on an outdoor power tool (e.g., a string trimmer) in a cool-weather climate, then the working hours for the battery pack may include a first set of working hours corresponding to the days, weeks, and/or months when the outdoor power tool would be in frequent use (e.g., the summer), and may include a second set of working hours corresponding to the days, weeks, and/or months when the outdoor power tool would be in less frequent use (e.g., early spring and/or late fall) or not in use at all (e.g., the winter). Multiple sets of such seasonal working hours could be stored for a particular battery pack.

When the usage data do not indicate that a battery pack has been put on and taken off a battery charger a sufficient number times to determine working hours for that battery pack, then the working hours for that battery pack may default to a specified set of working hours. For example, the working hours could be set to a default that all hours of the day (whether specific days of the week or all days of the week) are working hours. As another example, the working hours could be set to a default that specific hours (e.g., 6 AM to 6 PM) are working hours on one or more days of the week. In still other examples, one or more default sets of working hours could be weighted based on the number of previous takes off a power tool battery charger for the battery pack. A battery pack may also reset to a default set of working hours if it is left in a discharged state (e.g., fully discharged, partially discharged below a percent threshold such as 20% or the like) for too long. Additionally or alternatively, the usage data for a battery pack can be set to include default working hours after manufacturing and before it is first used.

In some other embodiments, the working hours can be determined based on usage statistics of the battery pack, which may be contained in the other usage data for the battery pack. For example, if the normalized standard deviation of the count of takes off a power tool battery charger (i.e., the number of times a battery pack has been taken off a power tool battery charger) is not above a specified threshold, then the working hours for the battery pack can be cleared, or the usage data for the battery pack can otherwise indicate that working hours should not be used for the particular battery pack until the threshold criterion is satisfied.

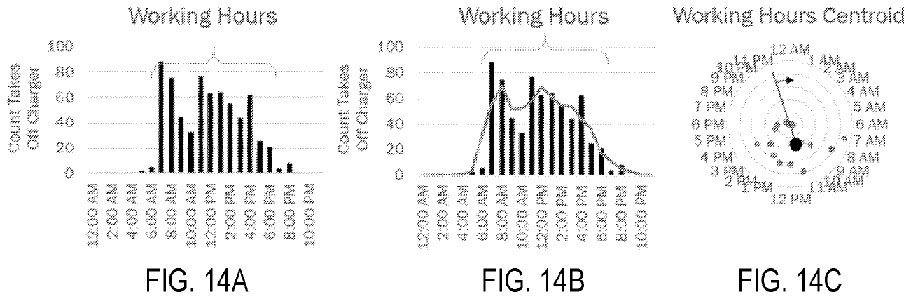

As one example, working hours for a battery pack can be defined as those hours having at least some percentage (e.g., 2%, 5%, and the like) of takes off a power tool battery charger. As another example, working hours for a battery pack can be selected from 12 hours opposite the mean hour on a 24-hour clock (e.g., based on the 5% and 95% percentile), as illustrated in FIG. 14A. As noted above, in some embodiments a set of working hours can be smoothed with a smoothing function, optionally with scaling and/or transformation, to derive a function of a measure of how much each hour is a working hour, as illustrated in FIG. 14B. In still other examples, the working hours for a battery pack can be selected from 12 hours opposite a centroid hour of a polar histogram of a 24-hour clock (e.g., based on the 5% and 95% percentiles), as illustrated in FIG. 14C. This latter example may be advantageous for different working shifts, such as a nightshift.

In some embodiments, the working hours for a power tool device (e.g., a power tool battery charger, battery pack, and/or power tool) can be determined using a server (e.g., server 106, 206, 306, 406), an external device 104, and/or an electronic processor (e.g. electronic processor 730, electronic processor 735), machine learning controller (e.g., machine learning controller 710, machine learning controller 715), or artificial intelligence controller.

The charging target for a battery pack 760 can characterize the Joules, amp-hours, Coulombs, percent of full charge, and/or voltage level needed for the battery pack 760. As described above, the charging target can be estimated, calculated, or otherwise determined based on power tool device data.

In some embodiments, the charging target, γ_{chargingTarget} can be based on usage data indicating whether the battery pack 760 (or another battery pack without a machine learning controller) is being put on a power tool battery charger (e.g., power tool battery charger 702 or another power tool battery charger without a machine learning controller) before a full discharge. In these instances, there may be a risk that a user may want to place a low voltage battery pack on a power tool battery charger early if the power output of the battery pack falls too low for performance reasons (e.g., too low to perform a desired tool application use). As such, the charging target, γ_{chargingTarget}, may be based, at least in part, on whether the battery pack can last in use longer than a full workday, assuming a user recharges the battery pack daily. This information about the battery pack use can be stored as usage data for the battery pack, or can otherwise be inferred, estimated, or derived from the usage data or other power tool device data (e.g., using a machine learning controller, such as machine learning controller 710 or machine learning controller 715).

Furthermore, γ_{chargingTarget} can be based on how much time the battery pack is left at full charge, which can damage the battery cells in the battery pack (e.g., battery cells 756 in battery pack 760). As such, the percent or duration of time left at full charge may be a meaningful input and can be collected and stored as usage data.

Some users tend to charge their battery packs at certain times of the day (e.g., in the morning). This information can be stored as usage data for the battery pack, or can otherwise be inferred, estimated, or derived from the usage data or other power tool device data (e.g., using a machine learning controller, such as machine learning controller 710 or machine learning controller 715).

More complex logic can account for, might ignore, or may use different logic if the battery pack is put back on a power tool battery charger 702 after a thermal threshold is tripped before a complete discharge, which may be stored as power tool device data (e.g., sensor data for the battery pack).

In some embodiments, the charging target can be biased, or otherwise initiated, as a value of γ_{chargingTarget}=1 for maximum performance, and can then be adjusted based on one or more control logics, such as those described below.

As one example, charger operation data including the charging target can be generated using a rules-based adaptation methodology, as illustrated in FIG. 15A. In this example logic, an adaptation rate parameter, α_{chargeTarget}, is implemented to iteratively adapt the value for the charge target, γ_{chargeTarget} The initial adaptation rate and/or charging target can be set based on one or more rules. For example, if one or more conditions are met, then the charging target can be set to an initial value. As an example, if the following three conditions are met for a battery pack, then the initial value for the charging target can be set to zero, else the initial value for the charging target can be set to one (i.e., indicating the charging performance should be maximized):

| | |
|---|---|
| Condition 1: | If the working hours data indicate that the battery |
| | pack can be fully charged before the battery pack |
| | is most likely needed again |
| Condition 2: | If the usage data of the battery pack indicate that |
| | the battery pack is rarely charged more than once |
| | per day |
| Condition 3: | If the usage data of the battery pack indicate that |
| | the battery pack is rarely put on the power tool |
| | battery charger before the end of the day and/or |
| | before a full discharge |

As one example, charger operation data including the charging target can be generated using a table-based adaptation methodology, as illustrated in FIG. 15B. In this example logic, incremental adaption of the charging target is achieved using a table based on usage data, such a percent into the workday when the battery pack is put on a power tool battery charger, and the percent of discharge of the battery pack when the battery pack is put on the power tool battery charger. The table-based adaptation can also be based on other usage data and/or power tool device data. In the illustrated embodiment, the charging target can be decreased if the usage data indicate that the battery pack is discharged less than 50% (e.g., the battery pack has at least 50% charge remaining) and the usage data indicate that the battery pack was put on the power tool battery charger less than 25% into a workday and/or more than 75% into a workday. As another example, in the illustrated embodiment, the charging target can be increased if the usage data indicate that the battery pack is greater than 75% discharged when placed on the power tool battery charger, or some combination of being nearly discharged (e.g., greater than 50% discharged) and the battery pack being placed on the power tool battery charger at a time of day when sufficient charging can still be achieved within the workday (e.g., the second quartile of the workday).

As one example, charger operation data including the charging target can be generated using an age-based adaptation methodology, as illustrated in FIG. 15C. In some embodiments, the age-based adaptation may be a warranty-based adaptation that is based on a warranty of the battery pack. In this example logic, the charging target can be determined based on the age of the battery pack and the total number of charging cycles the battery pack has been through, both of which may be stored as power tool device data of the battery pack, such as usage data. In the illustrated embodiment, when the usage data indicate that the battery pack is in a heavy-use region based on the number of charge cycles and the age of the battery pack (e.g., when the number of charging cycles is high for the age of the battery pack), then the charging target can be set to prioritize life of the battery pack (e.g., initiated at a value of zero). Similarly, when the usage data indicate that the battery pack is in a storage-use region based on the number of charge cycles and the age of the battery pack (e.g., when the number of charging cycles is low for the age of the battery pack), then the charging target can be set to prioritize life of the battery pack (e.g., initiated at a value of zero). However, when the usage data indicate that the battery pack is in a medium-use region based on the number of charge cycles and the age of the battery pack (e.g., when the number of charging cycles is within an expected range for the age of the battery pack), then the charging target can be set to prioritize charging performance of the battery pack (e.g., initiated at a value of one).

As yet another example, the charger operation data, including charging target, can be generated using a machine learning control logic, as illustrated in FIG. 15D. For example, a recurrent neural network can be implemented. Retake time data, charge parameters, the time of day, and other such data can be input to the recurrent neural network. Additionally or alternatively, other power tool device data can also be input to the recurrent neural network, and may be assembled or otherwise structured in a vector format, for example. In some embodiments, a recurrent neural network can be configured to output both η_{life-vs-max} as described above in addition to γ_{chargeTarget}.

The foregoing control logic examples can be implemented as machine learning programs, algorithms, and/or models: artificial intelligence programs, algorithms, and/or models: or other suitable programs or controls executed upon by an electronic processor (e.g., electronic processor 730 of the power tool battery charger 702 or other suitable power tool battery charger, electronic processor 735 of the battery pack 760 or other suitable battery pack), a machine learning controller (e.g., machine learning controller 710 of the power tool battery charger 702, machine learning controller 715 of the battery pack 760), an artificial intelligence controller (e.g., an artificial intelligence controller implemented by a power tool battery charger, an artificial intelligence controller implemented by a battery pack), and the like. For example, the foregoing control logic examples can be implemented in step 1006 of process 1000 to generate charger operation data including charging targets and/or charging rates (e.g., using the electronic controller 735, machine learning controller 715, and/or artificial intelligence controller of the battery pack 760 or another suitable battery pack). Additionally or alternatively, the foregoing control logic examples can be implemented in step 908 of process 900 to generate charger operation data including charging targets and/or charging rates (e.g., using the electronic controller 730, machine learning controller 710, and/or artificial intelligence controller of the power tool battery charger 702 or another suitable power tool battery charger). In some other embodiments, the control logic examples can be executed on a server (e.g., server 106, 206, 306, 406) and/or external device 104, and the generated charger operation data can be communicated to the power tool battery charger and/or battery pack via the network 108 or other wireless or wired communication.

In some embodiments, it may be desirable to more independently configure the charging target and the charging rate than can be achieved with a one-dimensional charging state methodology. For example, if a user wanted to make it through a day on one battery charge, the user may want a charging target that prioritizes, or is otherwise based on, maximizing, optimizing, or otherwise increasing performance, but using a charging rate (or charging rates time to a charging schedule) that prioritizes, or is otherwise based on maximizing, optimizing, or otherwise increasing the life of the battery pack. In these embodiments, the charger operation data can be generated based on a multidimensional charging state methodology.

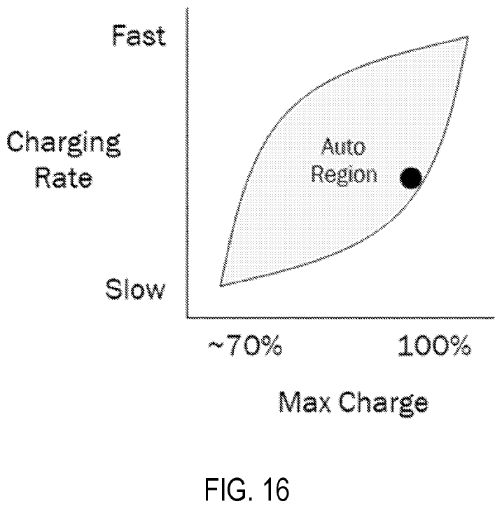

FIG. 16 illustrates an example parameterization that can be implemented for a two-dimensional charging state methodology. In the illustrated example, an “auto” mode setting is used to determine charger operation data based on a two-dimensional analysis of both charging target and charging rates. Although a two-dimensional charging state can be viewed as independent axes, it can also be modeled as a more complex charging rate function. For example, the following charging rate function may be utilized for a two-dimensional charging state methodology:

$${Γ}_{chargingRate} = H ( {γ}_{chargingTarget} - γ ) \cdot ( {Γ}_{min} + ( {Γ}_{max} - {Γ}_{min} ) \cdot {η}_{life - vs - max} )$$

where H ( . . . ) is a step function or other suitable function and γ is the current charge of the battery pack. This charging rate, Γ_{chargingRate}, can be used to set the maximum charge of the battery. While a two-dimensional charging methodology state may address most of a user's needs, even higher dimensional states can also be implemented to allow for even more customization, such as by accounting for multiple different variables or data.

In addition to charging target and charging rate data, a multidimensional charging state methodology can be based on other types of power tool device data, including other usage data (e.g., other usage data of the battery pack 760, usage data of the power tool battery charger 702, usage data of another power tool battery charger, and/or usage data of one or more power tools), maintenance data (e.g., maintenance data of the battery pack 760, power tool battery charger 702, and/or one or more power tools), feedback data, power source data, sensor data (e.g., sensor data of the battery pack 760, power tool battery charger 702, another power tool battery charger, and/or one or more power tools), environmental data, operator data, location data, and the like. For example, the multidimensional charging state methodology may be based on other power tool device data such as operational data of the battery pack 760, including data indicating the battery chemistry of the battery pack 760; the total capacity of the battery pack 760 (e.g., the ampere hour rating of the battery pack 760): the estimated, expected, and/or measured capacity of the battery pack 760; and/or the remaining charge level of the battery pack 760. The multidimensional state methodology may additionally or alternatively be based on other power tool device data of the battery pack 760, such as usage data indicating whether one or more users has entered a jobsite: usage data and/or sensor data indicating that the battery pack is moving or otherwise making its way to a jobsite (e.g., moving in a vehicle, moving between floors on a skyscraper under construction); usage data and/or location data indicating whether other battery packs are available; environmental data indicative of the weather; usage data indicating whether the battery pack 760 is under warranty: usage data indicating a cycle count for the battery pack 760; among other data.

In some embodiments, the multidimensional charging state methodology can be implemented based on machine learning programs, algorithms, and/or models: artificial intelligence programs, algorithms, and/or models; or other suitable programs or controls executed upon by an electronic processor (e.g., electronic processor 730 of the power tool battery charger 702 or other suitable power tool battery charger, electronic processor 735 of the battery pack 760 or other suitable battery pack), a machine learning controller (e.g., machine learning controller 710 of the power tool battery charger 702, machine learning controller 715 of the battery pack 760), an artificial intelligence controller (e.g., an artificial intelligence controller implemented by a power tool battery charger, an artificial intelligence controller implemented by a battery pack), and the like. For example, a multidimensional charging state methodology can be implemented in step 1006 of process 1000 to generate charger operation data including charging targets and/or charging rates (e.g., using the electronic controller 735, machine learning controller 715, and/or artificial intelligence controller of the battery pack 760 or another suitable battery pack). Additionally or alternatively, a multidimensional charging state methodology can be implemented in step 908 of process 900 to generate charger operation data including charging targets and/or charging rates (e.g., using the electronic controller 730, machine learning controller 710, and/or artificial intelligence controller of the power tool battery charger 702 or another suitable power tool battery charger). In some other embodiments, the multidimensional charging state methodology can also be executed on a server (e.g., server 106, 206, 306, 406) and/or external device 104, and the generated charger operation data can be communicated to the power tool battery charger and/or battery pack via the network 108 or other wireless or wired communication.

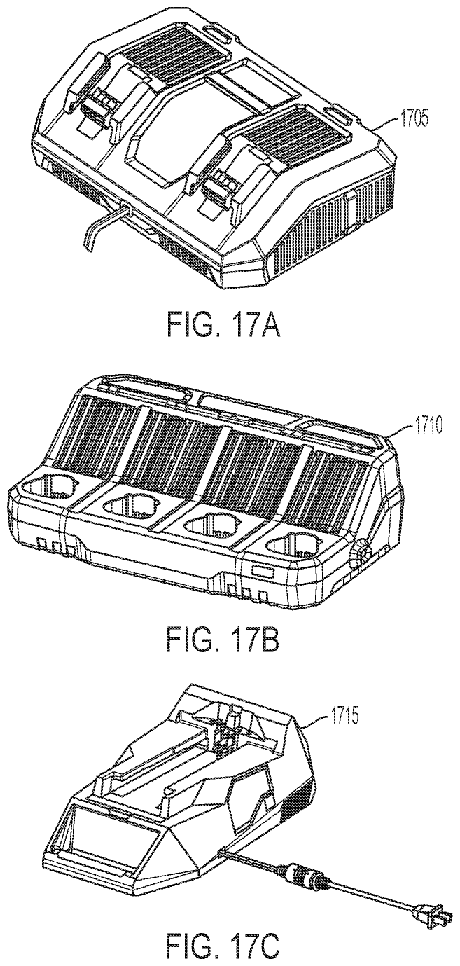

The power tool battery pack(s) 660, 760 and power tool battery charger(s) 102, 202, 302, 402, 502, 702 described herein are just some examples of such packs and chargers. In some embodiments, the power tool battery charger(s) 202, 302, 402, 502, 702 have another configuration. For example, the power tool battery charger(s) 202, 302, 402, 502, 702 may have additional or fewer charging docks, may have a different electrical and/or mechanical interface for interfacing with a power tool battery pack, and/or may be configured to charge a different type (or combinations of types) of power tool battery packs (e.g., having different capacities or nominal voltage levels). For example, FIGS. 17A-17C illustrate three further examples of power tool battery chargers 1705, 1710, and 1715. Each of the power tool battery pack chargers 1705, 1710, and 1715 may perform the functionality of the power tool battery charger(s) 202, 302, 402, 502, 702 above. For example, one or more of the chargers 1705, 1710, and 1715 may be configured to implement the process 800 of FIG. 8, the process 900 of FIG. 9, and/or the process 1000 of FIG. 10. Additionally, at least in some embodiments, the diagram(s) of the power tool battery charger(s) 702 of FIG. 7A similarly applies to the chargers 1705, 1710, and 1715.

The power tool battery chargers 102, 202, 302, 402, 502, 702 and 1705, 1710, and 1715 may include standalone power tool battery chargers, as shown in the illustrated embodiments. In some other configurations, the power tool battery chargers 102, 202, 302, 402, 502, 702 and 1705, 1710, and 1715 may be integrated in a power source, integrated in a power tool, integrated in a light, and/or integrated into another peripheral device or equipment.

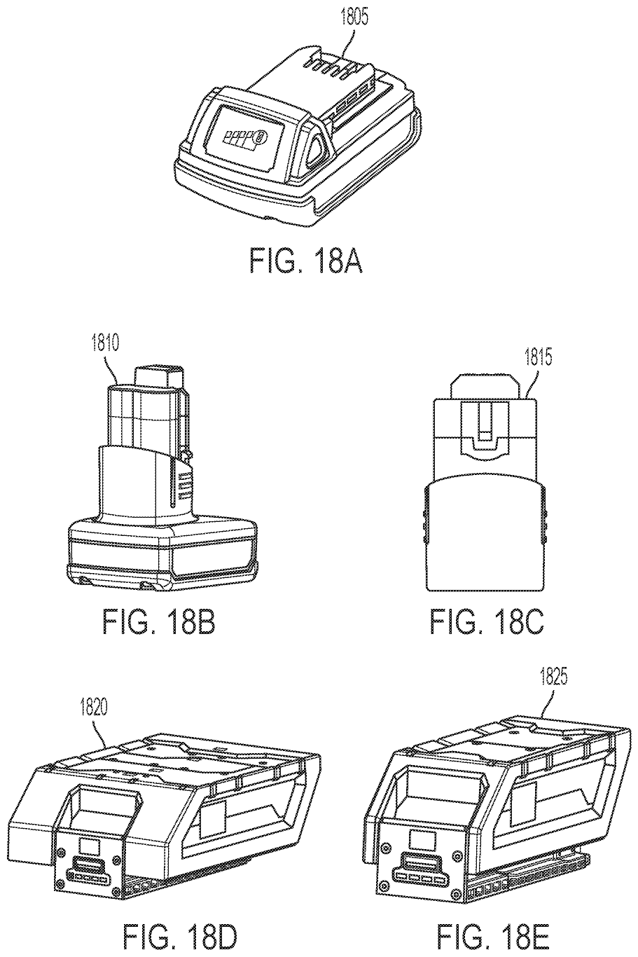

Similarly, in some embodiments, the power tool battery pack(s) 660, 760 have another configuration. For example, the power tool battery pack(s) 660, 760 may have a different electrical and/or mechanical interface for interfacing with power tools and/or power tool battery pack chargers and/or may be configured to be charged by a different type of power tool battery chargers (e.g., one or more of the chargers 1705, 1710, 1715), may have a different capacity, and/or may have a different nominal voltage level. For example, FIGS. 18A-18E illustrate five further examples of power tool battery packs 1805, 1810, 1815, 1820, and 1825. Each of the power tool battery packs 1805, 1810, 1815, 1820, and 1825 may perform the functionality of the power tool battery pack(s) 660, 760 above. For example, one or more of the packs 1805, 1810, 1815, 1820, and 1825 may be configured to transmit and/or receive power tool device data as described above.

FIGS. 17A-17C respectively illustrate the power tool battery pack chargers 1705, 1710, and 1715. As illustrated, the charger 1705 includes two charging docks, the charger 1710 includes four charging docks, and the charger 1715 includes one charging dock. Each charging dock is configured to receive and provide charging current to one power tool battery pack at a time. To receive a power tool battery pack, the charging dock may electrically and mechanically interface with the power tool battery pack. Accordingly, each of the chargers 1705, 1710, and 1715 is configured to electrically and mechanically interface with a power tool battery pack via each respective charging dock. Electrically interfacing may include electrical terminals of the pack and a charger (e.g., one of the respective chargers 1705, 1710, and 1715) contacting one another, may include a wireless connection for wireless power transfer (e.g., between inductive or capacitive elements of the pack and the charger), or a combination thereof. Mechanical interfacing may include the battery pack being received in a receptacle of a charger (e.g., one of the respective chargers 1705, 1710, and 1715), a mating of physical retention structures of the pack and the charger, or a combination thereof. In some examples, the charger 1705 includes fewer or additional charging docks. In some examples, the charger 1710 includes fewer or additional charging docks. In some examples, the charger 1715 includes fewer or additional charging docks. In some examples, the power tool battery pack charger 1705 is configured to receive and charge power tool battery packs (e.g., battery packs 660) and 1805) having a nominal voltage of approximately 18 volts, a nominal voltage between 16 volts and 22 volts, or another amount. In some examples, the power tool battery pack charger 1710 is configured to receive and charge power tool battery packs (e.g., battery packs 1810 and 1815) having a nominal voltage of approximately 12 volts, a nominal voltage between 8 volts and 16 volts, or another amount. In some examples, the power tool battery pack charger 1715 is configured to receive and charge power tool battery packs (e.g., battery packs 1815 and 1820) having a nominal voltage of approximately 72 volts, a nominal voltage between 60 volts and 90 volts, or another amount. Accordingly, at least in some embodiments, the charger 1715 is generally configured to charge battery packs having a higher nominal voltage than the packs charged by the chargers 1710 and 1705, and the charger 1705 is generally configured to charge battery packs having a higher nominal voltage than the packs charged by the charger 1710.

FIGS. 18A-18E respectively illustrate the power tool battery packs 1805-1825. Each battery pack 1805-1825 is configured to be received and charged by a power tool battery charger (e.g., one of the chargers 1705, 1710, and 1715). Each pack 1805-1825 is further configured to be received by, and to provide power to, a power tool. To be received by a charger or power tool, each battery pack 1805-1825 may electrically and mechanically interface with the charger and (at a different time) with a power tool. In some examples, the power tool battery packs 1805 (and the battery pack 660 illustrated in FIG. 6, the battery pack 760 illustrated in FIG. 7C) have a first nominal voltage of approximately 18 volts, of between 16 volts and 22 volts, or another amount. In some examples, the battery pack 660 illustrated in FIG. 6 has a larger capacity than the pack 1805, generally providing a longer run time than the pack 1805 when operating under similar circumstances. To achieve additional capacity, the battery pack 660 illustrated in FIG. 6 may include an additional set of battery cells relative to the pack 1805. For example, the pack 1805 may include a set of series-connected battery cells, while the battery pack 660 illustrated in FIG. 6 may include two or more sets of series-connected battery cells, with each set being connected in parallel to the other set(s) of cells.

In some examples, the power tool battery packs 1810 and 1815 have a second nominal voltage of approximately 12 volts, of between 8 volts and 16 volts, or another amount. In some examples, the power tool battery pack 1810 has a larger capacity than the pack 1815, generally providing a longer run time than the pack 1815 when operating under similar circumstances. To achieve additional capacity, the pack 1810 may include an additional set of battery cells relative to the pack 1815. For example, the pack 1815 may include a set of series-connected battery cells, while the battery pack 1810 may include two or more sets of series-connected battery cells, with each set being connected in parallel to the other set(s) of cells.

In some examples, the power tool battery packs 1820 and 1825 have a third nominal voltage of approximately 72 volts, of between 60 volts and 90 volts, or another amount. In some examples, the power tool battery pack 1820 has a larger capacity than the pack 1825, generally providing a longer run time than the pack 1825 when operating under similar circumstances. To achieve additional capacity, the pack 1820 may include an additional set of battery cells relative to the pack 1825. For example, the pack 1825 may include a set of series-connected battery cells, while the battery pack 1820 may include two or more sets of series-connected battery cells, with each set being connected in parallel to the other set(s) of cells.

Accordingly, at least in some embodiments, the packs 1820 and 1825 have a higher nominal voltage than the packs 1805, 1810, and 1815, and the pack 1805 has a higher nominal voltage than the packs 1810 and 1815.

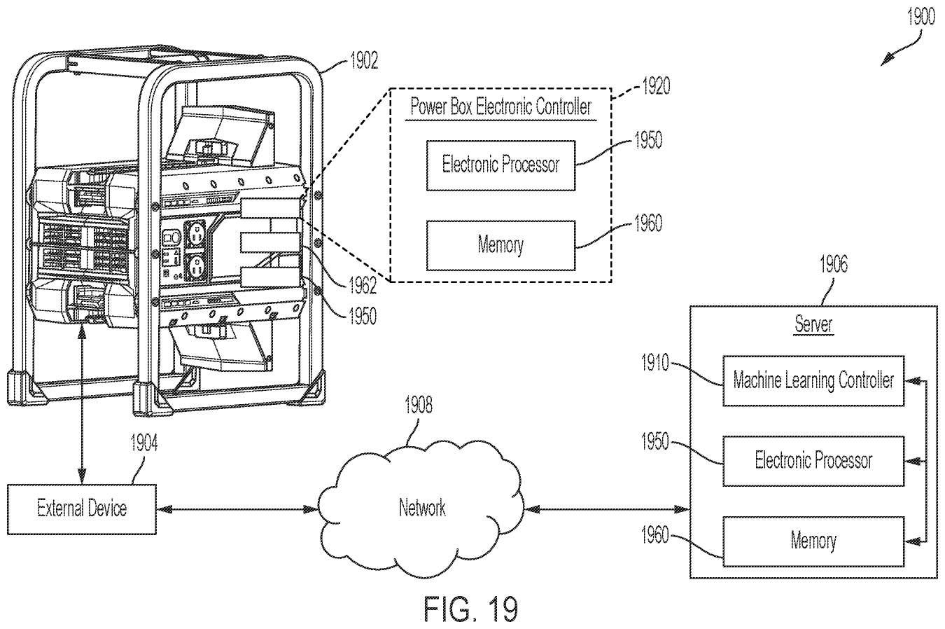

In some embodiments, the power tool battery charger 702 can be implemented as a portable power system. FIG. 19 is a diagram of an example power system 1900. The power system 1900 includes a power box 1902 and a server 1906. The power box 1902 communicates with the server 1906 over the network 1908. As discussed above with the power tool battery charger systems of FIGS. 1-4A, in some embodiments, an external device 104 may bridge the communication between the power box 1902 and the server 1906. The external device 104 may, for example, communicate directly with the power box 1902 via a Bluetooth® connection and communicate with the server 1906 via the network 1908. The power box 1902 receives power from an external source such as, for example, an AC source, a generator, a battery, or the like. Additionally or alternatively, the power box 1902 may have an internal power source such as, for example, an internal battery, a non-removable battery, one or more super capacitors, integral power, etc. Lamb]. In some cases, the internal power source may be modular, such that users can add or remove more energy storage. The power box 1902 then distributes the received power to power tools, power tool battery chargers, battery packs, or other power tool devices or peripheral devices that are connected to the power box 1902. As shown in FIG. 19, the power box 1902 may be connected to a plurality of different power tools, power tool battery chargers, or the like, and may include one or more power tool battery chargers integral with the power box 1902. The power box 1902 also includes an electronic controller 1920 (similar to electronic controller 720 of FIG. 7A), a plurality of sensors 1962, and a wireless communication device 1950. The sensors 1962 may be coupled to, for example, each of the power outputs of the power box 1902 to detect various power characteristics of each power output of the power box 1902. For example, the sensors 1962 include current sensors, voltage sensors, a real time clock, and the like.

The sensors 1962 transmit output signals indicative of sensed characteristics to the electronic controller 1920 of the power box 1902. The electronic controller 1920 transmits at least a portion of the sensor output signals to the server 1906 via, for example, a transceiver of the wireless communication device 1950. The server 1906 includes the machine learning controller 1910. In the illustrated embodiment, the machine learning controller 1910 (similar machine learning controller 110 of FIG. 1) is configured to analyze the sensor output signals from the power box 1902. Additionally or alternatively, the machine learning controller 1910 may be similar to, for example, the static machine learning controller 210 of FIG. 2, the adjustable machine learning controller 310 of FIG. 3 as described above, or the self-updating machine learning controller 410 of FIG. 4A. Thus, in some embodiments, the power box 1902 includes the machine learning controller 1910 rather than the server 1306. In such embodiments, the power box 1902 may communicate the determinations from the machine learning controller 1910 to the server 1906 (or to an external device 104) to provide a graphical user interface to illustrate the analysis of the sensor output signals.

In one embodiment, the machine learning controller 1910 of FIG. 19 implements a clustering algorithm that identifies different types of power tool battery chargers and/or battery packs connected to the power box 1902. In one example, the machine learning controller 1910 implements an iterative K-means clustering machine learning control. The clustering algorithm is an unsupervised machine learning algorithm and instead of using training data to train the machine learning control 784, the machine learning controller 1910 analyzes all the data available and provides information (e.g., the type of power tool battery chargers and/or battery packs connected to the power box 1902). Each data point received by the machine learning controller 1910 includes an indication of the used power (e.g., median Watts) provided to a specific power output of the power box 1902, the corresponding usage time (e.g., the time for which power was provided) of the same power output of the power box 1902, and a label indicating the type of power tool battery charger and/or battery pack.

In another embodiment, the machine learning controller 1910 implements, for example, a hierarchical clustering algorithm. In such an example, the machine learning controller 1910 starts by assigning each data point to a separate cluster. The machine learning controller 1910 then gradually combines data points into a smaller set of clusters based on a distance between two data points. The distance may refer to, for example, a Euclidean distance, a squared Euclidean distance, a Manhattan distance, a maximum distance, and Mahalanobis distance, among others. Similar to the k-means clustering algorithm, the hierarchical clustering algorithm does not use training examples, but rather uses all the known data points to separate the data points into different clusters.

After receiving the sensor output signals from the power box 1902, the machine learning controller 1910 identifies the different power usage of different power tool battery chargers and/or battery packs (e.g., by implementing, for example, one of the clustering algorithms described above). As shown in FIG. 19, the machine learning controller 1910 can categorize the power tool battery chargers and/or battery packs connected to the power box 1902 based on their power usage and usage time. For example, a first type of power tool battery charger may be used for longer periods of time but utilizes less power, while a second type of power tool battery charger typically utilizes a greater amount of power for shorter periods of time. Providing a graphical user interface (e.g., using the external device 104) may provide a user with a better estimation of the overall power necessary for specific type of jobs or in a particular jobsite.

In still other embodiments, the electronic controller 1920 of the power box 1902 includes an electronic processor 1930 that can be configured to receive instructions and data from a memory 1940 and execute, among other things, the instructions. In particular, the electronic processor 1930 executes instructions stored in the memory 1940. Thus, the electronic controller 1920 coupled with the electronic processor 1930 and the memory 1940 can be configured to perform the methods described herein (e.g., process 800 of FIG. 8, the process 900 of FIG. 9, and/or the process 1000 of FIG. 10).

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including.” “comprising.” or “having” and variations thereof herein is meant to encompass the items listed thereafter and equivalents thereof as well as additional items. Unless specified or limited otherwise, the terms “mounted,” “connected,” “supported.” and “coupled” and variations thereof are used broadly and encompass both direct and indirect mountings, connections, supports, and couplings. Further, “connected” and “coupled” are not restricted to physical or mechanical connections or couplings.

Some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates, etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (e.g., hard disks, floppy disks), optical media (e.g., compact discs, digital video discs, Blu-ray discs), semiconductor media (e.g., random access memory (“RAM”), flash memory, electrically programmable read only memory (“EPROM”), electrically erasable programmable read only memory (“EEPROM”)), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (“CD”), digital versatile disk (“DVD”), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (“LAN”). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component.” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and both items together. For example, a device having “a and/or b” is intended to cover: a device having a (but not b): a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The provided detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool battery charger comprising:
a housing;
at least one charging circuit coupled to the housing and configured to charge a battery pack coupled thereto;
an electronic controller coupled to the housing, and in communication with the at least one charging circuit, the electronic controller configured to:
receive power tool device data from a power tool device, wherein the power tool device data comprise usage data of the power tool device;
generate, based on the power tool device data, charger operation data indicating at least one of a charging rate of the at least one charging circuit, a charging target of the at least one charging circuit, or a time indication for when to adjust at least one of the charging rate or charging target of the at least one charging circuit; and
operate the at least one charging circuit based on the charger operation data.

2. The power tool battery charger of claim 1, further comprising a machine learning controller including a second electronic processor, the machine learning controller supported by the housing, coupled to the electronic controller, and including a machine learning control program, the machine learning controller being configured to:
receive the power tool device data from the electronic controller;
process the power tool device data, using the machine learning control program, wherein the machine learning control program is a trained machine learning control program;
generate, using the machine learning control program, an output based on the power tool device data; and
send the output to the electronic controller;
wherein the electronic processor of the electronic controller receives the output from the machine learning controller and generates the charger operation data using the output from the machine learning controller.

3. The power tool battery charger of claim 2, wherein the machine learning control program implements at least one selected from a group of an artificial neural network that takes power tool device data as an input and a support vector machine that takes power tool device data as an input.

4. (canceled)

5. (canceled)

6. The power tool battery charger of claim 5, wherein the power tool device is a battery pack and the usage data include at least one of retake time data of the battery pack, working hours data of the battery pack, a warranty of the battery pack, and an age of the battery pack.

7. The power tool battery charger of claim 2, wherein the machine learning controller is configured to receive feedback data and to adjust the machine learning control program based on the feedback data.

8. (canceled)

9. (canceled)

10. (canceled)

11. The power tool battery charger of claim 1, wherein the power tool device is a battery pack and the electronic controller is configured to generate the charger operation data by:
determining a charging state for the battery pack; and
generating the charger operation data based on the charging state and the power tool device data.

12. The power tool battery charger of claim 11, wherein the charging state for the battery pack includes independent variables including a charging rate and a charging threshold.

13. (canceled)

14. The power tool battery charger of claim 11, wherein the charging state comprises a multidimensional charging state, wherein the multidimensional charging state is parameterized by a charging rate function comprising independent variables including a charging target and a charging rate.

15. (canceled)

16. (canceled)

17. The power tool battery charger of claim 11, wherein the power tool device is a battery pack, the usage data comprise retake time data, and the electronic controller is configured to generate the charger operation data based on the retake time data, wherein the retake time data indicate at least one of:
a time between when the battery pack reaches a charging target and when the battery pack is taken off the power tool battery charger;
a time between when the battery pack is put on the power tool battery charger and when the battery pack is taken off from the power tool battery charger;
a time between when the battery pack reaches a charging target and when the battery pack is used next on another power tool device;
a time between subsequent times when the battery pack is taken off the power tool battery charger or another power tool battery charger; or
a time between subsequent times when the battery pack is put on the power tool battery charger or another power tool battery charger.

18. (canceled)

19. (canceled)

20. (canceled)

21. The power tool battery charger of claim 1, wherein the usage data indicates working hours for the power tool device.

22. (canceled)

23. (canceled)

24. (canceled)

25. (canceled)

26. The power tool battery charger of claim 1, wherein the charger operation data include a charging target, and wherein the charging target is determined from the power tool device data by the electronic controller.

27. (canceled)

28. (canceled)

29. (canceled)

30. (canceled)

31. (canceled)

32. A battery pack for use with a power tool, comprising:
a housing;
a plurality of battery cells arranged within the housing and configured to provide electrical power to a power tool when coupled thereto;
at least one charging circuit coupled to the housing and configured to:
provide electrical power to the plurality of battery cells to charge the plurality of battery cells when coupled to a power tool battery charger; and
discharge the plurality of battery cells to provide the electrical power to a power tool when coupled to the power tool;
an electronic controller coupled to the housing, including an electronic processor, and in communication with the at least one charging circuit; and
a machine learning controller including a second electronic processor, the machine learning controller supported by the housing, coupled to the electronic controller, and including a machine learning control program,
wherein the electronic controller configured to:
receive power tool device data from a power tool device, wherein the power tool device data comprise data indicative of use of the power tool device;
generate, based on the power tool device data, charger operation data indicating at least one of a charging rate of the at least one charging circuit, a charging target of the at least one charging circuit, or a time indication for when to adjust at least one of the charging rate or charging target of the at least one charging circuit, wherein the electronic controller generates the charger operation data based on an output from the machine learning controller; and
operate the at least one charging circuit based on the charger operation data.

33. The battery pack of claim 32, wherein the machine learning controller is configured to:
receive the power tool device data from the electronic controller;
process the power tool device data, using the machine learning control program, wherein the machine learning control program is a trained machine learning control program;
generate, using the machine learning control program, the output based on the power tool device data; and
send the output to the electronic controller.

34. (canceled)

35. (canceled)

36. The battery pack of claim 33, wherein the power tool device data include usage data of the power tool device.

37. The battery pack of claim 33, wherein the machine learning controller is configured to receive feedback data and to adjust the machine learning control program based on the feedback data.

38. The battery pack of claim 37, wherein the feedback data comprise user feedback data indicative of user feedback related to operation of the battery back based on the charger operation data.

39. (canceled)

40. The battery pack of claim 37, wherein the machine learning controller is configured to adjust the machine learning control program based on the feedback data by retraining the machine learning control program using the feedback data.

41. (canceled)

42. The battery pack of claim 37, wherein the feedback data indicate a performance of the battery pack and the machine learning controller is configured to adjust the machine learning control program based on the feedback data using reinforcement learning.

43. The battery pack of claim 32, wherein the electronic controller is configured to generate the charger operation data by:
determining a charging state for the battery pack; and
generating the charger operation data based on the charging state and the power tool device data.

44. The battery pack of claim 43, wherein the charging state for the battery pack includes independent variables including a charging rate and a charging threshold.
